(19) United States
(12) Patent Application Publication
(10) Pub. No.: US 2015/0294588 A1
(43) Pub. Date: Oct. 15, 2015

(54) Neuroperformance

(71) Applicant: ASPEN PERFORMANCE TECHNOLOGIES, Jerusalem (IL)

(72) Inventors: Jose Roberto KULLOK, Jerusalem (IL); Saul KULLOK, Jerusalem (IL)

(21) Appl. No.: 14/681,538

(22) Filed: Apr. 8, 2015

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.
Application No. 14/251,041 is a continuation-in-part of application No. 14/468,930, filed on Aug. 26, 2014.
Application No. 14/468,930 is a continuation-in-part of application No. 14/468,951, filed on Aug. 26, 2014.
Application No. 14/468,951 is a continuation-in-part of application No. 14/468,975, filed on Aug. 26, 2014.
Application No. 14/468,975 is a continuation-in-part of application No. 14/468,990, filed on Aug. 26, 2014.
Application No. 14/468,990 is a continuation-in-part of application No. 14/468,985, filed on Aug. 26, 2014.
Application No. 14/468,985 is a continuation-in-part of application No. 14/469,011, filed on Aug. 26, 2014.

(51) Int. Cl. G09B 19/00; G09B 5/02

(52) U.S. Cl. CPC G09B 19/00; G09B 5/02

(57) ABSTRACT

Methods of promoting fluid intelligence abilities in a subject are described herein. In particular, exemplary exercises are directed at the following: sensorially perceptually discriminating embedded relational open proto-bigrams (ROPB) in predefined alphabetic arrays; inserting missing different or same type ROPBs in predefined alphabetic arrays; sensorially perceptually discriminating and sensory motor selecting embedded same or different type ROPBs in predefined stand-alone alphabetic arrays or in predefined stand-alone alphabetic arrays as part of a sentence or figurative speech type sentence; and sensorially perceptually discriminating and sensory motor selecting embedded ROPBs in selected affixes contained within predefined alphabetic arrays.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014; and U.S. patent application Ser. No. 14/468,930, U.S. patent application Ser. No. 14/468,951, U.S. patent application Ser. No. 14/468,975, U.S. patent application Ser. No. 14/468,990, U.S. patent application Ser. No. 14/468,985, and U.S. patent application Ser. No. 14/469,011, all filed on Aug. 26, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential, statistical and combinatorial properties of alphanumerical series of symbols (e.g., in alphabetical series, letter sequences and series of numbers). These sequential, statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This non-pharmacological technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling sufficient transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of natural numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-alphabetical-linguistic plasticity, thus preventing or decelerating the chemical break-down initiation of the biological neural machine as it grows old.

The present non-pharmacological technology accomplishes this by principally focusing on the root base component of language, its alphabet. In particular, the constituent parts, namely the letters and letter sequences (chunks) are intentionally organized without altering the intrinsic direct or inverse alphabetical order to create rich and increasingly complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on numerical series of natural numbers. Specifically, the natural numerical constituent parts, namely single natural number digits and number sets (numerical chunks), are intentionally organized without altering the intrinsic direct or inverse serial order in the natural numbers numerical series to create rich and increasingly novel serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition).

Further, the present non-pharmacological technology also derives its effectiveness by promoting strong arousal when reasoning in order to efficiently problem solve provided serial order(s) of symbols and numbers. Arousal when reasoning is promoted via an intentional sensorial perceptual discrimination and processing of phonological and visual serial order information among alphabetical structures (e.g., relative serial ordinal positions of letters and serial orders of letter chunks and statistical regularities and combinatorial properties of the same, including non-word serial order letter patterns). Accordingly, neuronal plasticity, in general, across several distant brain regions and hemispheric related language neural plasticity, in particular, are promoted.

The scope of the present non-pharmacological technology is not intended to be limited to promoting fluent reasoning abilities by promoting selective discrimination of serial orders of single letters in letter chunk patterns and/or frequency distribution of the same in letter sequences to enable the subject to implicitly transfer acquired knowledge about the letters' sequential order(s) and explicitly formulate strategies that facilitate lexical-semantic recognition. The present non-pharmacological technology teaches novel ways of problem solving by the sensorial-perceptual-motor grounding of higher order relational lexical knowledge. Accordingly, the present exercises intentionally promote fluid reasoning to quickly enact an abstract conceptual mental web where a number of relational direct, inverse, and incomplete alphabetic arrays interrelate, correlate, and cross-correlate with each other such that the processing and real-time manipulation of these arrays is maximized in short-term memory. In other words, the alphabetic arrays utilized herein are purposefully selected and arranged with the intention of bypassing long-term memory processing of semantic information in a subject. By presenting selected alphabetic arrays in the novel configurations described herein, the subject is not required to use cognitive resources, e.g. recall-retrieval of prior semantic knowledge and/or learning strategies based on categorical and associative semantic learning, to solve the present exercises. More specifically, the present exercises are designed to minimize or eliminate the subject's need to access prior known semantic knowledge by focusing on the intrinsic seriality of the alphabetic arrays even for the case where the alphabetic array(s) conveys a semantic meaning. Principally, the novel problem solving of the serial order(s) of alphabetical and number symbols exercises disclosed herein grants fast and direct access to higher order cognitive conceptualization constructs involving degrees of interrelated, correlated and cross-correlated lexical relational knowledge while providing minimal access, if any, to stored lexical meaning (e.g., recall-retrieval) from long term memory.

The advantage of the non-pharmacological cognitive intervention technology disclosed herein is that it is effective, safe, and user-friendly. This technology principally concentrates on the novel cognitive and sensorial perceptual grounding of symbol terms occupying intrinsic relational serial orders in alphabetic, numerical, and alphanumerical arrays through the on-line performance of the sensorial perceptual search, discrimination and sensory motor selection of the same. This technology also demands little or no arousal towards semantic constructs, and thus low attentional drive to automatically recall/retrieve semantic information from long term memory storage is expected. Further advantages include that this technology is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the method that the exercises disclosed in Example 1 use in promoting fluid intelligence abilities in a subject by sensorially perceptually discriminating embedded relational open proto-bigrams (ROPB) from predefined alphabetic arrays.

FIGS. 2A-2J depict a number of non-limiting examples of the exercises for sensorially perceptually discriminating relational open proto-bigrams (ROPB) in predefined alphabetic arrays. FIG. 2A shows an arrangement of a number of alphabetic arrays. FIG. 2B shows the first selected ROPB ‘ON’. FIGS. 2C and 2D show correct selections of ROPB ‘ON’. FIG. 2E illustrates all of the instances of the ROPB ‘ON’ occurring in the predefined array. FIG. 2F shows the next selected ROPB ‘OR’. FIGS. 2G-2I each show ROPB ‘OR’ as correctly discriminated in the provided array. In FIG. 2J all instances of ROPB ‘OR’ are displayed.

FIGS. 3A-3F depict a number of non-limiting examples of the exercises for inserting different-type relational open proto-bigrams (ROPB) in predefined alphabetic arrays. FIG. 3A shows an arrangement of selected alphabetic arrays. FIG. 3B shows the incomplete alphabetic arrays along with a ruler of ROPB answer choices. FIG. 3C shows a correct insertion of the ROPB ‘IT’. FIGS. 3D and 3E illustrate additional correction insertions of ROPBs. In FIG. 3F, the incomplete alphabetic arrays are removed leaving only the correctly inserted ROPBs to be displayed.

FIGS. 4A-4G depict another number of examples of the exercises for inserting different-type relational open proto-bigrams (ROPB) in predefined alphabetic arrays. FIG. 4A shows an arrangement of selected alphabetic arrays. FIG. 4B shows the incomplete alphabetic arrays along with a ruler of ROPB answer choices. FIG. 4C shows a correct insertion of the ROPB ‘HE’. FIGS. 4D-4F illustrate additional correction insertions of ROPBs. In FIG. 4G, the incomplete alphabetic arrays are removed leaving only the correctly inserted ROPBs to be displayed.

FIGS. 5A-5H depict another number of examples of the exercises for inserting different-type relational open proto-bigrams (ROPB) in predefined alphabetic arrays. FIG. 5A shows an arrangement of selected alphabetic arrays. FIG. 5B shows the incomplete alphabetic arrays along with a ruler of ROPB answer choices. FIG. 5C shows a correct insertion of the ROPB ‘BE’. FIGS. 5D-5G illustrate additional correction insertions of ROPBs. In FIG. 5H, the incomplete alphabetic arrays are removing leaving only the correctly inserted ROPBs to be displayed.

FIGS. 6A-6C depict a non-limiting example of the exercises for inserting missing same-type relational open proto-bigrams (ROPB) in predefined alphabetic arrays. FIG. 6A shows an arrangement of selected alphabetic arrays along with a ruler of ROPB answer choices. In FIG. 6B, the correct ROPB is shown inserted into each of the provided alphabetic arrays. In FIG. 6C, a grammatically correct sentence, formed using the completed alphabetic arrays, is displayed to the subject.

FIGS. 7A-7C depict another non-limiting example of the exercises for inserting missing same-type relational open proto-bigrams (ROPB) in predefined alphabetic arrays. FIG. 7A shows an arrangement of selected alphabetic arrays along with a ruler of ROPB answer choices. In FIG. 7B, the correct ROPB is shown inserted into each of the provided alphabetic arrays. In FIG. 7C, a grammatically correct sentence, formed using the completed alphabetic arrays, is displayed to the subject.

FIGS. 8A-8C depict a non-limiting example of the exercises for inserting missing same-type relational open proto-bigrams (ROPB) in predefined alphabetic arrays. FIG. 8A shows an arrangement of selected alphabetic arrays along with a ruler of ROPB answer choices. In FIG. 8B, the correct ROPB is shown inserted into each of the provided alphabetic arrays. In FIG. 8C, a grammatically correct sentence, formed using the completed alphabetic arrays, is displayed to the subject.

FIGS. 9A-9C depict another non-limiting example of the exercises for inserting missing same-type relational open proto-bigrams (ROPB) in predefined alphabetic arrays. FIG. 9A shows an arrangement of selected alphabetic arrays along with a ruler of ROPB answer choices. In FIG. 9B, the correct ROPB is shown inserted into each of the provided alphabetic arrays. In FIG. 9C, a grammatically correct sentence, formed using the completed alphabetic arrays, is displayed to the subject.

FIGS. 10A-10J depict a number of non-limiting examples of the exercises for discriminating same-type relational open proto-bigrams (ROPB) in predefined alphabetic arrays. FIG. 10A shows an arrangement of a number of alphabetic arrays. FIG. 10B shows the selected ROPB ‘AT’. FIGS. 10C-10H each illustrate correct selections of ROPB ‘AT’. In FIG. 10I, all of the provided alphabetic arrays that do not contain ROPB ‘AT’ are removed. FIG. 10J shows a pictorial image of the words forming the selected sentence from FIGS. 10A-10I.

FIGS. 11A-11G depict another non-limiting example of the exercises for discriminating same-type relational open proto-bigrams (ROPB) in predefined alphabetic arrays. FIG. 11A shows an arrangement of a number of alphabetic arrays. FIG. 11B shows the selected ROPB ‘OR’. FIGS. 11C-11E each illustrate correct selections of ROPB ‘OR’. In FIG. 11F, all of the provided alphabetic arrays that do not contain ROPB ‘OR’ are removed. FIG. 11G shows a pictorial image of the words forming the selected sentence from FIGS. 11A-11F.

FIGS. 12A-12F depict a number of non-limiting examples of the exercises for discriminating different-type relational open proto-bigrams (ROPB) in predefined alphabetic arrays. FIG. 12A shows an arrangement of a number of alphabetic arrays and a ruler containing possible ROPB answer choices. FIG. 12B shows the correctly selected ROPB ‘HE’. FIGS. 12C-12E each illustrate correct selections of embedded ROPBs. In FIG. 12F, only the sentence formed by the provided alphabetic arrays is displayed with each correctly selected ROPB highlighted by a changed time and/or spatial perceptual related attribute(s).

FIGS. 13A-13E depict another non-limiting example of the exercises for discriminating different-type relational open proto-bigrams (ROPB) in predefined alphabetic arrays. FIG. 13A shows an arrangement of a number of alphabetic arrays and a ruler containing possible ROPB answer choices. FIG. 13B shows the correctly selected ROPB ‘AS’. FIGS. 13C and 13D each illustrate correct selections of embedded ROPBs. In FIG. 13E, only the sentence formed by the provided alphabetic arrays is displayed with each correctly selected ROPB highlighted by a changed time and/or spatial perceptual related attribute(s).

FIGS. 14A-14CC depict a number of non-limiting examples of the exercises for sensorially perceptually discriminating relational open proto-bigrams (ROPB) embedded in selected affixes within predefined alphabetic arrays. FIG. 14A shows a selected alphabetic array along with the first selected affix ‘ABLE’ to discriminate. FIG. 14B shows a correct selection of the word ‘willable’. FIGS. 14C-14F each illustrate correctly selected words containing the selected affix ‘ABLE’.

FIG. 14G shows the initial selected alphabetic array along with the newly selected affix ‘OUS’ to discriminate. FIG. 14H shows a correct selection of the word ‘vigorous’. FIGS. 14I-14L each show correctly selected words containing the selected affix ‘OUS’.

FIG. 14M shows the initial selected alphabetic array along with the newly selected affix ‘ATE’ to discriminate. FIG. 17N shows the correctly selected word ‘ultimate’. FIG. 14O shows the initial selected alphabetic array along with the newly selected affix ‘ANT’ to discriminate. FIG. 14P shows a correct selection of the word ‘stimulant’. FIGS. 14Q-14T each show additional correctly selected words containing the selected affix ‘ANT’.

FIG. 14U shows the initial selected alphabetic array along with the newly selected affix ‘IBLE’ to discriminate. FIG. 14V shows the correctly selected word ‘invisible’. FIG. 14W shows the initial selected alphabetic array along with the newly selected affix ‘AN’ to discriminate. FIG. 14X shows the correctly selected word ‘titan’. In FIG. 14Y, all of the correctly selected words containing the selected affix ‘AN’ are shown. FIG. 14Z shows the initial selected alphabetic array along with the newly selected affix ‘ISH’ to discriminate. FIG. 14AA shows the correctly selected word ‘planish’.

FIG. 14BB depicts all of the sensorially perceptually discriminated and correctly sensory motor selected affixes and the respective selected ROPBs embedded therein in the same spatial horizontal frame having the same spatial and/or time perceptual related attribute(s) changes from FIGS. 14A-14AA. Likewise, FIG. 14CC depicts all of the selected affixes and respective embedded ROPBs together in the same spatial vertical frame with the same spatial and/or time perceptual related attribute(s) changes as shown in FIG. 14BB.

### DETAILED DESCRIPTION

### I. Figurative Speech

### Introduction

To what degree is natural language involved in human cognition? Do thought processes involve language? To what extent is human thinking dependent upon possession of one or more natural language? Humboldt (1836) viewed language as the formative organ of thought and held that thought and language are inseparable (Gumperz, J., and Levinson, S. (1996). Rethinking Linguistic Relativity. Cambridge: Cambridge University Press; Lucy, J. A. (1996). The scope of linguistic relativity: An analysis and review of empirical research. In J. J. Gumperz & S. C. Levinson (Eds.), Rethinking Linguistic Relativity (pp. 37-69). Cambridge, England: Cambridge Press). The anthropologist Lee Whorf proposed ways by which natural language serves to structure and shape human cognition. Whorf, the same as Humboldt, was concerned with the relevance of language to thought, and he argued that the language we acquire influences how we see the world (and therefore the grammatical structure of a language shapes a speakers' perception of the world). Whorf's influential hypothetical views can be summarized in the following two conjectures:

### 1. The Strong Conjecture

“We dissect nature along lines laid down by our native language. The categories and types that we isolate from the world of phenomena we do not find there because they stare every observer in the face; on the contrary, the world is presented in a kaleidoscope flux of impressions which has to be organized by our minds—and this means largely by the linguistic systems of our minds” (Whorf, B. L. (1956). Language, Thought and Reality. Selected Writings. Ed.: J. B. Carroll. MIT, New York: J. Wiley/London: Chapinaon & Hall).

### 2. The Weaker Conjecture

“My own studies suggest, to me, that language, for all its kingly role, is in some sense a superficial embroidery upon deeper processes of consciousness, which are necessary before any communication, signaling, or symbolism whatsoever can occur” (Whorf, B. L. (1956). Language, Thought and Reality. Selected Writings. Ed.: J. B. Carroll. MIT, New York: J. Wiley/London: Chapinaon & Hall).

Nonetheless, the strongly contested but influential hypothesis that has come to be known as the Whorfian hypothesis, or alternatively as the Sapir-Whorf hypothesis, states that (1) languages vary in their semantic partitioning of the world; (2) the structure of one's language influences the manner in which one perceives and (conceptually) understands the world; (3) therefore, speakers of different languages will perceive the world differently. Since the early 1990s, however, Whorfianism has been undergoing something of a revival, albeit in a weakened form (Hunt, E., and Agnoli, F. (1991). The Whorfian hypothesis: A Cognitive psychology perspective. Psychological Review 98: 377-89; Lucy, John A. (1992a). “Grammatical Categories and Cognition: A Case Study of the Linguistic Relativity Hypothesis”. Cambridge: Cambridge University Press, and (1992b). “Language Diversity and Thought: A Reformulation of the Linguistic Relativity Hypothesis”. Cambridge: Cambridge University Press; Gumperz, J., and Levinson, S. (1996). Rethinking Linguistic Relativity. Cambridge: Cambridge University Press).

This new wave of research no longer argues that language has a structuring effect on cognition (meaning that the absence of language makes certain sorts of thoughts or cognitive processes completely unavailable/unattainable to people). Rather, one or another natural language can make certain sorts of thought and cognitive processes more likely, and more accessible to people. The basic point can be expressed in terms of Slobin's (1987) idea of “thinking for speaking” (Slobin D. (1987). Thinking for speaking. Proceeding of the Berkeley Linguistics Society 13: 435-45). Variants of this idea have been considered before. Pinker, for example, states that “Whorf was surely wrong when he said that one's language determines how one conceptualizes reality in general. But he was probably correct in a much weaker sense: one's language does determine how one must conceptualize reality when one has to talk about it” (Pinker, S. (1989). Learnability and cognition: The acquisition of argument structure. Cambridge, Mass.: MIT Press).

Yet, after decades of neglect, the question of the relevance of language to cognition has resurfaced and has become an arena of active scientific investigation. Three influential themes can be credited for this subject's reemergence.

The first theme developed from the work of Talmy, Langacker, Bowerman, and other language researchers who, beginning in the 1970s, analyzed the semantic systems of different languages and demonstrated convincingly that an important difference exists in how languages carve up the world. For example, the English and Korean languages offer their speakers very different ways of talking about joining objects. In English, placing a video cassette in its case or an apple in a bowl is described as putting one object in another. However, Korean makes a distinction according to the fit between the objects: a videocassette placed in a tight-fitting case is described by the verb kkita, whereas an apple placed in a loose-fitting bowl is described by the verb nehta. Indeed, in Korean, the ‘fitting’ notion is more important than the ‘containment’ notion. Unlike English speakers, who say that the ring is placed on the finger and that the finger is placed in the ring, Korean speakers use kkita to describe both situations since both involve a tightfitting relation between the objects (Choi, S., and Bowerman, M. (1991). Learning to express motion events in English and Korean: The influence of Language-specific lexicalization patterns. Cognition, 41, 83-121). As a consequence, a number of researchers have taken the task to explore ways in which semantic structure can influence conceptual structure.

The second theme developed from a set of theoretical arguments. These include the revival of Vygotsky's constructivist approach centering in the importance of language in cognitive development, namely how abstract cognitive cognition develops through the child's interaction with cultural and linguistic systems (Vygotsky, L. (1962). Thought and Language. Cambridge, Mass.: MIT Press). Soviet psychologist Lev Vygotsky developed his ideas on interrelations existing between language and thought in the course of child development as well as in mature human cognition. One of Vygotsky's ideas concerned the ways in which language deployed by adults can scaffold children's development, yielding what he called a “zone of proximal development.” He argued that what children can achieve alone and unaided is not a true reflection of their understanding. Rather, there is also a need to consider what they can do when supported (scaffold) by the instructions and suggestions of an adult. Moreover, such scaffolding not only enables children to achieve with others what they would be incapable of achieving alone, but plays a causal role in enabling children to acquire new skills and abilities.

Consequently, Vygotsky focused on the overt speech of children, arguing that it plays an important role in problem solving, partly by serving to focus their attention, and partly through repetition and rehearsal of adult guidance. Vygotsky claimed that this role does not cease when children stop accompanying their activities with overt monologues, but disappears inwards. Vygotsky argued that in older children and in adults, inner (subvocal) speech serves many of the same functions. For example, Diaz and Berk studied the self-directed verbalizations of young children during problem-solving activities (Diaz, R., and Berk, L. (eds.) (1992). Private Speech: From Social Interaction to Self-Regulation. Hillsdale, N.J.: Erlbaum). They found that children tended to verbalize more when the tasks were more difficult, and that children who verbalized more often were more successful in their problem solving. Likewise, Clark draws attention to the many ways in which language is used to support human cognition, ranging from shopping lists and post-it notes, to the mental rehearsal of instructions and mnemonics, to the performance of complex arithmetic calculations on pieces of paper. By writing an idea down, for example, one can present himself with more leisured reflection, leading to criticism and further improvement (Clark, A. (1998). Magic words: How language augments human computation. In P. Carruthers and J. Boucher (eds.), Language and Thought. Cambridge: Cambridge University Press).

Another influential review paper was Hunt and Agnoli's, making the case that language influences thought by instilling cognitive habits (Hunt, E., & Agnoli, F. (1991). The Whorfian hypothesis: a cognitive psychology perspective. Psychological Review, 98(3), 377-389). They proposed a different line of approach that produced evidence in support of the Whorfian linguistic relativity hypothesis. This approach calculates the number of decisions a person has to make while choosing a word or constructing an utterance (an analogy of computational models). One factor to consider is the coding conditions, which place a demand on the user's psychological capacity, depending on the language used. Recognition and selection of lexical terms, and analysis of structures, place certain demand on the long term and short term memory. This suggests that the language a user employs to think most efficiently about topics have efficient codes provided by the lexicon (Whorf believed that the grammar of a language is a more important determinant of thought than the categorizations of the lexicon). Hunt and Agnoli concluded that a sample of these lexicons could be objectively chosen and a minimal size effect tested. Therefore, if it is possible to find cross linguistic effects are as large as intralingual effects, the Whorfian hypothesis could be tested.

In order to explore the possible effect of language on thought, Miller and Stigler chose to concentrate first on representational level thinking, where two sources of information seemed particularly important for this area of study: the lexically identified concepts and the culturally developed schema. They argued that people consider the cost of computation when they reason about a topic and different languages involve different costs for transmission of messages, thus language influences cognition. Miller and Stigler's exploration on the possible effect of language on thought was carried out in research on cross linguistic differences in number systems and their influence on learning arithmetic (Miller, K. F., & Stigler, J. W. (1987). Counting in Chinese: Cultural variation in a basic cognitive skill Cognitive Development, 2, 279-305).

The research of Leslie et al. concentrated on exact numerical concepts for numbers larger than four (“five”, “six”, “seven”, “eight”, “fifteen”, “seventy-four”, “two million” and so forth). Most researchers agree that such numbers' acquisition is dependent upon language, specifically on the mastery of count-word lists (“five”, “six”, “seven”, “eight”, “nine”, and so on) together with the procedures of counting; that is, exact number information is stored along with its natural language encoding (see Leslie et al. (2007). Where Do the Integers Come From? In P. Carruthers, S, Laurence, and S. Stich (EDS.), The Innate Mind: Volume 3: Foundations and the Future. Oxford: Oxford University Press). Moreover, Lucy conducted important research on how cognition is affected by classifier grammars (Lucy, J. A. (1994). Grammatical categories and cognition. Cambridge: Cambridge University Press).

The third important theme was the investigation of ‘the spatial domain’, rather than focusing on studying a particular phenomenon, such as color. Domains, such as space, offer much richer possibilities for cognitive effects. Spatial relations are highly variable cross linguistically and this fact suggests the possibility of corresponding cognitive variability (e.g., Bowerman, M. (1980). The structure and origin of semantic categories in the language-learning child. In M. L. Foster and S. Brandes (Eds.), Symbol as sense (pp. 277-299). New York: Academic Press and, Bowerman, M. (1989). Learning a semantic system: What role do cognitive predispositions play? In M. L. Rice and R. L. Schiefelbusch (Eds.), The teachability of language (pp. 133-168). Baltimore: Brookes and Bowerman, M. (1996). Learning how to structure space for language: A cross-linguistic perspective. In P. Bloom, M. A. Peterson, L. Nadel, and M. F. Garret (Eds.), Language and space (pp. 385-436). Cambridge, Mass.: MIT Press; Brown, P. (1994). The INs and ONs of Tzeltal locative expressions: The semantics of static descriptions of locations. Linguistics, 32, 743-790; Casad, E. H., and Langacker, R. W. (1985). “Inside” and “outside” in Cora grammar. International Journal of American Linguistics, 51, 247-281; Levinson, S. C., and Brown, P. (1994). Immanuel Kant among the Tenejapans: Anthropology as applied philosophy. Ethos, 22, 3-41; Talmy, L. (1975). Semantics and syntax of motion. In J. Kimball (Ed.), Syntax and semantics (Vol. 4, pp. 181-238). New York: Academic Press and (1985). Lexicalization patterns: Semantic structure in-lexical forms. In T. Shopen (Ed.), Language typology and syntactic description: Vol. 3. Grammatical categories and the lexicon (pp. 57-149). New York: Cambridge University Press). Further, spatial relational terms provide framing structures for the encoding of events and experience. Therefore, spatial relational terms play a more interesting cognitive role than color names.

Finally, spatial relations, like color concepts, are amenable to objective testing in a more direct way than, say, people's concepts of justice or causality. The work of Levinson's research group demonstrates the cognitive differences that follow from differences in spatial language, specifically from the use of absolute spatial terms (analogous to north-south) versus geocentric terms (e.g., right/left/front/back). If, for example, a speaker's language requires him/her to describe spatial relationships in terms of compass directions, then the speaker will continually need to pay attention to and compute geocentric spatial relations. In contrast, if descriptions in terms of “left” and “right” are the norm, then geocentric relations will barely need to be noticed. This might be expected to have an impact on the efficiency with which one set of relations is processed relative to the other, and on the ease with which they are remembered (Levinson, S. C. (1996). Relativity in spatial conception and description. In J. J. Gumperz and S. C. Levinson (Eds.), Rethinking linguistic relativity (pp. 177-202). Cambridge: Cambridge University Press).

Levinson's work has been extremely influential in attracting renewed interest to the Whorfian hypothesis, either arguing for the effect or against it (Levinson, S. C. (1996). Relativity in spatial conception and description. In J. J. Gumperz and S. C. Levinson (Eds.), Rethinking linguistic relativity (pp. 177-202). Cambridge: Cambridge University Press and (1997). From outer to inner space: Linguistic categories and non-linguistic thinking. In J. Nuts and E. Pederson (Eds.), Language and conceptualization (pp. 13-45). Cambridge: Cambridge University Press; Levinson and Brown 1994; Pederson 1995) or against it (Li, P., and Gleitman, L. (2002). Turning the tables: Language and spatial reasoning. Cognition, 83, 265-294). Whether language has an impact on thought depends, of course, on how we define language and how we define thought. But, it also depends on our definition of ‘impact’. Language can act as a lens through which we see the world. It can provide us with tools that enlarge our capabilities. It can help us appreciate simple and complex relations and groupings in the world that we might not have otherwise grasped.

### Cognition

Cognition is a term that refers to the mental faculty of knowledge. Specifically, it refers to mental processes involved in the acquisition of knowledge and comprehension. These processes include thinking, reasoning, knowing, learning, remembering, judging, inferring (inductively or deductively), decision-making and problem-solving. These are higher-level functions of the brain and they encompass language, imagination, perception, and planning. Still, these mental functions or cognitive abilities are based on specific neuronal networks or brain structures. It can be said that cognition is an abstract property of advanced living organisms. Therefore, it is studied as a direct property of the brain or of an abstract mind on sub-symbolic and symbolic levels. Still, cognition is an (embodied) experience of knowledge that can be distinguished from an (embodied) experience of feeling or will. Cognition is one of the only words/terms that is associated to the brain as well as to the mind. Recently, advanced cognitive research has extended its domain to especially focus on the capacities of abstraction, generalization, concretization/specialization, and meta-reasoning, which descriptions involve concepts such as beliefs, knowledge, desires, preferences, and intentions of intelligent individuals/objects/agents/systems. In a wider sense, cognition also means the act of knowing or knowledge, and may be interpreted in a social or cultural sense to describe the emergent development of knowledge and concepts within a group that culminates in both thought and action.

### Remarkable Abilities of Human Cognition and Language

Humans specialize in thinking and knowing—in cognition—and our extraordinary cognitive powers have enabled us to do remarkable things that have transformed every aspect of our lives. We are complex social, political, economic, scientific and artistic creatures living and adapted to a vast range of habitats, many of our own creation. Humans' cognitive accomplishments can be attributed to their use of language and to their culture. Humans derive great cognitive power from the use of language. How has evolution produced creatures with minds capable of these remarkable feats? What is the nature of this ability? Gentner has proposed the following relevant list of cognitive skills that characterizes us (In D. Gentner and S. Goldin-Meadow (eds.), Language in Mind. Cambridge, Mass.: MIT Press. Pages 195-196 The MIT Press: 2003):
The ability to maintain hierarchies of abstraction, so that we can store information about Fido, about dachshunds, about dogs, or about living things
The ability to concatenate assertions and arrive at a new conclusion
The ability to reason outside of the current context—to think about different locations and different times and even to reason hypothetically about different possible worlds
The ability to compare and contrast two representations to discover where they are consistent and where they differ
The ability to reason analogically—to notice common relations across different situations and project further inferences
The ability to learn and use external symbols to represent numerical, spatial, or conceptual information.
   Language abilities include:
The ability to learn a generative, recursive grammar, as well as a set of semantic conceptual abilities
The ability to learn symbols that lack any iconic relation to their referents
The ability to learn and use symbols whose meanings are defined in terms of other learned symbols, including even recursive symbols such as the set of all sets
The ability to invent and learn terms for abstractions as well as for concrete entities
The ability to invent and learn terms for relations as well as (concrete) things.

### The Next Frontier: Higher-Order Cognition

### Early Induction and Categorization is Similarity-Based

Early in development, humans exhibit the ability to form categories and overlook differences for the sake of generality. Thus, the ability to generalize from the known to the unknown is crucial for learning new information. In recent years, new findings pose a challenge to the classical and naïve-theory of conceptual knowledge that holds that early in development induction is category based. Nevertheless, new findings suggest that it is unnecessary to posit conceptual assumptions to account for inductive generalizations in young children, thus supporting the recently proposed similarity, induction, and categorization (SINC) model. Briefly, the SINC model argues that for young children, both induction and categorization are similarity-based processes (the SINC model also argues for induction with both familiar and novel categories to be a similarity-based process) (Sloutsky. V. M., & Fisher, A. V. (2004a). Induction and categorization in young children: A similarity-based model. Journal of Experimental Psychology: General, 133, 166-188).

Sloutsky suggested that mature categorization is accomplished through inductive generalization that is grounded in perceptual and attentional mechanism capable of detecting multiple correspondences or similarities (Sloutsky. V. M (2003). The role of similarity in the development of categorization. Trends in Cognitive Sciences, 7, 246-251 (Murphy, G. L. (2002) The Big Book of Concepts, MIT Press; McClelland, J. L. and Rogers, T. T. (2003) The parallel distributed processing approach to semantic recognition. Nat. Rev. Neurosci. 4:310-322; Goldstone, R. L. (1994) The role of similarity in categorization: providing a groundwork. Cognition 52, 125-157; Hahn, U. and Ramscar, M. (2001) Similarity and Categorization, Oxford University Press; Sloman, S. A. and Rips, L. J. (1998) Similarity and Symbols in Human Thinking, MIT Press). Sloutsky's new approach became known as the ‘similarity-based approach’ (Sloutsky. V. M (2003). The role of similarity in the development of categorization. Trends in Cognitive Sciences, 7, 246-251) 2003). The central tenant of the similarity-based approach is that there are multiple correlations (correspondences among relations) in the environment and that humans have perceptual and attentional mechanisms capable of extracting these regularities and establishing correspondences among correlated structures (McClelland, J. L. and Rogers, T. T. (2003) The parallel distributed processing approach to semantic recognition. Nat. Rev. Neurosci. 4:310-322).

In particular, there is evidence that reliance on linguistic labels is not central and therefore fixed, and that it can vary as a function of perceptual information. For example, children's reliance on linguistic labels in categorization and induction tasks differs for real 3-dimensional (3-D) objects and for line-drawing pictures (2-D). The effects of labels are more pronounced for line-drawing pictures (2-D) than for real 3-D objects (Deak, G. O. and Bauer, P. J. (1996) The dynamics of preschoolers' categorization choices. Child Dev. 67, 740-767). Still, if two entities share a label, young children are more likely to say that these entities look alike (Sloutsky, V. M. and Lo, Y-F (1999) How much does a shared name make things similar? Part 1: Linguistic labels and the development of similarity judgment. Dev. Psychol. 35, 1478-1492). Furthermore, this overall similarity—rather than the centrality of linguistic labels alone, drives inductive generalization (Sloutsky, V. M. et al. (2001) How much does a shared name make things similar? Linguistic labels and the development of inductive inference. Child Dev. 72, 1695-1709).

It seems that an attention-based mechanism of similarity computation can account for inductive generalization in young children. Still, Sloutsky's approach further assumes that children do not have to know the importance of features' correspondences a priori, rather this knowledge can be the outcome of powerful learning mechanisms that are grounded in the ability to attend to and detect statistical regularities in the environment (McClelland, J. L. and Rogers, T. T. (2003) The parallel distributed processing approach to semantic recognition. Nat. Rev. Neurosci. 4:310-322). Hence, the importance of distinctive features correspondences does not have to be known in advance by children—it can be ‘created’ on the fly by presenting and contrasting examples. Because many ‘basic categories’ have correlated structures, the ability to detect specific and more abstract regularities might be an important learning mechanism supporting the development of categories. Still, in a later study, Fisher & Sloutsky proposed that category and similarity-based induction should result in different memory traces and thus in different memory accuracy.

Fisher & Sloutsky summarized their study results (consisting in four experiments) to indicate that (a) young children spontaneously perform similarity-based induction, (b) there is a gradual transition from similarity-based to category-based induction, and, c) category-based induction is likely to be a product of learning (Fisher, A. V. & Sloutsky, V. M. (2005b). When induction meets memory: Evidence for gradual transition from similarity-based to category-based induction. Child Development, 76, 583-597).

### The Role of Function in Categories

Most generally, an object's function, the use that people have assigned to it, is a central aspect of the object's conceptualization. Typically, the function of an object is treated as a simple unanalyzed amodal unitary property that can be abstractly predicated as existing independently of its other properties, such as physical structure and context of use. Most commonly, when functional properties are viewed modally, they are often assigned to a single modality, namely, the motor system.

Barsalou et al., and Chaigneau et al., have proposed function to be a more elaborate construct, firstly, a complex relational structure, not a single abstract unanalyzed property, and secondly, that it is distributed across many modalities, not just one (Barsalou, L. W., Sloman, S. A, & Chaigneau, S. E. (2005). The HIPE theory of function. In Carlson, L. & van der Zee, E. (Eds.) Representing functional features for language and space: Insights from perception, categorization and development (pp. 131-47). Oxford: Oxford University Press; Chaigneau, S. E., Barsalou, L. W. (2008). The role of function in categories. Theoria et Historia Scientiarum, 8, 33-51). Third, they proposed that there is not just one sense of an entity's function but many. When subjects are aware of the relational systems that underlie function, they use it to categorize, to name, to guide inferences, and to fill gaps in knowledge. For instance, assigning an entity to a category is one way to sustain inductive inference (Markman, E. M. (1989) Categorization and naming in children. Cambridge, Mass.: The MIT Press; Yamauchi, T. & Markman, A. B. (2000). Inference using categories. Journal of Experimental Psychology: Learning, Memory, & Cognition, 26(3), 776-795). For example, when two objects belong to the same category, people expect these two objects to share important properties. Thus, if a novel entity is classified as a bird, people infer that it can fly (even though they may not know this for a fact).

Still, in line with the above mentioned proposal that posits function as an elaborate complex relational system, some researchers have argued that understanding the intention of an object's designer (design history) is crucial for understanding the object's function and that people use these meta-beliefs in categorization (Bloom, P. (1996). Intension, history, and artifact concepts. Cognition, 60, 1-29 and, (1998). Theories of artifact categorization. Cognition, 66, 87-93; Gelman, S. A., & Bloom, P. (2000). Young children are sensitive to how an object was created when deciding what to name it. Cognition, 76, 91-103; Matan, A., & Carey, S. (2001). Developmental changes within the core of artifact concepts. Cognition, 78, 1-26).

Bloom assumes that the designer's intention constitutes an artifact's essence, where the term “essence” herein refers to a theory of naming which holds that names are not grounded in mental representations (Bloom, P. (1996). Intension, history, and artifact concepts. Cognition, 60, 1-29 and, (1998). Theories of artifact categorization. Cognition, 66, 87-93). Instead, names are grounded in causal relations to their referents. When structure and function are treated as independent properties, or when causal relations are ambiguous, function's role is minimized. Function only shows its effect on reasoning and language naming ability when meaningful (causal chain) structure-function relations take place and when subjects understand them. Therefore, the better children and adults understand the underlying system of (complex) relations, the more function guides the naming of objects, inductive reasoning about objects' properties, and their categorization. In short, the elaborated view of Barslalou et al. contemplates the role of function as being a core conceptual property that represents categories, where function emerges from a complex relational system that links together physical structure, background settings, action/use, and design history.

### Abstract Relational Thought

Gentner and collaborators have proposed a new insight based on cognitive theories of learning which still claims the richness of the constructivist's theoretical frames. Their new proposal aims to capture the development of abstract relational thought—the sine qua non of human cognition. They propose that children's learning competence stems from carrying out comparisons that yield abstractions. These early comparisons are typically based on close concrete similarities.

Later, comparisons among less obviously similar exemplars promote further inferences and abstractions. Their proposal sheds new light on the learning process of new knowledge by comparison mechanisms. Specifically, they suggest that comparison is not a low-level feature generalization mechanism, but a process of structural alignment and mapping (e.g., learning by comparing two situations and abstracting their commonalities) that is powerful enough to acquire structured knowledge and rules (Gentner, D., & Medina, J. (1998). Similarity and the development of rules. Cognition, 65, 263-297; Gentner, D., & Wolff, P. (2000). Metaphor and knowledge change. In E. Dietrich & A. Markman (Eds.), Cognitive dynamics: Conceptual change in humans and machines (pp. 295-342). Mahwah, N.J.: Lawrence Erlbaum Associates).

### Comparison Can Promote Learning

According to this account, there are at least four ways by which the process of comparison can further the acquisition of knowledge:
a. Highlighting and schema abstraction-extracting common systems from representations, thereby promoting the dis-embedding of subtle and possibly important commonalities (including common relational systems);
b. Projection of candidate inferences inviting inferences from one item to the other;
c. Re-representation-alteration of one or both representations to improve the match (and thereby, as an important side effect, promoting representational uniformity); and
d. Restructuring-altering the domain structure of one domain in terms of the other (Gentner, D., & Wolff, P. (2000). Metaphor and knowledge change. In E. Dietrich & A. Markman (Eds.), Cognitive dynamics: Conceptual change in humans and machines (pp. 295-342). Mahwah, N.J.: Lawrence Erlbaum Associates; Gentner, D., Brem, S., Ferguson, R., Markman, A., Levidow, B. B., Wolff, P., & Forbus, K. D. (1997). Analogical reasoning and conceptual change: A case study of Johannes Kepler. The Journal of Learning Sciences, 6(1), 3-40).

These processes enable the child to learn abstract commonalities and to make relational inferences.

### The Strength of Comparison in Promoting Inductive Inference

Children also learn by mapping from well-understood systems to less understood systems, as shown, for example, in studies on children's understanding of biological properties. When young children are asked to make predictions about the behavior of animals and plants, they often invoke analogies with people (Carey, S. (1985b). Are children fundamentally different kinds of thinkers and learners than adults? In S. F. Chipman, J. W. Segal, & R. Glaser (Eds.), Thinking and learning skills: Current research and open questions (Vol. 2, pp. 485-517). Hillsdale, N.J.: Lawrence Erlbaum Associates; Inagaki, K. (1989). Developmental shift in biological inference processes: From similarity-based to category-based attribution. Human Development, 32, 79-87 and Inagaki, K. (1990). The effects of raising on children's biological knowledge. British Journal of Developmental Psychology, 8, 119-129; Inagaki, K., & Hatano, G. (1987). Young children's spontaneous personification as analogy. Child Development, 58, 1013-1020 and, Inagaki, K., & Hatano, G. (1991). Constrained person analogy in young children's biological inference. Cognitive Development, 6, 219-231; Inagaki, K., & Sugiyama, K. (1988) Attributing human characteristics: Development changes in over- and underattribution. Cognitive Development, 3, 55-70; also see for findings with adults—Rips, L. J. (1975). Inductive judgments about natural categories. Journal of Verbal Learning and Verbal Behavior, 14, 665-681).

For example, when asked if they could keep a baby rabbit small and cute forever, 5 to 6 year-olds often made explicit analogies to humans. For example, “We can't keep it [the rabbit] forever in the same size. Because, like me, if I were a rabbit, I would be 5 years old and become bigger and bigger”. Inagaki and Hatano noted that this use of the human analogy was not mere “childhood animism”, but rather a selective way of mapping from the known to the unknown (Inagaki, K., & Hatano, G. (1987). Young children's spontaneous personification as analogy. Child Development, 58, 1013-1020). That children reason from the species they know best as humans to other animals follows from the general phenomenology of analogy. A familiar base domain, whose causal structure is well understood, is used to make predictions about a less-well understood target (Bowdle, B., & Gentner, D. (1997). Informativity and asymmetry in comparisons. Cognitive Psychology, 34(3), 244-286; Gentner, D. (1983). Structure-mapping: A theoretical framework for analogy. Cognitive science, 7, 155-170; Holyoak, K. J., & Thagard, P. (1995). Mental leaps: Analogy in creative thought. Cambridge, Mass.: MIT Press). For example, knowledge about the solar system was used to make predictions about the atom in Rutherford's (1906) analogy (Gentner, D. (1983). Structure-mapping: A theoretical framework for analogy. Cognitive science, 7, 155-170). Inagaki and Hatano's findings suggest that these analogies are not a sign of faulty logic, but rather are a means “to generate an educated guess about less familiar, nonhuman objects”, and they stem from a highly sensible reasoning strategy, the same strategy used by adults in cases of incomplete knowledge (Inagaki, K., & Hatano, G. (1987). Young children's spontaneous personification as analogy. Child Development, 58, 1013-1020, [see page. 1020] and, Inagaki, K., & Hatano, G. (1991). Constrained person analogy in young children's biological inference. Cognitive Development, 6, 219-231).

Inagaki argued that analogical reasoning is not restricted to special cases of inference concerning unfamiliar properties and situations, but rather it is an integral part of the process of knowledge acquisition. As the findings of Inagaki and Hatano suggest, the process of analogical comparison and abstraction may itself drive the acquisition of abstract knowledge (Gentner, D., & Medina, J. (1997). Comparison and the development of cognition and language. Cognitive Studies: Bulletin of the Japanese Cognitive Science Society. 4(1), 112-149 and, Gentner, D., & Medina, J. (1998). Similarity and the development of rules. Cognition, 65, 263-297). Analogy plays a formative role in acquisition of knowledge when a well-structured domain provides the scaffolding for the acquisition of a new domain.

### The Career of Similarity Thesis

Gentner and collaborators have argued that analogy and comparison in general, are pivotal in children's learning. How does analogy develop? The early stages in analogy development appear to be governed by “global” or “holistic” similarities where infants can reliably make overall matches before they can reliably make partial matches (Smith, L. B. (1989). From global similarities to kinds of similarities: The construction of dimensions in development. In S. Vosniadou & A. Ortony (Eds.) Similarity and analogical reasoning (pp. 146-178). New York: Cambridge University Press and, Smith, L. B. (1993). The concept of same. In H. W. Reese (Ed.), Advances in child development and behavior (Vol. 24, pp. 215-252). San Diego, Calif.: Academic Press; Foard, C. F., & Kemler-Nelson, D. G. (1984). Holistic and analytic modes of processing: The multiple determinants of perceptual analysis. Journal of Experimental Psychology, 113(1), 94-111). The earliest reliable partial matches are based on direct resemblances between objects, such as the similarity between a round red ball and a round red apple. With increasing knowledge, children come to make pure attribute matches (e.g., a red ball and a red barn) and relational similarity matches (e.g., a ball rolling on a table and a toy car rolling on the floor.) As an example of this developmental progression, when asked to interpret the metaphor A tape recorder is like a camera, 6-year-olds produced object-based interpretations (e.g., Both are black), whereas 9-year-olds and adults produced chiefly relational interpretations (e.g., Both can record something for later) (Gentner, D. (1988). Metaphor as structure-mapping: The relational shift. Child Development, 59, 47-59).

Similarly, Billow reported that metaphors based on object similarity could be correctly interpreted by children of about 5 or 6 years of age, but that relational metaphors were not correctly interpreted until around 10 to 13 years of age (Billow, R. M. (1975). A cognitive developmental study of metaphor comprehension. Developmental Psychology, 11, 415-423). Still, young children's success in analogical transfer tasks increases when the domains are familiar to them and they are given training in the relevant relations. With increasing expertise, learners shift from reliance on surface similarities to greater use of structural commonalities in problem solving and analogy transfer (Chi, M. T. H., Feltovich, P. J., & Glaser, R. (1981). Categorization and representation of physics problems by experts and novices. Cognitive science, 5, 121-152). Novick showed that more advanced mathematics students were more likely to be reminded of structurally similar problems than were novices (Novick, L. R. (1988). Analogical transfer, problem similarity, and expertise. Journal of Experimental Psychology: Learning, Memory, and Cognition, 14, 510-520).

Further, when the experts were initially reminded of a surface-similar problem, they were able to reject it quickly. In brief, novices appear to encode domains largely in terms of surface properties, whereas experts possess relationally rich knowledge representations. Researchers speculated that experts tend to develop uniform relational representations (Forbus, K. D., Gentner, D., & Law, K. (1995). MAC/FAC: A model of similarity-based retrieval. Cognitive Science, 19, 141-205; Gentner, D., & Rattermann, M. J. (1991). Language and the career of similarity. In S. A. Gelman & J. P. Byrnes (Eds.), Perspective on language and thought: Interrelations in development (pp. 225-277). London: Cambridge University Press). In this regard, expertise leads to a greater probability that two situations embodying the same principle will be encoded in like terms and therefore will participate in mutual reminding. In summary, it is suggested that one way by which children and other novices improve their ability to detect powerful analogical matches is through comparison itself.

### Making Analogical Comparisons

One simple way to engage in comparison is via physical juxtaposition of similar items. Kotovsky and Gentner showed that experience with concrete similarity comparisons can improve children's ability to detect more abstract similarity (Kotovsky, L., & Gentner, D. (1996). Comparison and categorization in the development of relational similarity. Child Development, 67, 2797-2822). The results from this study were somehow puzzling since it was expected that matching via comparing highly similar examples (e.g., oOo with xXx or xxX), would lead to the formulation of a narrow understanding. Instead, comparisons have led to noticing relational commonalities that could be used in a more abstract mapping (within-dimension matching of pairs acts to make the higher order relation of symmetry or monotonicity more salient). In other words, making concrete comparisons improved children's ability to reveal relational similarities.

Still, Gentner & Clement showed that relational information tends to be implicit and difficult to call forth within individual items (Gentner, D., & Clement, C. (1998). Evidence for relational selectivity in the interpretation of analogy and metaphor. In G. H. Bower (Ed.), The psychology of learning and motivation, advances in research and theory (Vol. 22, pp. 307-358). New York: Academic Press). In brief, it seems that engaging in comparison processing tends to be a naturalistic way by which children and adults (e.g., when dealing with familiar topics) come to reveal and thus appreciate relational commonalities. In another study, Gentner and Medina demonstrated a second way to encourage comparison—giving two things the same name (label)—what they referred to as symbolic juxtaposition (Gentner, D., & Medina, J. (1998). Similarity and the development of rules. Cognition, 65, 263-297).

Gentner and Medina suggested that comparison can be promoted via symbolic juxtaposition through common language. Initial hints to symbolic juxtaposition effects were obtained in a previous study by Kotovsky and Gentner, where 4-year-olds were given name labels for higher order relations among the picture objects (e.g., “even” for symmetry) (Kotovsky, L., & Gentner, D. (1996). Comparison and categorization in the development of relational similarity. Child Development, 67, 2797-2822). Children in the study received a categorization task (with feedback) where they had to give only cards that showed the name label “even”. After the training in the categorization task, children who succeeded in the name labeling task scored well above chance in the cross-dimensional trials (72% relational responding), as opposed to chance performance (about 50%) that children showed with no such name label training. As with the physical juxtaposition studies, the use and training with relational name labels increased children's attention to discover common relational structure. They concluded that the acquisition of relational language influences the development of relational thought.

### Relational Reasoning in Human Evolution

Reasoning depends on the skill to form and manipulate mental representations of relations between objects, events and symbols. Thus, the integration of multiple relations between mental representations is critical for higher order cognition. Transitive inferences, drawing analogies (a type of induction), and a problem of the type “person is to house as bear is to what?” are such examples. The correct problem solving and planning depend on successfully reasoning the integration of at least two sources of relational information namely, the share roles, dweller and dwelling, constraining the inferred answer, “cave” for the above-referenced question. In fact, reasoning to understand and integrate more than one relation requires more than perceptual (given a visual scene) or linguistic (given a sentence) processing alone (e.g., transitive inference). In evolutionary terms, humans display far greater sophistication in relational reasoning across a wide range of content domains (Halford, G. S. (1984). Can young children integrate premises in transitivity and serial order tasks? Cognitive Psychology, 16, 65-93).

### Relational Knowledge: The Foundation of Higher-Order Cognition

Relational knowledge provides an integrative multidisciplinary framework for a broad number of fields, including inference, categorization, quantification, planning, language, working memory, and knowledge acquisition. Relational representations have a number of core properties that are vital to relational knowledge and which are different from other forms of cognition such as association, or automatic and modular processes. For example, structure-consistent mappings, a crucial property of relations and key to analogies, determine structural correspondence that is defined as a consistent mapping of elements and relations, have been postulated to be the process that best distinguishes humans' cognition from that of other animals (Holland, J. H. et al. (1989) Induction: Processes of inference, learning and discovery, MIT Press) and (Penn, D. C. et al. (2008) Darwin's mistake: Explaining the discontinuity between human and nonhuman minds. Behav. Brain Sci. 31, 109-130). Structure-consistent mappings enable analytic cognition that is relatively independent from similarity of content and that promotes selection of relations that are common to several relational instances (e.g., ‘Tom is TALLER than Peter’ and ‘Bob is TALLER than Tom’), which is a major step towards abstraction and representations of variables. This core property may offer new insight to explain a number of phenomena: 1) the nature and limitations of working memory, 2) the high correlation with fluid intelligence, 3) why higher order cognitive processes are by nature serial processes, 4) semantic tasks that evolve earlier and are implicitly acquired (mastered) at an earlier age, and 5) the flexibility and versatility of higher order cognition.

### Humans Prefrontal Cortex as the Locus Site of Relational Reasoning

It has been hypothesized that given the large increases in the size of prefrontal cortex in humans, the prefrontal cortex may be the locus of a system for relational reasoning in humans (Benson, D. F. (1993). Prefrontal abilities. Behavioral Neurology, 6, 75-81) and (Holyoak K. J., & Kroger, J. K. (1995) Forms of reasoning: Insight into prefrontal functions? In J. Grafman, K. J. Holyoak, & F. Boller (Eds), Structure and functions of the human prefrontal cortex (pp. 253-263). New York: New York Academy of Sciences; Robin, N., & Holyoak, K. J. (1995). Relational complexity and the functions of prefrontal cortex. In M. S. Gazzaniga (Ed.), The cognitive neurosciences (pp. 987-997). Cambridge, Mass.: MIT Press). The existing literature implicates the prefrontal cortex in the performance of a large number of higher order cognitive tasks, such as memory monitoring, management of dual tasks, rule application, and planning sequences of moves in problem solving (D'Esposito, M., Detre, J. A., Alsop, D. C., Shin, R. K., Atlas, S., & Grossman, M. (1996), The neural basis of the central executive system of working memory. Nature, 378, 279-281); Duncan, J., Burgess, P., & Emslie, H. (1995). Fluid intelligence after frontal lobe lesions. Neuropsychologia, 33, 261-268; Smith, E. E., Patalano, A., & Jonides, J. (1998). Alternative strategies of categorization. Cognition, 65, 167-196). This hypothesis is consistent with evidence that prefrontal cortex dysfunction leads to selective decrements in performance on tasks involving hypothesis testing, categorization, planning, and problem solving, all of which involve relational reasoning (Delis, D. C., Squire, L. R., Bihrle, A., & Massman, P. J. (1992). Componential analysis of problem-solving ability: Performance of patients with frontal lobe damage and amnesic patients on a new sorting test. Neuropsychologia, 30, 683-697; Shallice, T., & Burgess, P. (1991), Higher-order cognitive impairments and frontal lobe lesions in man. In H. S. Levin, H. M. Eisenberg, & A. L. Benton (Eds.), Frontal lobe function and dysfunction (pp. 125-138). New York: Oxford University Press). Still, it is further speculated that relational reasoning appears critical for all tasks identified with executive processing and fluid intelligence. Neuropsychological and functional imagining studies indicate that different regions in prefrontal cortex subserve distinct functions. Particularly, the dorsolateral prefrontal cortex (DLPFC) has been implicated in working memory and executive functions (Baddeley, A. D. (1992). Working memory. Science, 255, 556-559). Relational reasoning requires a capacity to bind elements dynamically into roles and to maintain these bindings as inferences are made.

### The Role of Working Memory in Constructing Relational Representations

Working memory is recognized as the workspace where relational representations are constructed (Halford, G. S., Wilson, W. H., & Phillips, S. (1998). Processing capacity defined by relational complexity: Implications for comparative, developmental, and cognitive psychology. Brain and Behavioral Sciences, 21, 803; Halford, G. S. and Busby, J. (2007) Acquisition of structured knowledge without instruction: The relational schema induction paradigm. J. Exp. Psychol. Learn. Mem. Cogn. 33, 586-603); Doumas, L. A. (2008) A theory of the discovery and predication of relational concepts. Psychol. Rev. 115, 1-43), and Oberauer, K. (2009) Design for a working memory. In The psychology of learning and motivation: Advances in research and theory (Ross, B. H., ed.), pp. 45-100, Elsevier Academic Press). It plays a role in the determination of structural correspondence that defines a consistent mapping of elements and relations. More so, these operations underlying relational integration may distinguish the mechanisms involved in working memory from a passive buffer role assigned to short-term memory. Still, the operations that support relational reasoning may form the core of an executive component of working memory, which implies both the active maintenance (also manipulation) of information and its processing (Halford, G. S., Wilson, W. H., & Phillips, S. (1998). Processing capacity defined by relational complexity: Implications for comparative, developmental, and cognitive psychology. Brain and Behavioral Sciences, 21, 803-864).

Working memory stands for approximately 50% of variance in fluid intelligence and its shares substantial variance in reasoning that is not accounted for computational demands (e.g., processing, storage, or by processing speed) (Kane, M. J. et al. (2004) The Generality of Working Memory Capacity: A Latent-Variable Approach to Verbal and Visuospatial Memory Span and Reasoning. J. Exp. Psychol. Gen. 133, 189-217), Kane, M. J. et al. (2005) Working Memory Capacity and Fluid Intelligence Are Strongly Related Constructs: Comment on Ackerman, Beier, and Boyle (2005). Psychol. Bull. 131, 66-71) and (Oberauer, K. et al. (2008) Which working memory functions predict intelligence? Intelligence 36, 641-652). This indicates that the shared variance at least somewhat reflects the ability to form structure representations. In other words, relational integration may be the “work” done by working memory that is the workspace where relational representations are constructed and it is influenced by knowledge stored in semantic memory. Therefore, it plays an important role in the interaction of analytic and nonanalytic processes in higher cognition.

### Relational Language and Relational Though

A view that contemplates language as influencing cognition is still considered to be a contentious claim. A recent progression of studies has uncovered a new understanding in support of how language might influence conceptual life. Particularly, the hypothesis is that learning specific relational terms and systems is important in the development of abstract thought (Gentner, D., & Rattermann, M. J. (1991). Language and the career of similarity. In S. A. Gelman & J. P. Byrnes (Eds.), Perspective on language and thought: Interrelations in development (pp. 225-277). London: Cambridge University Press; Gentner, D., Rattermann, M. J., Markman, A. B., & Kotovsky, L. (1995). Two forces in the development of relational similarity. In T. J. Simon & G. S. Halford (Eds.), Developing cognitive competence: New approaches to process modeling (pp. 263-313). Hillsdale, N.J.: Lawrence Erlbaum Associates; Kotovsky, L., & Gentner, D. (1996). Comparison and categorization in the development of relational similarity. Child Development, 67, 2797-2822). This hypothesis further suggests that relational language provides tools for extracting and formulating abstractions. In particular, it focuses on the role of relational name labels in promoting the ability to perceive relations, to transfer relational patterns, and to reason about relations. Even within a single language, the acquisition of relational terms provides both an invitation and a means for the learner to modify his/her thought. When applied across a set of cases, relational name labels prompt children to make comparisons and to store the relational meanings that result (Gentner, D. (1982). Why nouns are learned before verbs: Relativity vs. natural partitioning. In S. A. Kuczaj (Ed.), Language development: Syntax and semantics (pp. 301-304). Hillsdale, N.J.: Lawrence Erlbaum Associates; Gentner, D., & Medina, J. (1997). Comparison and the development of cognition and language. Cognitive Studies: Bulletin of the Japanese Cognitive Science Society. 4(1), 112-149 and, Gentner, D., & Medina, J. (1998). Similarity and the development of rules. Cognition, 65, 263-297).

Relational name labels invite the child to notice, represent, and, retain structural patterns of elements. Learning by analogy and similarity, even mundane within-dimension similarity, can act as a positive driving force playing a fundamental role in learning and in the development of structured representations. Children originally acquire knowledge at a highly specific conservative level. Later in development children engage in exemplars' matching to foster comparisons, which are initially concrete but progressively more abstract and complex. In the phase of exemplars, language learning by analogy and similarity promotes thought abstraction and rule learning.

### Why Relational Language Matters

Relational terms invite and preserve relational patterns that might otherwise be short-lived. Relational language includes verbs, prepositions, and a large number of relational nouns (e.g., weapon, barrier) members of classes that are exclusively dedicated to conveying relational knowledge and that contrast with object reference terms on a number of grammatical and informational dimensions (Gentner, D. (1981). Some interesting differences between nouns and verbs. Cognition and Brain Theory, 4. 161-178). Although pivotal in acquiring abstract concept development, relational concepts are not obvious, and therefore not automatically learned. Relational concepts are not simply given in the natural world. They are culturally and linguistically shaped (Bowerman, M. (1996). Learning how to structure space for language: A cross-linguistic perspective. In P. Bloom, M. A. Peterson, L. Nadel, and M. F. Garrett (Eds.), Language and space (pp. 385-436). Cambridge, Mass.: MIT Press; Talmy, L. (1975). Semantics and syntax of motion. In J. Kimball (Ed.), Syntax and semantics (Vol. 4, pp. 181-238). New York: Academic Press).

Although relational language is hard to learn, the benefits outweigh the difficulty. To that effect, Gentner and Loewenstein have put forward several specific ways in which relational language can foster the learning and retention of relational language patterns (Gentner, D., and Loewenstein, J. (2002). Relational language and relational thought. In J. Byrnes and E. Amsel (Eds.), Language, literacy, and cognitive development (pp. 87-120). Mahwah, N.J.: Erlbaum).
1. Abstraction. Naming a relational pattern helps to abstract it, to relocate it from its initial context. Abstraction helps to preserve it as a pattern (holistic structure entailing a set of relations), increasing the likelihood that the learner will perceive (automatically and/or with less attentional demanding) the (same or most related) relational pattern again across different circumstances.
2. Initial registration. Hearing (also visually via reading) a relational term used invites (particularly children) the storage of the situation and its name label in order to seek a relational meaning even when none is initially obvious.
3. Selectivity. Once learned, relational terms afford not only abstraction, but also selectivity. For example, when we select to label a cat a pet and not a carnivore, or a good mouser, or a lap warmer, we concentrate on a different set of aspect and relations. Selective linguistic labeling can influence the understanding of a situation.
4. Reification. Using a relational term helps to reify an entire pattern, so that new (novel) assertions can be stated about it. A named relations schema can serve as an argument to a higher order proposition (e.g., terms like: betrayal, loss, revenge, etc.)
5. Uniform relational encoding. Habitual use of a given set of relational terms promotes uniform relational encoding, thereby increasing the probability of transfer between like relational situations. The growth of technical vocabulary in experts reflects the utility of possessing a uniform relational vocabulary.

### Benefits of Language on Thought

Along with the Sapir-Whorf hypothesis and Vygotsky's theory of language and thought, Gentner and Loewenstein have claimed that learning specific relational terms and relational systems in a language fosters the human ability to notice and reason about related abstractions. Specifically, they claim that the set of currently lexicalized existing relations (e.g., verbs, propositions, and relational nouns) frames the set of new ideas that can be readily noticed and articulated. Their proposal goes beyond Slobin's “thinking for speaking” view, which states that language may determine the construal of reality during language use without necessarily pervading our entire world view, by arguing for lasting benefits of language on thought (Slobin, D. I. (1996). From “thought and language” to “thinking for speaking.” In J. J. Gumperz & S. C. Levinson (Eds.), Rethinking linguistic relativity (pp. 70-96). Cambridge, England: Cambridge University Press).

Since language influences categorization and memory (encoding and retrieval of lexical labels) and is instrumental in providing us with most of our concepts, its centrality in cognition and cognitive development is beyond dispute. Symbolic comparison operates in tandem with experiential comparison to foster the development of higher order cognition, namely abstract thought. The spirit of the present understanding can best be captured in a memorable comment from Piaget: “ . . . after speech has been acquired, the socialization of thought is revealed by the elaboration of concepts, of relations, and by the formation of rules, that is, there is a structural evolution” (Piaget, J. (1954). The construction of reality in the child. New York: Basic Books—see page. 360).

### The Relevance of Figurative Language in the Conceptualization of Thought

### Figurative Language

Figurative language generally refers to spoken or written words, which the understanding thereof deviates from the literal meaning. In contrast, understanding literal statements does not demand the extra step of figuring out the speaker's real intention. Psycholinguistics commonly assume that figurative meaning constitutes a conceptual category in which a speaker communicates something different than literally expressed. Others in the field suggest that in many cases figurative language expresses directly a speaker's thoughts and therefore does not differ from what the speaker says. Psycholinguistics research focuses mostly in online processing of the meaning of linguistic utterances, defined in terms of short literal paraphrases. For instance, there are many special characteristics of figurative meaning in different types of figurative language that communicate complex social and pragmatic meanings, which are often difficult to paraphrase and which resist propositional definition.

Different kinds of figurative language reflect different relations between what is said and what is communicated (e.g., irony involves cases where a speaker intends the opposite of what is literally said). At the same time, scholars maintain that many instances of figurative language convey special pragmatic effects that no other kind of speech can easily impart. When seen in isolation, for example, metaphorical utterances generally take longer to understand than literal ones. However, certain types of figurative speech can often be understood as quickly as literal speech when encountered in realistic discourse contexts (Gibbs, R. (1994). The poetics of mind: Figurative thought, language, and understanding. New York: Cambridge University Press and, Gibbs, R. (2011). Evaluating conceptual metaphor theory. Discourse Processes, 48, 529-562). This observation is particularly true for more familiar, conventional figurative language, such as idioms, stock metaphors, conventional ironies, and certain indirect speech acts.

In recent years, the convergence between different levels of analysis (from the evolutionary to the neural, from the conceptual to the linguistic, and from the cultural to the individual), together with new techniques and models, have produced fertile clinical research studies in cognitive science on how listeners arrive at these figurative meanings. Different theories for the interpretation of figurative meaning reflect contrasting conceptions of the human language processor, and, more generally, reflect different aspects of the relationship between language and thought as directly exposing people's figurative conceptualizations of experience.

### Metaphor

Metaphor is pervasive in language and thought: in scientific discovery (Gentner, D. (1982). Are scientific analogies metaphors? In D. Miall, Ed., Metaphor: Problems and perspectives, pp. 106-132. Brighton: Harvester; Gruber, H. E. (1995). Insight and effect in the history of science. In R. J. Sternberg and J. E. Davidson, Eds., The nature of insight, pp. 397-432. Cambridge, Mass.: MIT Press), in literature (Gibbs, R. W, Jr. (1994) The poetics of mind: Figurative thought, language, and understanding. New York: Cambridge University Press; Lakoff, G., & Turner, M. (1989). More than cool reason. Chicago: University of Chicago Press; Miller, G. A. (1993) Images and models, similes and metaphors. In A. Ortony, Ed., Metaphor and thought (2d ed.), pp. 357-400. Cambridge: Cambridge University Press; Steen, G. J. (1989). Metaphor and literary comprehension: Towards a discourse theory of metaphor in literature. Poetics, 18:113-141) and in everyday language (Glucksberg, S., and Keysar, B. (1990). Understanding metaphorical comparisons: Beyond similarity. Psychological Review 97:3-18; Hobbs, J. R. (1979). Metaphor, metaphor schemata, and selective inferencing. Technical Note 204, SRI Projects 7910 and 7500. Menlo Park, Calif.: SRI International; Lakoff, G., & Johnson, M. (1980). Metaphors we live by. Chicago: University of Chicago Press). Reasons for using metaphor language include politeness, avoiding responsibility for the import of what is communicated, expressing ideas that are difficult to communicate using literal language (e.g., “The ubiquity of metaphoric language throughout many abstract domains and across virtually every language ever studied is clearly consistent with the idea that metaphor allows people to talk and communicate abstract ideas that are difficult, even impossible, to describe in non-metaphorical terms” [Gibbs, R. (1994). The poetics of mind: Figurative thought, language, and understanding. New York: Cambridge University Press]), and expressing thoughts in a compact and vivid manner (Ortony, A. (1975). Why metaphors are necessary and not just nice. Educational Theory 25:45-53).

During ordinary language use people rarely bother differentiating consciously whether words and phrases have literal, figurative or other types of meaning. People simply try to interpret and produce the discourse given the present context and the combined communicative goals speakers mutually share. Therefore, one may argue that certain kinds of figurative language (such as novel, creative metaphors) are perceptually-conceptually noticeable (especially useful for evoking emotional reactions in listeners and readers) and transmitted with a distinctive (variable tropes) figurative effect. Some scholars suggest that novel creative metaphors are produced “deliberately” for specific stylistic and rhetorical reasons (Steen, G. (2008). The paradox of metaphor: Why we need a three dimensional model for metaphor. Metaphor & Symbol, 23, 213-241).

Other forms of figurative language, such as conventional metaphor, may be perceived-conceptualized much like literal language and interpreted as readily as most nonfigurative discourse. Conventional metaphors are presumably generated without consideration of their rhetorical properties, suggesting that perhaps conventional metaphors have become “dead” and cliched.

### Metaphor is Like Analogy

### Conceptual Metaphors as Extended Analogical Mappings: Reasoning Relational Information in Metaphors

Are metaphors understood in terms of long-standing conceptual metaphors or can mappings be constructed online as most analogy theories assume? Structure-mapping provides a natural mechanism for explaining how extended domain mappings are processed (Gentner, D. (1982). Are scientific analogies metaphors? In D. Miall, Ed., Metaphor: Problems and perspectives, pp. 106-132. Brighton: Harvester and, Gentner, D. (1983). Structure-mapping: A theoretical framework for analogy. Cognitive Science 7:155-170 and, Gentner, D., and Clement, C. A. (1988). Evidence for relational selectivity in the interpretation of analogy and metaphor. In G. H. Bower, Ed., The psychology of learning and motivation, pp. 307-358. New York: Academic; Gentner, D., and Markman, A. B. (1997). Structure mapping in analogy and similarity. American Psychologist 52:45-56). For example, consider the following two metaphors:
1) Encyclopedias are gold mines
2) My job is a jail

Metaphors (1) and (2) could be considered analogies-comparisons that share primarily relational commonality information. According to structure-mapping theory, analogical mapping is a process that establishes a structural alignment between two represented situations and then projects inferences (Gentner, D. (1983). Structure-mapping: A theoretical framework for analogy. Cognitive Science 7:155-170 and, Gentner, D., and Clement, C. A. (1988). Evidence for relational selectivity in the interpretation of analogy and metaphor. In G. H. Bower, Ed., The psychology of learning and motivation, pp. 307-358. New York: Academic; Gentner, D., and Markman, A. B. (1997). Structure mapping in analogy and similarity. American Psychologist 52:45-56).

Structure-mapping theory assumes the existence of structured representations made up of objects and their properties, relations between objects, and higher-order relations between relations. An alignment consists of an explicit set of correspondences between the representational elements of the two situations. The alignment is determined according to structural consistency constraints: (1) one-to-one correspondence between the mapped elements in the source and in the target, and (2) parallel connectivity, in which the arguments of corresponding predicates also relate. In addition, the selection of an alignment is guided by the systematicity principle, a system of (deeper) relations connected by higher order constraining relations. Causal relations (connected systems of belief) is preferred over one with an equal number of independent matches.

Systematicity influences people to infer a new fact and is more prone to classify a given fact as important if it was connected to a common causal structure. Systematicity is related to people's preference for relational interpretations of metaphors. Systematicity also guides analogical inference. People do not import random facts from source to target, but rather project inferences that complete the common system of relations (Bowdle, B., and Gentner, D. (1997). Informativity and asymmetry in comparisons. Cognitve Psychology 34(3):244-286; Clement, C. A., and Gentner, D. (1991). Systematicity as a selection constraint in analogical mapping. Cognitive Science 15:89-132). A second line of computational support for extended mappings is incremental mapping. An analogical mapping can be extended by adding further assertions from the base domain to the mapping (Burstein, M. H. (1983). Concept formation by incremental analogical reasoning and debugging. Proceedings of the International Machine Learning Workshop, 19-25; Novick, L. R., and Holyoak, K. J. (1991). Mathematical problem solving by analogy. Journal of Experimental Psychology: Learning, Memory, and Cognition 17(3):398-415). Although analogy provides the strongest evidence for structure, mapping, alignment and mapping processes also apply in ordinary similarity (Gentner, D., and Markman, A. B. (1997). Structure mapping in analogy and similarity. American Psychologist 52:45-56; Markman, A. B., and Gentner, D. (1993). Structural alignment during similarity comparisons. Cognitive Psychology 25:431-467; Medin, D. L., Goldstone, R. L., and Gentner, D. (1993). Respects for similarity. Psychological Review 100(2):254-278).

### The Career of Metaphor Theory

The career of metaphor theory combines aspects of both the comparison and categorization views (Bowdle, B., & Gentner, D. (2005). The career of metaphor. Psychological Review, 112, 193-216; Gentner, D., & Bowdle, B. (2001). Convention, form, and figurative language processing. Metaphor and Symbol, 16 223-247 and, Gentner, D., & Bowdle, B. (2008). Metaphor as structure-mapping. In R. Gibbs (Ed.), The Cambridge handbook of metaphor and thought (pp. 109-128). New York, N.Y.: Cambridge University Press). This theory claims that there is a shift in mode (representation) of mapping from comparison to categorization processes as metaphors become conventionalized. For instance, novel metaphors are processed as structural alignments between the concrete or literal representations of the base and target, but as repeated comparisons are made, the metaphorical meaning is gradually abstracted and comes to be associated with the base term. This theory suggests that the repeated derivation and retention of structural abstractions is the basic mechanism by which metaphors become conventionalized.

Novel metaphors involve base terms that refer to a domain-specific concept but are not yet associated with a domain-general category. They are interpreted as comparisons, direct structural alignments between the literal base and target concepts. Conventional metaphors involve base terms that refer both to a literal concept and to an associated metaphoric category. At this point, the source term is polysemous, having both a semantically related literal domain (specific meaning), and a metaphoric related domain (general category meaning). Thus, the carrier of metaphor theory predicts that as metaphors become increasingly conventional, there is a shift from comparison to categorization (Bowdle, B., & Gentner, D. (2005). The career of metaphor. Psychological Review, 112, 193-216).

This is consistent with the proposal that the interpretation of novel metaphors (e.g., A mind is a computer) involves sense creation, but stands in contradistinction with the interpretation of conventional metaphor (e.g., An opportunity is a doorway) which involves sense retrieval (Blank, G. D. (1988). Metaphors in the lexicon. Metaphor and Symbolic Activity 3:21-26; Giora, R. (1997). Understanding figurative and literal language: The graded salience hypothesis. Cognitive Linguistics 8(3):183-206; Turner, N. E., and Katz, A. N. (1997). The availability of conventional and of literal meaning during the comprehension of proverbs. Pragmatics and Cognition 5:199-233). Likewise, the same holds for idioms (Cacciari, C., and Tabossi, P. (1988). The comprehension of idioms. Journal of Memory and Language 27:668-683; Gibbs, R. W, Jr. (1980). Spilling the beans on understanding and memory for idioms in conversations. Memory and Cognition 8:449-456; Williams, J. (1992). Processing polysemous words in context: Evidence for inter-related meanings. Journal of Psycholinguistic Research 21:193-218).

The carrier of metaphor theory depicts an interpretation process that treats novel metaphors sense creation as information extraction via comparison versus the interpretation process of conventional metaphors where sense retrieval is a process depicting information recall of stored abstract metaphoric categories.

### The Centrality of Comparison

The career of metaphor theory claims that comparison is the fundamental process that drives metaphors. According to this theory, novel creative metaphors are understood only by comparison. In contrast, conventional metaphors can be understood by accessing stored abstractions, which are by themselves a product of past comparisons. Comparison is thus the more universal process for metaphor comprehension. However, cognitive effects and processing effort are also inseparable factors that contribute to metaphor understanding. In addition to the claimed centrality of comparison, novel creative metaphors may also demand more attentional resources than required to interpret a conventional metaphorical meaning that is highly lexicalized. Consequently, novel creative metaphors (also irony) will require a longer time to process because of the additional cognitive effects they convey over literal utterances (Gibbs, R. (1994). The poetics of mind: Figurative thought, language, and understanding. New York: Cambridge University Press).

Relational Words have High Metaphoric Potential

The results of a study by Jamrozik et al. have provided further support for the hypothesis that relational words have greater metaphoric potential than entity words, and this pattern is stronger for conventional uses (Jamrozik, A., Sagi, E., Goldwater, M., & Gentner, D. (2013). Relational words have high metaphoric potential. In E. Shutova, B. Beigman Klebanov, J. Tetreault, & Z. Kozareva (Eds.), Proceedings of the 2013 Meeting of the North American Association for Computational Linguistics: Human Language Technologies, First Workshop on Metaphor in NLP (pp. 21-26). Atlanta, Ga.: Association for Computational Linguistics). In their study, gathered from a corpus search of expert ratings of metaphoricity for uses of verbs, relational nouns, and entity nouns, they found that verbs (e.g., speak) and relational nouns (e.g., marriage) were rated as being marginally more metaphorical than entity nouns (e.g., zebra, item). When concreteness and imaginability were equated across the word types, verbs were rated more metaphorical than nouns.

Within conventional uses, verbs were rated as more metaphorical than nouns, and relational nouns were rated more metaphorical than entity nouns. Specifically, relational words are words that embrace more than one argument. These include verbs, propositions, and relational nouns. Relational nouns (e.g., bridge, party), which name relations or systems of relations, can be contrasted with entity nouns (e.g., elephant, item), which name entities defined by their intrinsic properties (Gentner, D., & Kurtz, K. (2005). Relational categories. In W. K. Ahn, R. L. Goldstone, B. C. Love, A. B. Markman & P. W. Wolff (Eds.), Categorization inside and outside the lab. (pp. 151-175). Washington, D.C.: APA; Goldwater, M. B., Markman, A. B, Stilwell, C. H. (2011). The empirical case for role-governed categories. Cognition, 118, 359-376).

The Jamrozik hypothesis, suggesting that metaphorical potential is related to relationality, is derived by evidence that relational words are more mutable than entity words. Accordingly, they suggested that relational words that are more mutable will have a greater metaphorical potential since their meaning readily adjusts to their context and can result in metaphoric extensions that go beyond the basic or standard literal meaning (Gentner, D. (1981). Some interesting differences between nouns and verbs. Cognition and Brain Theory, 4, 161-178). Prior findings already provided evidence for the predicted metaphoricity potential difference between word classes. For instance, metaphorical uses of verbs have been found to be more common than metaphorical uses of nouns in poetry (Brooke-Rose, C. (1958). A grammar of metaphor. London: Seeker & Warburg), in classroom discourse (Cameron, L. (2003). Metaphor in educational discourse. New York: Continuum), and across various spoken and written genres (Shutova, E., & Teufel, S. (2010). Metaphor corpus annotated for source-target domain mappings. Proceedings of LREC 2010, 3255-3261; Steen, G. J., Dorst, A. G., Herrmann, J. B., Kaal, A. A., Krennmayr, T., & Pasma, T. (2010). A method for linguistic metaphor identification: From MIP to MIPVU. Philadelphia: John Benjamins).

### Cerebral Hemisphere Specialization in Carrying Distinct Semantic Processes

Some researchers claim that the right hemisphere (RH) has a primary role in metaphor comprehension. Meanwhile, the left hemisphere (LH) is thought to focus on a small set of highly related semantic associations while inhibiting the marginal and less salient ones. In contrast, the RH activates and maintains a much broader and less differentiated set of semantic associations, including also distantly related, unusual, and less salient meanings (Beeman, M. (1998). Coarse semantic coding and discourse comprehension. In M. Beeman & C. Chiarello (Eds.), Right hemisphere language comprehension: Perspectives from cognitive neuroscience (pp. 255-284). Mahwah, N.J.: Erlbaum; Chiarello, C. (1991). Interpretation of word meanings in the cerebral hemispheres: One is not enough. In P. J. Schwanenflugel (Ed.), The psychology of word meanings (pp. 251-275). Hillsdale, N.J.: Erlbaum.; St. George, M., Kutas, M., Martinez, A., & Sereno, M. I. (1999). Semantic integration in reading: Engagement of the right hemisphere during discourse processing. Brain, 122, 1317-1325). To explain the salience of meaning above language processing type (figurative conventional, novel or literal), Giora has proposed the Graded Salience Hypothesis (GSH), which posits the priority of salient meanings rather than the type of language processed (Giora, R. (2002). Literal vs. figurative language: Different or equal? Journal of Pragmatics, 34, 487-506). According to Giora, the degree of salience of an expression is determined by conventionality, frequency, familiarity, and proto-typicality. Non-salient meanings are not coded in the mental lexicon and rely on contextual (inferential inductive-deductive) mechanisms for their activation.

A number of studies have shown that right hemisphere damaged (RHD) patients seem to have noteworthy difficulties in understanding the gist of jokes, metaphors, connotations, idioms, sarcasm, and indirect requests that reflect the unique ability of the intact RH to maintain the continued activation of multiple meanings of words (Brownell, H. H., & Martino, G. (1998). Deficits in inference and social cognition. The effects of right hemisphere brain damage on discourse. In M. Beeman & C. Chiarello (Eds.), Right hemisphere language comprehension: Perspectives from cognitive neuroscience (pp. 309-328). Mahwah, N.J.: Erlbaum; Burgess, C., & Chiarello, C. (1996). Neurocognitive mechanisms underlying metaphor comprehension and other figurative language. Metaphor and Symbolic Activity, 11, 67-84). Indeed, RHD patients demonstrate deficits in understanding indirect requests (Stemmer, B., Giroux, F., & Joanette, Y. (1994). Production and evaluation of requests by right hemisphere brain damaged individuals. Brain and Language, 47, 1-31), difficulties in interpreting idioms (Van Lancker, D., & Kempler, K. (1987). Comprehension of familiar phrases by left—but not by right-hemisphere damaged patients. Brain and Language, 32, 265-277), and poor comprehension of metaphors (Brownell, H. H., Simpson, T. L., Bihrle, A. M., Potter, H. H., & Gardner, H. (1990). Appreciation of metaphoric alternative word meanings by left and right brain damaged patients. Neuropsychologia, 28, 375-383). However, individuals with LH brain lesions can readily match metaphors with appropriate pictures, where RH brain lesions patients perform poorly at this task (Mackenzie, C., Begg, T., Brady, M., & Lees, K. (1997). The effects on verbal communication skills of right hemisphere stroke in middle age. Aphasiology. 11, 929-945; Winner, E., & Gardner, H. (1977). The comprehension of metaphor in brain damaged patients. Brain, 100, 717-729).

Subordinate meanings activated by an ambiguous word tend to decay rapidly in the LH, whereas the RH maintains activation of both meanings of the ambiguous word (Burgess, C., & Simpson, G. (1988). Cerebral hemispheric mechanisms in the retrieval of ambiguous word meanings. Brain and Language, 3, 86-103). Divided visual field studies showed that semantic priming effects of remotely related words are obtained in the RH, but not in the LH (Chiarello, C. (1991). Interpretation of word meanings in the cerebral hemispheres: One is not enough. In P. J. Schwanenflugel (Ed.), The psychology of word meanings (pp. 251-275). Hillsdale, N.J.: Erlbaum). Individuals with unilateral RHD do not show typical semantic priming effects for targets associated with the metaphorical meanings of words in context (e.g., “chicken-scared”) while LHD patients exhibit these speeded facilitation effects (Klepousniotou, E., & Baum, S. (2007). Disambiguating the ambiguity advantage effect in word recognition: An advantage for polysemous but not homonymous words. Journal of Neurolinguistics, 20, 1-24). Thus, the nature of semantic relations between words is one of the factors that determine hemispheric differences in semantic access and retrieval (Chiarello, C. (1991). Interpretation of word meanings in the cerebral hemispheres: One is not enough. In P. J. Schwanenflugel (Ed.), The psychology of word meanings (pp. 251-275). Hillsdale, N.J.: Erlbaum).

The accumulated evidence supports the hypothesis that the RH contributes to language processing mainly by allowing for widespread activation of multiple word meanings, without subsequent selection. Therefore, it can be claimed that the undifferentiated activation of alternative and sometimes contradictory interpretations of words for some indefinite period of time may support the view that the RH has a selective role to play in the processing of figurative language such as metaphors (Faust, M., & Lavidor, M. (2003). Convergent and divergent priming in the two cerebral hemispheres: Lexical decision and semantic judgment. Cognitive Brain Research, 17, 585-597). Further, the GSH view follows that processing non-salient linguistic meanings such as novel creative unfamiliar metaphors, would recruit RH regions, whereas processing salient linguistic meanings (e.g., lexicalized meanings of either conventional metaphors or of literal expressions) will mainly activate the LH where most of our linguistic knowledge is stored (Giora, R. (1997). Understanding figurative and literal language: The Graded Salience Hypothesis. Cognitive Linguistics, 7, 183-206), Giora, R. (2002). Literal vs. figurative language: Different or equal? Journal of Pragmatics, 34, 487-506), Giora, R. (2003). On our mind: Salience, context and figurative language. New York: Oxford University Press).

Recently, Cardillo et al. investigated the neural career of metaphors in a functional magnetic resonance imaging study using extensively normed new (novel) metaphors and simulated the ordinary gradual experience of metaphor conventionalization by manipulating the participants' exposure to these metaphors. Results showed that the conventionalization of novel metaphors specifically tunes activity within the bilateral inferior prefrontal cortex, left posterior middle temporal gyrus, and right postero-lateral occipital cortex. These results support theoretical accounts attributing a role for the right hemisphere in processing novel, low salience figurative meanings, but also show that conventionalization of metaphoric meaning is a bilaterally-mediated process. Metaphor conventionalization entails a decreased neural load within the semantic networks of both hemispheres rather than a hemispheric or regional shift across brain areas (E R Cardillo, C E Watson, G hL Schmidt, A Kranjec, A Chatterjee (2012). From novel to familiar: Tuning the brain for metaphors. Neuroimage 59 (4), 3212-3221).

### Higher-Order Cognition in Alzheimer's Disease (AD)

### Linking Categorization Processes to Semantic Memory

Recognition of an object entails placing it in a category. Accordingly, categorization processes are paramount to semantic memory, the long-term knowledge grasping of things and events. Besides the number and well established investigations of semantic memory in the context of stored semantic knowledge, sematic memory processing as well as its content plays a role. For instance, limited ability to assign a particular categorization process to intact knowledge could also impair semantic memory (Grossman, M., Smith, E. E., Koenig, P., Glosser, G., Rhee, J., & Dennis, K. (2003). Categorization of object descriptions in Alzheimer's disease and frontotemporal dementia: Limitation in rule-base processing. Cognitive, Affective, and Behavioral Neuroscience, 3, 120-132; Koenig, P., Smith, E. E., & Grossman, G. (2006). Semantic categorization of novel objects in frontotemporal dementia. Cognitive Neuropsychology, 23, 541-562).

A study by Koenig et al., was designed to assess the link of categorization processes with semantic memory by assessing similarity and rule-based learning of a semantically meaningful novel category (biologically plausible novel animals) in patients with mild to moderate AD and correlating performance with semantic classification of familiar objects (Koenig, P., Smith, E. E., Grossman, M., Glosser G., Moore, P. (2007). Categorization of novel animals by patients with Alzheimer's disease and corticobasal degeneration. Neuropsychology, 21, 193-206). The study showed that AD patients had significant rule-based categorization impairment. The AD group required more training trials and had longer response times relative to their own performance in the similarity-based categorization condition as well as to the rule-based categorization performance of healthy participants. Their rule-based categorization performance at test was significantly impaired, showing a graded performance pattern rather than the sharp distinction between members and non-members seen in matched healthy participants. However, the similarity-based categorization performance of AD patients was comparable to the healthy matched subjects.

The correlation between the rule-based categorization impairment of AD patients and their performance on tests of executive function supports the view that a limitation of executive resources such as working memory, inhibitory control, and selective attention, contributes to the deficit with rule-based categorization processing and semantic memory impairment. Most importantly, episodic memory impairment, the hallmark symptom of AD, showed no correlation with performance in either categorization condition, suggesting that semantic memory impairment in mild to moderate AD is relatively independent of episodic memory deficits. The results of the study propose a link between categorization processes and semantic memory impairment in mild to moderate AD. Mainly, intact similarity-based categorization processing will support much of semantic memory performance while deficits in rule-based categorization processes will particularly impair categorization of items, which classification requires specific (e.g., novel) features assessments. Koening et al. concluded that qualitatively distinct categorization processes, supported by distinct cortical networks, contribute to semantic memory (Koenig, P., Smith, E. E., Grossman, M., Glosser G., Moore, P. (2007). Categorization of novel animals by patients with Alzheimer's disease and corticobasal degeneration. Neuropsychology, 21, 193-206).

### Relational Integration and Executive Function in AD

The neurophathological heterogeneity of patients with AD raises the possibility that executive deficits may be present in only a subset of patients with mild or moderate AD (Waltz, J. A., Knowlton, B J., Holyoak, K. J., Boone, K. B., Mishkin, F. S., de Menezes Santos, M., (1999). A system for relational reasoning in human prefrontal cortex. Psychological Science, 10, 119-125; Waltz, J. A., Knowlton, B J., Holyoak, K. J., Boone, K. B., Madruga, C. B., McPherson, S., (2004). Relational integration and executive function in Alzheimer's disease. Neurophysiology, 18, 296-305). In general, executive functions depend on the ability to reason (deductively and inductively) to represent abstract problems characterizing simple or complex relations between objects, events, and symbols (e.g., language and numbers). The prefrontal cortex provides the neural substrate for this capacity. Based on analyses of the working memory impairment in AD, several researchers proposed the manifestation of multiple, distinct patterns of cognitive impairment within AD. One centered on compromised declarative memory systems, and one related to deficits in working memory (WM) and/or executive function (EF). More so, there is a wealth of evidence linking cognitive EF to frontal cortical pathology in AD, and it appears that this pathology may occur relatively early in the course of the disease in a subset of AD patients.

Based on consistent research observations that stages in human cognitive development may be delineated by the ability to process relational representations of different complexities, Halford & Wilson have proposed a hypothesis claiming that relational information is a predictor of the reliance of problems on cognitive executive functions, as well as a predictor of the degree of prefrontal cortex involvement in a cognitive task (Halford, G. S., & Wilson, W. H. (1980). A category theory approach to cognitive development. Cognitive Psychology, 12, 356-411; Halford, G. S. (1984). Can young children integrate premises in transitivity and serial order tasks? Cognitive Psychology, 16, 65-93) and (Halford, G. S., Wilson, W. H., & Phillips, S. (1998). Processing capacity defined by relational complexity: Implications for comparative, developmental, and cognitive psychology. Behavioral & Brain Sciences, 21, 803-864; Robin, N., & Holyoak, K. J. (1995). Relational complexity and the functions of prefrontal cortex. In M. S. Gazzaniga (Ed.), The cognitive neurosciences (pp. 987-997). Cambridge, Mass.: MIT Press).

A subgroup of AD patients in Halford and Wilson's study showed significant impairment on reasoning measures that required online integration of multiple (complex) relations and a neuropsychological profile consistent with prefrontal cortical dysfunction. In addition, because abstract thought is known to depend on the ability to integrate multiple relations, as propositional elements need to be mapped across domains, a number of studies showing impairments in abstract reasoning in mild-to-moderate AD are consistent with the integration of relational information deficits (Halford, G. S., Wilson, W. H., & Phillips, S. (1998). Processing capacity defined by relational complexity: Implications for comparative, developmental, and cognitive psychology. Behavioral & Brain Sciences, 21, 803-864).

For example, studies have demonstrated difficulties in patients with AD in identifying similarities between objects or concepts (Huber, S. J., Shuttleworth, E. C., & Freidenberg, D. L. (1989). Neuropsychological differences between the dementias of Alzheimer's and Parkinson's diseases. Archives of Neurology, 46, 1287-1291; Martin, A., & Fedio, P. (1983). Word production and comprehension in Alzheimer's disease: The breakdown of semantic knowledge. Brain and Language, 19, 124-141; Pillon, B., Dubois, B., Lhermitte, F., & Agid, Y. (1986). Heterogeneity of cognitive impairment in progressive supranuclear palsy, Parkinson's disease, and Alzheimer's disease. Neurology, 36, 1179-1185), in the comprehension of proverbs (Kempler, D., van Lancker, D., & Read, S. (1988). Proverb and idiom comprehension in Alzheimer's disease. Alzheimer's Disease and Associated Disorders, 2, 38-49), and in general abilities related to the capacity to perform inductive inference (Cronin-Golomb, A., Rho, W. A., Corkin, S., & Growdon, J. H. (1987). Abstract reasoning in age-related neurological disease. Journal of Neural Transmission, 24, 79-83).

Still, additional studies on AD individuals suggest that they experience particular difficulty in the performance of tasks of cognitive estimation, another form of inference (Goldstein, F. C., Green, J., Presley, R., & Green, R. C. (1992). Dysnomia in Alzheimer's disease: An evaluation of neurobehavioral subtypes. Brain and Language, 43, 308-322; Shallice, T., & Evans, M. E. (1978). The involvement of the frontal lobes in cognitive estimation. Cortex, 14, 294-303; Smith, M. L., & Milner, B. (1984). Differential effects of frontal-lobe lesions on cognitive estimation and spatial memory. Neuropsychologia, 22, 697-705).

### Metaphor Comprehension—Novelty Matters

A study by Amanzio et al. has found that patients in early stages of AD are selectively impaired in the comprehension of novel creative metaphors while their comprehension of conventional metaphors was conserved. They suggested that the found impairment most likely stems from defective executive functions and verbal reasoning (Amanzio, M., Geminiani, G., Leotta, D., & Cappa, S. (2008). Metaphor comprehension in Alzheimer's disease: Novelty matters. Brain and Language 107, 1-10). They further speculated that the prefrontal cortex dysfunction may represent the corresponding neurological substrate. In addition, patients in the initial stage of the disease did not show deficits in conventional metaphorical language comprehension, compared to subjects in the control group (Papagno, C. (2001). Comprehension of metaphors and idioms in patients with Alzheimer's disease—A longitudinal study. Brain, 124, 1450-1460).

What would then be the possible reasons for the selective impairment in novel creative metaphors comprehension (and report) in the initial stage of AD? One possible reason is that the comprehension of conventional and “dead” metaphors, which are central to ordinary language usage, may reflect “recognition” ability based on automatic processing. This is because the meanings of conventional metaphors are lexicalized through frequent usage, thus they are considered as very salient.

In contrast, comprehension of novel creative metaphors, may reflect an online process of abstract reasoning construction of common ground (e.g., relational mapping/shared properties between the topic and the vehicle). Another possible reason is that comprehension of conventional metaphors is sufficient to access semantic knowledge. This process may be considered to require limited intentional and attentional control. On the other hand, the meaning of novel creative metaphors is not part of the mental lexicon and thus might require additional processing such as the retrieval of information from episodic, mental imagery, and verbal reasoning (Mashal, N., Faust, M., & Hendler, T. (2005). The role of the right hemisphere in processing nonsalient metaphorical meanings: Application of principal components analysis to fMRI data. Neuropsychologia, 43, 2084-2100).

Still, patients with AD are specifically impaired in their explanation of novel creative metaphors and proverbs, but not in their understanding of conventional metaphors and idioms (Santos, M., Sougey, E., & Alchieri, J. (2009). Validity and reliability of the Screening Test for Alzheimer's Disease with Proverbs (STADP) for the elderly. Arquivos De Neuro-Psiquiatria, 67(3-B), 836-842). These patients even exhibit normal understanding of irony and sarcasm (Kipps, C., Nestor, P., Acosta-Cabronero, J., Arnold, R. & Hodges, J. (2009). Understanding social dysfunction in the behavioural variant of frontotemporal dementia: The role of emotion and sarcasm processing. Brain: A Journal Of Neurology, 132, 592-603).

### Relational Words Enacting a Flexible Orthographic Coding in Alphabetical Languages

### Some Open Bigrams are Also Relational Open Proto-Bigram Function Words

A number of computational models have postulated open bigrams as the best means to substantiate a flexible orthographic encoding. In these models, a flexible orthographic coding is achieved by coding ordered combinations of contiguous and non-contiguous letter pairs, namely open bigrams. Still, these open bigrams represent an abstract intermediary layer between letters and word units. For example, in the English language there are 676 pairs of letters combinations or open bigrams (see Table 1 below). We introduce herein an open bigram novel language property that plays an early pivotal brain developmental role in shaping higher order cognitive conceptual skills to rapidly adapt and be able to efficiently handle, implicitly and/or explicitly, alphanumeric computations (serial, combinatorial, or statistical kind) and their resulting associative/analogical inductive thought processes through input-output learning mechanisms.

The teachings of the present invention identify and categorize monosyllabic word members that belong to one of five novel classes of open bigram words, herein dubbed “relational open proto-bigram words” (see below). There are 24 relational open proto-bigrams that convey a linguistic semantic meaning, and therefore are considered words. These 24 relational open proto-bigrams words represent 3.55% out of 676 monosyllabic open bigrams possible to obtain in the English Language alphabet (see Table 1 below).

TABLE 1
Open Bigrams of the English Language

| | | | | | | | | | | | | | | | | | | | | | | | | | |
|---|---|---|---|---|---|---|---|---|---|---|---|---|---|---|---|---|---|---|---|---|---|---|---|---|---|
| aa | ab | ac | ad | ae | af | ag | ah | ai | aj | ak | al | am | an | ao | ap | aq | ar | as | at | au | av | aw | ax | ay | az |
| ba | bb | bc | bd | be | bf | bg | bh | bi | bj | bk | bl | bm | bn | bo | bp | bq | br | bs | bt | bu | bv | bw | bx | by | bz |
| ca | cb | cc | cd | ce | cf | cg | ch | ci | cj | ck | cl | cm | cn | co | cp | cq | cr | cs | ct | cu | cv | cw | cx | cy | cz |
| da | db | dc | dd | de | df | dg | dh | di | dj | dk | dl | dm | dn | do | dp | dq | dr | ds | dt | du | dv | dw | dx | dy | dz |
| ea | eb | ec | ed | ee | ef | eg | eh | ei | ej | ek | el | em | en | eo | ep | eq | er | es | et | eu | ev | ew | ex | ey | ez |
| fa | fb | fc | fd | fe | ff | fg | fh | fi | fj | fk | fl | fm | fn | fo | fp | fq | fr | fs | ft | fu | fv | fw | fx | fy | fz |
| ga | gb | gc | gd | ge | gf | gg | gh | gi | gj | gk | gl | gm | gn | go | gp | gq | gr | gs | gt | gu | gv | gw | gx | gy | gz |
| ha | hb | hc | hd | he | hf | hg | hh | hi | hj | hk | hl | hm | hn | ho | hp | hq | hr | hs | ht | hu | hv | hw | hx | hy | hz |
| ia | ib | ic | id | ie | if | ig | ih | ii | ij | ik | il | im | in | io | ip | iq | ir | is | it | iu | iv | iw | ix | iy | iz |
| ja | jb | jc | jd | je | jf | jg | jh | ji | jj | jk | jl | jm | jn | jo | jp | jq | jr | js | jt | ju | jv | jw | jx | jy | jz |
| ka | kb | kc | kd | ke | kf | kg | kh | ki | kj | kk | kl | km | kn | ko | kp | kq | kr | ks | kt | ku | kv | kw | kx | ky | kz |
| la | lb | lc | ld | le | lf | lg | lh | li | lj | lk | ll | lm | ln | lo | lp | lq | lr | ls | lt | lu | lv | lw | lx | ly | lz |
| ma | mb | mc | md | me | mf | mg | mh | mi | mj | mk | ml | mm | mn | mo | mp | mq | mr | ms | mt | mu | mv | mw | mx | my | mz |
| na | nb | nc | nd | ne | nf | ng | nh | ni | nj | nk | nl | nm | nn | no | np | nq | nr | ns | nt | nu | nv | nw | nx | ny | nz |
| oa | ob | oc | od | oe | of | og | oh | oi | oj | ok | ol | om | on | oo | op | oq | or | os | ot | ou | ov | ow | ox | oy | oz |
| pa | pb | pc | pd | pe | pf | pg | ph | pi | pj | pk | pl | pm | pn | po | pp | pq | pr | ps | pt | pu | pv | pw | px | py | pz |
| qa | qb | qc | qd | qe | qf | qg | qh | qi | qj | qk | ql | qm | qn | qo | qp | qq | qr | qs | qt | qu | qv | qw | qx | qy | qz |
| ra | rb | rc | rd | re | rf | rg | rh | ri | rj | rk | rl | rm | rn | ro | rp | rq | rr | rs | rt | ru | rv | rw | rx | ry | rz |
| sa | sb | sc | sd | se | sf | sg | sh | si | sj | sk | sl | sm | sn | so | sp | sq | sr | ss | st | su | sv | sw | sx | sy | sz |
| ta | tb | tc | td | te | tf | tg | th | ti | tj | tk | tl | tm | tn | to | tp | tq | tr | ts | tt | tu | tv | tw | tx | ty | tz |
| ua | ub | uc | ud | ue | uf | ug | uh | ui | uj | uk | ul | um | un | uo | up | uq | ur | us | ut | uu | uv | uw | ux | uy | uz |
| va | vb | vc | vd | ve | vf | vg | vh | vi | vj | vk | vl | vm | vn | vo | vp | vq | vr | vs | vt | vu | vv | vw | vx | vy | vz |
| wa | wb | wc | wd | we | wf | wg | wh | wi | wj | wk | wl | wm | wn | wo | wp | wq | wr | ws | wt | wu | wv | ww | wx | wy | wz |
| xa | xb | xc | xd | xe | xf | xg | xh | xi | xj | xk | xl | xm | xn | xo | xp | xq | xr | xs | xt | xu | xv | xw | xx | xy | xz |
| ya | yb | yc | yd | ye | yf | yg | yh | yi | yj | yk | yl | ym | yn | yo | yp | yq | yr | ys | yt | yu | yv | yw | yx | yy | yz |
| za | zb | zc | zd | ze | zf | zg | zh | zi | zj | zk | zl | zm | zn | zo | zp | zq | zr | zs | zt | zu | zv | zw | zx | zy | zz |

Some Relational Open Proto-Bigrams Words are Function Words Depicting: 1) Prepositions, 2) Actions, 3) Conjunctions and 4) Linguistic Structures that (Tacitly) Refer to: a) the Speaker or b) Others in Alphabetic Languages

There are five classes of open bigrams that are also considered to be words in the English language which play a central enactive role in the developmental maturation of abstract relational thinking. These five classes of open bigrams function to relate/link into the same category (within the permissible grammatical structure of the English language) meanings of distant lexical items into a novel category domain and/or relate/link meanings of close lexical items into a natural/conventional category domain. This relational alignment among lexical items is gradually attained via thought processes involved in the conceptual enactment of a coherent spatial-temporal relational mapping. At first, these thought processes implicitly depict abstract shallow relational links among lexical items, but later on they turn into complex, ruled-based, relational mapping (web) involving deep causal relationships among lexical items. Thus analogies (e.g., comparisons, similarities, exemplar prototyping), interpretations concerning different kinds of figurative meanings (e.g., metaphors, ironies, proverbs), and metacognitive mentation states emerge as relational knowhow.

One class of open bigrams of the form vowel-consonant (VC) or consonant-vowel (CV) are considered to be words that carry semantic relational meaning; This class is herein named “relational open proto-bigrams”. AN, AS, AT, BY, IN, OF, ON, TO, UP, are highly frequent ‘function’ words that belong to a linguistic class named ‘preposition words’. A preposition word is a word governing, and usually preceding, a noun or pronoun, and expressing a relation to another word or element in the clause, such as ‘the book is on the table’, ‘she looked at the cat’, ‘what did you do it for? We commonly use prepositions to show a relationship in space or time or a logical relationship between two or more people, places, or things. In English, some propositions are short, mostly containing six letters or fewer.

A second class of open bigrams of the form VC or CV that are also considered to be words that carry semantic relational action meaning. This class is herein also named “relational open proto-bigrams”. These relational open proto-bigrams words are highly frequent ‘function’ words that belong to a linguistic class named ‘verb words’. Verb words are any member of a class of words that function as the main elements of predicates, typically express an action, a state, or a relation between two things, and may be inflected for tense, aspect, voice, mood, and to show agreement with the subject or object. These relational open proto-bigram words are the following function words: AM, BE, DO, GO, IS, NO.

A third class of open bigram of the form VC or CV that are also considered to be words that carry semantic relational meaning. This class is herein also named “relational open proto-bigrams”. These relational open proto-bigram words entail highly frequent ‘functional’ words that belong to a linguistic class named ‘conjunction words’. Conjunction words are very important for constructing sentences. Conjunction words link/relate different parts of a sentence. Basically, conjunctions join/relate words, phrases, and clauses together. These relational open proto-bigrams are the following conjunction words: AS, IF, OR, SO.

A fourth class of open bigrams of the form VC or CV that are also considered to be words that carry semantic relational meaning. This class is herein also named “relational open proto-bigram”. These relational open proto-bigram words entail highly frequent ‘functional’ words that their meaning tacitly represents or implies the “speaker” or “others”, referring to 1) belonging to or associated with the speaker; 2) used by a speaker to refer to himself/herself and one or more other people considered together; 3) used as the object of a verb or preposition; 4) referring to the male person or animal being discussed or last mentioned; or 5) to anyone (without reference to sex) or tacitly to “that person”. These relational open proto-bigrams are the following functional words: HE, ME, MY, US, WE.

A fifth open bigrams class of the form VC or CV that are also considered to be words that carry semantic relational meaning. This class is herein named “relational open proto-bigrams”. These relational open proto-bigram words convey a semantic meaning that is interpreted by the listener to imply potentially ‘figurative’ meaning referring to: 1) a concept or abstract idea: ‘IT’; or 2) a negation as a metaphor inducing operator: ‘NO’ (Giora, R., Balaban, N., Fein, O., & Alkabets, I. (2005). Negation as positivity in disguise. In: Colston, H. L., and Katz, A. (eds.), Figurative Language comprehension: Social and cultural influences (pp. 233-258). Hillsdale, N.J.: Erlbaum; Giora, R., Fein, O., Metuki, N., & Stern, P. (2010). Negation as a metaphor-inducing operator. In L. Horn (Ed.), The expression of negation (pp. 225-256). Berlin: Mouton). Negation is a device that often functions to enhance metaphoric meaning in discourse such as “I am not your maid”. Yet, affirmative counterparts are judged as conveying literal interpretations containing the modifier “almost”, such as “I am almost your maid”, to convey literal meaning.

In general, functional relational open proto-bigram words either have reduced lexical meaning or ambiguous meaning. They signal the structural grammatical relationship that words have to one another and are the relational lexical glue that holds sentences together. Relational open proto-bigram words (function) also specify the attitude or mood of the speaker. They are resistant to change and are always relatively few (in comparison to ‘content words’). Relational open proto-bigrams (and other n-grams e.g. “THE”) words may belong to one or more of the following function words classes: articles, pronouns, adpositions, conjunctions, (auxiliary) verbs, interjections, particles, expletives, and pro-sentences. Further, relational open proto-bigrams that are function words are traditionally categorized across alphabetic languages as also belonging to a class named ‘common words’.

In the English language, there are about 350 common words which represent about 65-75% of the words most used when speaking, reading, or writing. These 350 most common words satisfy the following criteria: 1) the most frequent/basic words of an alphabetic language; 2) the shortest words (on average)—up to 6 or 7 letters per word; and 3) are not perceptually discriminated (access to their semantic meaning) by the way they sound; they must be orthographically recognized (by the way they are written).

Frequency Effects in Alphabetical Languages for: 1) Relational Open Proto-Bigrams Function Words as: a) Stand-Alone Function Words in Between Words and as b) Subset Function Words Embedded within Words

Fifty to 75% of written words or words articulated in a conversation belong to the group of most common words. Just 100 different most common words in the English language (see Table 2 below) account for a remarkable 50% of any written or spoken text. Furthermore, it is noteworthy that 22 of the above-mentioned relational open proto-bigrams function words (BE, TO, OF, IN, IT, ON, HE, AS, DO, AT, BY, WE, OR, AN, MY, SO, UP, IF, GO, ME, NO, US) (see table 2 below) are also part of the 100 most common words. On average, one in any two spoken or written words is one of the 100 most common words. Similarly, 90% of any average written text or conversation is comprised of a vocabulary consisting of about 7,000 common words from the existing 1,000,000 words in the English language.

TABLE 2
Most Frequently Used Words Oxford Dictionary 11^{Th} Edition

| | |
|---|---|
| 1. | the |
| 2. | be |
| 3. | to |
| 4. | of |
| 5. | and |
| 6. | a |
| 7. | in |
| 8. | that |
| 9. | have |
| 10. | I |
| 11. | it |
| 12. | for |
| 13. | not |
| 14. | on |
| 15. | with |
| 16. | he |
| 17. | as |
| 18. | you |
| 19. | do |
| 20. | at |
| 21. | this |
| 22. | but |
| 23. | his |
| 24. | by |
| 25. | from |
| 26. | they |
| 27. | we |
| 28. | say |
| 29. | her |
| 30. | she |
| 31. | or |
| 32. | an |
| 33. | will |
| 34. | my |
| 35. | one |
| 36. | all |
| 37. | would |
| 38. | there |
| 39. | their |
| 40. | what |
| 41. | so |
| 42. | up |
| 43. | out |
| 44. | if |
| 45. | about |
| 46. | who |
| 47. | get |
| 48. | which |
| 49. | go |
| 50. | me |
| 51. | when |
| 52. | make |
| 53. | can |
| 54. | like |
| 55. | time |
| 56. | no |
| 57. | just |
| 58. | him |
| 59. | know |
| 60. | take |
| 61. | person |
| 62. | into |
| 63. | year |
| 64. | your |
| 65. | good |
| 66. | some |
| 67. | could |
| 68. | them |
| 69. | see |
| 70. | other |
| 71. | than |
| 72. | then |
| 73. | now |
| 74. | look |
| 75. | only |
| 76. | come |
| 77. | its |
| 78. | over |
| 79. | think |
| 80. | also |
| 81. | back |
| 82. | after |
| 83. | use |
| 84. | two |
| 85. | how |
| 86. | our |
| 87. | work |
| 88. | first |
| 89. | well |
| 90. | way |
| 91. | even |
| 92. | new |
| 93. | want |
| 94. | because |
| 95. | any |
| 96. | these |
| 97. | give |
| 98. | day |
| 99. | most |
| 100. | us |

Most Frequently Used Words Oxford Dictionary 11^{th} Edition

It is further hypothesized that a subject exercising his/her fluid reasoning abilities to problem solve the herein presented new language settings involving novel configurations of relational lexical items belonging to any of the 5 classes of relational open-proto-bigrams words will result in a number of task related quantifiable neuroperformance and core domain skill gains. Accordingly, the expected measurable gains should at least encompass the following neuroperformance areas: I) sensory motor, II) perceptual, III) higher order cognitive relational abilities and, IV) cognitive non-relational abilities.

The present subject matter also specifically targets the promotion, stability, and enhancement of higher order relational cognition faculties and their interactive informational handshake with other non-relational cognitive abilities. Examples of this include, but are not limited to, the following:

1. Ability of a subject's higher order cognitive skills to abstractly conceptualize and enact a complex multidimensional mapping of novel and/or similar relational lexical knowledge stored in long term memory (LTM) from orthographic alphabetical languages, in order to infer and activate in parallel, potentially related LTM stored similar and/or novel lexical meaning(s) to name: a) a concrete item; b) a relational item; or c) a relational situation-state. Complex conceptualization is herein defined as the speedy enactment of a web of relations (the relational mapping), correlations, and cross-correlations among the meanings of a minimum of 3 relational lexical items;

2. Preferred bottom-up-top-down processing neural channels where a handshake of relational-relational or relational-non-relational lexical information promotes a faster and automatic direct cascaded (parallel) spread activation of meaning (effect) from orthography to semantics;

3. Faster relational lexical-sub-lexical items recognition-identification;

4. Ability to quickly attain lexical meaning assisted by efficiently performing degrees of alphabetical compressions (letter's chunking) on a number of lexical relational items at once in Visual Short Term Memory (VSTM);

5. Real-time manipulation of relational lexical knowledge/information becoming less attentional taxing/demanding in
a. Working Memory (WM)
b. Short Term Memory (STM) e.g., monitoring (keeping track); and
c. Long Term Memory (LTM) e.g., encoding-retrieval;

6. Experience of a faster and greater on-line (real time) versatility in manipulating a larger number of relational lexical items in STM at once;

7. Ability to perform robust encoding (stronger relational consolidation among lexical items) and faster automatic retrieval of semantic meaning from relational lexical items from LTM;

8. Direct semantic track for fast retrieval of word relational literal meaning; and

9. For a proficient reader, when relational open proto-bigram words fulfill a role of a stand-alone function by connecting/relating a word unit in between words in a sentence. There will not be visual attentional sensitivity (thus no arousal) to their (relational open proto-bigram) orthographic form. More so, the semantic literal meaning of these relational open proto-bigram words will be retrieved automatically due to the intrinsic orthographic-phonological representational capacity of the relational words, which affords maximal data compression (chunking) along with a robust processing encoding and consolidation in STM-LTM. Namely, stand-alone relational open proto-bigrams connecting/relating words in between words in sentences are factually automatically ‘known’ implicitly. In other words, a proficient reader may not explicitly pay attention to them, remaining minimally aroused to their orthographic appearance. In silent reading, the reader will not [silently] verbalize any of these relational open proto-bigram words encountered while visually swiping through print in a sentence.

It is further assumed that constraining the presented new language settings in novel ways will directly bear an influence on how the subject sensory motor searches, perceptually recognizes, cognitively abstractly conceptualizes, reasons (e.g., inductively infers) in order to problem solve, and sensory motor performs to lexically categorize and/or lexically pattern-complete a given set of entailed relational lexical items and/or reorganize a given number of lexical items into a correctly syntactic grammatical structure. Therefore, it is expected that intentionally constraining the presented new language settings through novel fluent reasoning strategies will grant the exercising subject, in a relatively short period of time, an optimal capacity for implicit-explicit transfer of relational lexical knowledge, mainly for the task at hand. However, it is also contemplated that the task-specific acquired relational lexical knowledge can be implicitly transferred to other similar sensorial-perceptual-motor related tasks at a much later time.

The transfer of relational lexical meaning information can generate a direct measurable gain in the performance of the task at hand in the short term as a result of an efficient sensory motor-perceptual adaptation and related implicit learning. For the long term, the transfer can also generate a measurable gain in the exercised core skill domain as a result of explicit learning due to the subject's capability to grasp the full depth of the generated complex multidimensional abstract mapping of relational lexical knowledge and the enacting of a deeper conceptualization concerning planning the best steps/path to take in order to correctly (minimize error) solve the problem at hand. Therefore, the novel constraining presented herein aims to provide a subject with a greater affordance of higher order cognitive faculties, which is translated into multidimensional abstract conceptualization mapping and fast processing to activate, retrieve, or inhibit lexical meaning (literal or figurative) from relational language structures and their respective orthographic alphabetical distributions.

Further, it is an object of the present subject matter to grant a greater functional versatility to higher order cognitive faculties such that a subject will be capable of enduring longer optimal cognitive functional stability and be better shielded against old age maladies stemming from cognitive decay.

Without limiting the scope of the present invention, a number of novel constrains implemented upon the herein new alphabetical language settings may include the following:
1) Selected relational lexical items belong to specific relational lexical categorical domains;
2) Intentional serially organization of all of the selected relational lexical items according to pre-selected alphabetical orders;
3) Several of the selected relational lexical items consist of letter strings that do not entail repeated letters; selected relational lexical items consisting of letter strings that entail serially non-contiguous repeated letters are also used to a lesser extent;
4) Syntactical-grammatical organization of relational lexical items to communicate figurative meaning in figurative speech statements; and
5) Sensorial modulation of the spatial and/or time perceptual related attributes of all of the relational lexical items used in the exercises herein.

More so, a number of novel methodological constrains are implemented to facilitate and promote lexical implicit-explicit relational knowledge learning and comprehension. The new language settings involve one or more of the following language related processes: production-verbalization, reading silently-aloud, spatial distributions of visual symbols, mentation (e.g., abstract thinking-conceptualization to formulate inferences-deductions and categorical and/or analogical similarities/comparisons), and listening.

Specifically, the herein novel methodological constraints facilitate and promote the following higher order cognitive skills and processes:
1) Conceptual attainment of a greater depth of abstractness when thinking-conceptualizing the meaning of lexical relational properties. For example, the effortless capability of enacting a complex multidimensional abstract mapping involving direct lexical relations and lexical correlations among close and distant lexical relational items and quick abstract conceptualization of a robust casual (ruled or logic based) relational mapping, resulting in efficient linkage-alignment of the multiple involved related meanings of the lexical relational items;
2) Facilitation and promotion of abstract thinking engagement (inventive/creative thinking) concerning novel lexical items, resulting in quick creation/invention (from scratch) of new categorical relational lexical domains;
3) Competency to engage in abstract lexical conceptualizations allowing higher order cognitive handling of a multi-layer of relational lexical knowledge (interconnected and interrelated relational meanings web) on the fly, resulting in effortless powerful analogical thinking-reasoning that proficiently pinpoints and effortlessly extracts similarities of lexical items and makes comparisons among exemplars or retrieves a central tendency among a given number of exemplars, namely the ability to retrieve the “prototype” relational or concrete lexical item from a given sample of lexical or non-lexical items;
4) Enhancement of the capability to foster powerful abstract conceptualizations when thinking-reasoning the meaning of relational language, thereby very quickly implicitly grasping/acquiring the ambiguous or conventionalized literal-like meaning implied in figurative language statements, particularly when figurative language statements take the ambiguous non-salient speech form of novel creative metaphors, ironies, and proverbs;
5) Facilitation of a smoother cognitive transition/shift in the process of interpreting novel creative metaphors statements; e.g., figurative speech statements conveying novel creative meanings (e.g., novel metaphors) become easier to conventionalize (like-‘literal’) in part due to their frequent use to represent daily common-causal circumstances (e.g., ‘the mind is a computer’);
6) Competency to quickly, on the fly, and abstractly conceptualize a complex mapping of relational lexical meanings, enhancing the ability to handle/manipulate several interacting or interconnected dimensions of the abstract meanings of relational lexical items. Effortless capability to engage in meta-cognitive introspection states, namely the capability to develop a robust introspective access to metacognitive thinking related to complex interrelated meanings of relational lexical items. In many ways, metacognitive thinking acts to reformat a subject's goal oriented behavior so his/her performance is highly adaptable in the face of novel emerging (not contemplated) circumstances. Still, metacognitive states grant access to problem solving of complex relational lexical concepts/ideas/items, not previously known (novel) or stored (known from past experience) in long term memory. The latter said can be seen to relate best to a subject's ability to engage, on the fly, in metacognitive introspection to parameterize and problem solve a new requirement to perform (non or quasi-expected) relational lexical setting. Such problem solving may also be aided by a suitable learning strategy, such as serial or associative learning. Accordingly, the presented relational lexical setting scenario is conceptually segmented into a number of lexical abstract basic thoughts formulating, at least: ‘what’, ‘how’ and ‘when’ the subject should perform in order to successfully extract, infer-deduct, and analogize similarities/comparisons stored in past related relational lexical knowledge. Further, the conceptual segments are selected according to the new emerging circumstance where the subject will cognitively reciprocate by formulating an adaptive problem solving strategy. The related retrieved relational lexical knowledge will then be applied to task reshape and guide goal-oriented behavior in somewhat similar, although novel, situational circumstances. This kind of behavior can be characterized as imaginative/creative/resourceful;
7) Physiological arousal mechanisms dispose cognitive attention (visual/auditory) to orient and quickly, selectively identify the most likely pragmatic relational meaning in the context of a spoken or written language statement. A written language statement meaning: a) a grammatically correct sentence or sentences, b) a grammatically incorrect sentence or sentences, or c) a list of related or unrelated lexical items meanings [e.g., a written list of “names or numbers” or a written list of “words-like non-words”—for example, special letter constructions of pseudowords to receptively suggest a semantic meaning];
8) Physiological arousal mechanisms dispose cognitive attention (visual/auditory) to orient accurately, quickly, and selectively detect and infer semantic relational congruencies or incongruences from spoken or written statements;
9) Competency to quickly reject or inhibit/downplay ‘literal’ salient meaning from specific figurative speech statements, as for example, “irony” and “idiom” statements;
10) Physiological arousal mechanisms dispose (receptive) cognitive aural attention to orient selectively rapidly attuning to the prosody sound pattern of spoken language statements, particularly those which entail at least one stand-alone lexical relational item and/or those which entail more than one lexical relational items meaning embedded within one or more lexical relational carrier items meanings. A spoken language statement conveying semantic meaning could be any of the following kinds: a) a spoken grammatical-like correct language statement, b) a spoken non-grammatical-like correct language statement, c) a spoken language statement in the form of a list of words conveying related or unrelated lexical items meanings [e.g., a spoken list of “names/numbers” words or a spoken list of “words-like pseudo-non-words”] and; d) spoken novel figurative speech statements i) where the metaphoric ‘topic’ and ‘vehicle’ words are both relational lexical items or ii) where the metaphoric ‘topic’ word or the metaphoric ‘vehicle’ word is a relational lexical item(s) and;
11) Physiological arousal mechanisms dispose cognitive visual attention to pick up (implicitly) on the fly, one or more stand-alone salient lexical relational items meanings and/or salient lexical relational sub-items meanings embedded within one or more stand-alone lexical relational carrier items meanings when visually swiping/reading printed letter strings.

The related art substantiating the present subject matter is vast. The provided overwhelming evidence corroborates the position that claims relational knowledge as a unique emergent property that empowers and shapes higher order cognitive faculties due to the symbolic implementation-performance (production-reception) and related reasoning about generic alphabetical and lexical serial patterns embedded across all alphabetical languages. Indeed, humans possess a natural capacity for confronting change and adapting to novel introspective metacognitive states as well as social and environmental (physical) perturbations.

In general, the teachings of the present subject matter strongly suggest that higher order cognitive faculties reflect the unique human ability to engage in language mentation states (thinking activities) that abstractly and symbolically conceptualize the quickest best strategy to problem solve a particular undertaking in order to fulfill a goal oriented purpose (short or long term) in and through language.

The present subject matter aims to rapidly promote higher order cognitive relational abstract conceptual thinking-reasoning to rapidly facilitate orthographic and phonological lexical processing and direct cascade activation of related word form meanings. The present subject matter aims to attain the latter by revealing a methodology principally aimed to promote fluid inductive reasoning and novel lexical problem solving involving relational open proto-bigram words. Specifically, these open proto-bigram words are embedded and dynamically interacting, thereby activating one or more lexical meanings at a time in alphabetical language settings. Exemplary alphabetical language settings include: 1) when lexical items are arranged in alphabetical or inverse alphabetical order (or in any other preselected alphabetical order), 2) lexical categories, 3) similes & comparison-based speech statements, 4) analogy-based speech statements, 5) sentence-carrier sub-word layers of lexical embedding, and 6) figurative speech statements (e.g. metaphor, irony, idiom, proverb, adage). The herein exercising of relational-based lexical knowledge also aims to facilitate and promote new learning and by extension reduce the cognitive taxing effects stemming from busy and distracted attentional processes due to the handling and retrieving of concrete non-relational lexical items from memory in real time.

The present subject matter is generally directed towards: a) reducing cognitive decline in the normal aging population and b) slowing down or reversing early stages of cognitive maladies, later resulting in neurodegeneration states such as Dementia and Alzheimer's disease. These directives are generally achieved through the safe implementation, via a computer, any other mobile device, or the like, of an easy to understand and user friendly, novel alphabetical language neuroperformance regimen of exercises aimed at sustaining the optimal functioning of cognitive brain as a whole, for as long as feasibly possible.

In particular, the interactive embodied informational reciprocal interactions are accomplished among higher order cognitive relational faculties, cognitive non-relational abilities, and sensorial-perceptual skills-systems. In these interactive embodied informational reciprocal interactions, the user becomes physiologically aroused and attentionally oriented (selectively predisposed) in order to be capable of performing the following at once or in a number of steps: alphanumeric pattern search, alphanumeric pattern recognition, alphanumeric pattern abstract conceptualization, alphanumeric pattern constraint, alphanumeric pattern organization (e.g., partial or complete; relate or reject), alphanumeric pattern production, alphanumeric pattern contemplation, and language relationally related to numerical quantities (e.g., the numerical digit value ‘7’ is relationally (related) bigger than the numerical digit value ‘6’; the numerical digit value ‘5’ is relationally (related) smaller than the numerical digit value ‘6’). Additionally, regarding the alphanumeric pattern contemplation, the relational higher order cognitive conceptual faculties, sensorial and perceptual skills systems also apply to a ‘social’ context, where language for the most part fulfills a ‘communicative’ acting role.

The implicit-explicit adaptive learning abilities enable humans, in a relatively short period of time, to master the core building blocks of native symbolic alphabetical language and the relative semantic meaning of number quantities in a series of numbers. Furthermore, the teachings of the present subject matter also claim that the learning of selective sequential spatial-temporal alphabetical orders, combinatorial orders, and/or statistical distributions of relational lexical items and the full or partial conceptualization of their resulting relational mappings-systems promotes and enhances cognitive higher order abstract relational thinking-reasoning and their resulting task-embodied performances.

For most part, these cognitive higher order abstract conceptualizations are conceived as portraying and setting in motion relational lexical reasoning processes. Such reasoning processes gradually succeed in enacting a lexical relational informational web of deep causal and logical (ruled based) direct interrelations, correlations, and cross-correlations among relational concepts/ideas/meanings, other concrete non-relational symbolic lexical items meanings (e.g., objects), and other quasi-lexical abstract conceptualizations depicting states (e.g., emotional conditions/feelings about self or others captured via imageability states due to their ambiguity, and rarely represented accurately by relational-non-relational lexical items in language). Nevertheless, these quasi-lexical abstract conceptualization states are also considered to be an important complementary building block of higher order cognition faculties if one is to grasp and master semantic language meaning.

Within the context of the present subject matter, higher order cognitive faculties reflect, more than anything else, the natural ability to engage in complex and interwoven degrees of abstract relational symbolic thinking-conceptualization. Consequently, the capabilities of human embodied sensory motor-perceptual-non-relational cognitive skills are expanded. In fact, these abstract relational and non-relational symbolic thinking-reasoning complex degrees of interactions unfold as introspective conceptualizations capable of simulating functional states related to oneself, others, events, and relational-concrete objects in the environment.

Still, the present subject matter is concerned with cognitive decline in normal aging, MCI, and the early and mild stages of neurodegenerative diseases, such as Dementia, Alzheimer's, and Parkinson's disease. In this respect, the present subject matter provides a non-pharmacological platform of novel alphabetical language neuro-performance exercises that specifically target and promote relational lexical thinking-reasoning problem solving.

Without limiting the scope, the examples of the implemented exercises set in motion an innovative methodology principally promoting fluid reasoning in order to encourage engaging relational lexical problem solving involving the innovative use and manipulation of a vast number of relational lexical items meanings across a multidisciplinary language landscape. Examples within the language landscape include, but are not limited to, categorical learning, figurative language, analogical reasoning in language, language morphology, orthographic-phonological code processing, conceptualization of relational language semantic meaning-mapping, and knowledge.

Still, without limiting the scope of the present subject matter, the herein examples aim to implement the novel use of relational open proto-bigrams lexical items meanings and other selected relational lexical word meanings through alphabetical, categorical, morphological, and various types of syntactic-grammatical language structures settings to achieve certain neuroperformance goals. Further, the parallel activation of distinct but correlated relational lexical meanings and their respective spatial and/or time perceptual related attribute changes, encourages the user to engage inductive abstract conceptualizations to enact complex relational lexical mappings in order to problem solve the presented relational language based settings. Neuroperformance goals may include the following without limitation: a) promote and sustain functional stability of non-relational cognitive processes for as long as feasibly possible; b) promote and sustain functional stability of higher order relational cognitive faculties for as long as feasibly possible; c) delay or shield the normal aging population from the aversive effects arising from non-relational cognitive decline; d) sustain or promote the cognitive drive to explicitly engage in learning; e) delay or shield the MCI population from progressing to the neurodegenerative state; f) promote or withstand (and to some extent enhance) normal performance ability in a selective core of non-relational cognitive skills; and g) facilitate metacognitive introspection ability to guide goal oriented behavior to: 1) successfully perform a selective core of daily instrumental activities and 2) develop encouragement to engage in social interaction.

The performance of a selective core of daily instrumental activities refers herein to innovative metacognitive states capable of introspectively simulating relational performance instances and their successful assembling into coherent embodied patterns (e.g., concrete and/or non-concrete lexical items) of behavior by promoting and guiding goal oriented performance. In these innovative metacognitive states, a subject reasons in order to correctly plan the steps that should be taken to execute future related actions (short & long term). Alternatively, a subject abstractly reasons new relational lexical alignments among a set of lexical item meanings in order to problem solve an active novel situation. The subject cannot completely retrieve the relational lexical mapping related to similar past performances from LTM to guide present imminent behavior (e.g., performance execution or inhibition).

The development of encouragement to engage in social interaction refers herein to the ability to promote and sustain a novel metacognitive language drive in the user that promotes and thus encourages social interaction (social cognition). Namely, this feature is designed to develop an affective motivation in the user for engaging others via relational language thinking and reasoning capable of mentally simulating affective states.

### Methods

The definitions given to the terms below are in the context of their meaning when used in the body of this application and the claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

“Alphabetic array” is defined as an open serial order of letters, wherein the letters are not fixed to a specific ordinal position, and the letters may either be all different or repeated. An alphabetic array may encompass words and/or non-words.

### “Alphabetic Compression”

It has been empirically observed that when the first and last letter symbols of a word are kept in their respective serial ordinal positions, the reader's semantic meaning of the word may not be altered or lost by altering the ordinal positions or removing one or more letters in between the fixed first and last letters. This orthographic transformation is herein named “alphabetic compression”. Consistent with this empirical observation, the notion of “alphabetical compression” is extended into the following definitions:

If a “symbols sequence is subject to alphabetic compression”, which is characterized by the removal of one or more contiguous symbols located in between two predefined symbols in the sequence of symbols, the two predefined symbols may, at the end of the alphabetic compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the alphabetic compression of a letter sequence is considered to take place at two letters symbols sequential levels, “local” and “non-local”. Further, the non-local letters symbols sequential level comprises an “extraordinary letters symbols sequential compression case.”

A “local open proto-bigram term compression” is characterized by the omission or removal of one or two contiguous letters in a sequence of letters lying in between the two letters that form or assemble an open proto-bigram term. Upon the removal or omission of these letters, the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term. Upon the omission or removal of these letters, the two letters of the open proto-bigram term become contiguous letters in the letters sequence.

An “extraordinary non-local open proto-bigram compression” is a particular case of a non-local open proto-bigram term compression. This occurs in a letters sequence comprising N letters when the first and last letters in the letters sequence are the two selected letters forming or assembling an open proto-bigram term, and the N−2 letters lying in between are omitted or removed. Following the omission or the removal of these letters, the remaining two letters forming or assembling the open proto-bigram term become contiguous letters.

“Absolute incompleteness” is a relative property of serial arrangements of terms. Herein, this property is used only to depict alphabetic set arrays because a set array characterizes complete and closed serial orders of terms. For example, in the context of an alphabetic set array, the term incompleteness means ‘absolute’. Absolute incompleteness involves a number of serial arrangements of terms or parameters, such as number of missing letters, type of missing letters, and ordinal positions of missing letters.

“Affix” is defined as a morpheme that is attached to a word stem to form a new word. “Affixes” may be derivational, like English -ness and pre-, or inflectional, like English plural -s and past tense -ed. They are bound morphemes by definition. Prefixes and suffixes may be separable affixes. Affixation is, thus, the linguistic process speakers use to form different words by adding morphemes (affixes) at the beginning (prefixation), the middle (infixation) or the end (suffixation) of words.

“Alphabetic contiguity” is defined as a visual discrimination facilitation effect occurring when a pair of letters assemble any open bigram term. This is true even in case when 1 or 2 letters in orthographic contiguity lying in between the two edge letters form the open bigram term. It has been empirically confirmed that up to 2 letters located contiguously in between the open bigram term do not interfere with the visual perceptual identity and resulting sensorial perceptual discrimination process of the pair of letters making up the open bigram term. In other words, the visual perceptual identity of an open bigram term (letter pair) remains intact even where up to two letters held in between the two edge letters form the open bigram term.

For the particular case where open bigram terms orthographically directly convey a semantic meaning in a language (e.g., an open proto-bigram), the visual sensorial perceptual identity of the open proto-bigram terms is considered to remain intact even when more than 2 letters are held in between the edge letters forming the open proto-bigram term. This particular visual sensorial perceptual discrimination effect is considered to be an expression of: 1) a Local Alphabetic Contiguity effect, which is empirically manifested when up to two letters are held in between (LAC) for open bigrams and open proto-bigrams terms and 2) a Non-Local Alphabetic Contiguity (NLAC) effect, which is empirically manifested when more than two letters are held in between; this effect only takes place in open proto-bigrams terms. This NLAC defined property of relational open proto-bigrams (ROPB) of an alphabetic set array is also extended for when the ROPBs are present in alphabetic arrays which have a semantic meaning, namely when the two letters forming an ROPB are the first and last letters of a word.

Both LAC and NLAC are part of the novel methodology aiming to advance a flexible orthographic sensorial perceptual decoding and ultra-efficient/superior rapid processing view concerning sensory motor grounding of sensory perceptual-cognitive alphabetical, numerical, and alphanumeric information and/or knowledge. LAC correlates to the already known priming transposition of letters phenomena. NLAC is a new proposition concerning the visual perceptual discrimination of serial properties particularly possessed only by open proto-bigrams terms, which is enhanced by the performance of the proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and unknowingly causes inhibitory arousal in a subject while visually perceptually discriminating, processing, and serially relationally mapping the N letters held in between the 2 edge letters forming an open proto-bigram term. The result being the maximal alphabetical data compression of the letters sequence. As a consequence of the alphabetic contiguity orthographic phenomena, the space held in between any 2 non-contiguous letters forming an open proto-bigram term in the alphabet attains a critical perceptual related nature, designated herein the ‘Collective Critical Space Perceptual Related Attribute’ (CCSPRA). The CCSPRA of the open proto-bigram term, wherein the letters sequence, which is implicitly attentionally ignored-inhibited, should be conceptualized as if existing in a virtual abstract mental kind of state. This virtual abstract mental kind of state will remain effective even if the 2 letters making up the open proto-bigram term are in orthographic contiguity (maximal alphabetical serial data compression).

When there are a number of N letters held in between the two letters forming an open proto-bigram term, and when the serial ordinal positions of these two letters are the edge letters of a letters sequence (there being no additional letters on either side of the edge letters), the alphabetic contiguity property will only pertain to the edge letters forming the open proto-bigram term. This scenario discloses the strongest manifestation of the alphabetic contiguity property, where one of the letters making up an open proto-bigram term is the head and the other letter is the tail of a letters sequence. This particular case is designated herein as Extraordinary NLAC.

“Alphabetic expansion” of an open proto-bigram term is defined as the orthographic separation of the two (alphabetical non-contiguous letters) letters by a task requiring the serial sensory motor insertion of the corresponding incomplete alphabetic sequence directly related to the collective critical space according to predefined timings. This sensory motor insertion task referred to as ‘alphabetic expansion’ explicitly reveals the particular related virtual sequential state implicitly entailed in the collective critical space of this open proto-bigram term, thereby making it sensorially perceptually concrete.

“Alphabetic letter sequence”, unless otherwise specified, is defined as one or more complete “alphabetic letter sequences” from the group comprising: Direct alphabetic set array, Inverse alphabetic set array, Direct open bigram set array, Inverse open bigram set array, Direct open proto-bigram sequence, and Inverse open proto-bigram sequence.

“Alphabetical ordinal distance” (AOD) is the difference between the ordinal positions of any two letters in an alphabetic set array. The AOD may also be a virtual alphabetical ordinal distance in between any two letters in an alphabetic array of non-repeated contiguous letters. For example, in a direct or inverse alphabetic set array, there are 25 AOD between the letter A and the letter Z, 3 AOD between the letter O and the letter R, 11 AOD between the letter B and the letter M, and 1 AOD between the letters A and B. Between any two contiguous repeated letters in an alphabetic array the AOD is equal to zero.

“Alphabetic set array” is defined as a closed serial order of letters, wherein all of the letters are predefined to be different (not repeated). Each letter member of an “alphabetic set array” has a predefined different ordinal position in the alphabetic set array. An alphabetic set array is herein considered to be a Complete Non-Randomized alphabetical letters sequence. Letter symbol members are only graphically represented with capital letters herein. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.
Inverse alphabetic set array: Z, Y, X, W, V, U, T, S, R, Q, P, O, N, M, L, K, J, I, H, G, F, E, D, C, B, A.
Direct type alphabetic set array: A, Z, B, Y, C, X, D, W, E, V, F, U, G, T, H, S, I, R, J, Q, K, P, L, O, M, N.
Inverse type alphabetic set array: Z, A, Y, B, X, C, W, D, V, E, U, F, T, G, S, H, R, I, Q, J, P, K, O, L, N, M.
Central type alphabetic set array: A, N, B, O, C, P, D, Q, E, R, F, S, G, T, H, U, I, V, J, W, K, X, L, Y, M, Z.
Inverse central type alphabetic set array: N, A, O, B, P, C, Q, D, R, E, S, F, T, G, U, H, V, I, W, J, X, K, Y, L, Z, M.

“Arrangement of terms” (symbols, letters, and/or numbers) is defined as one of two classes of “arrangements of terms”, i.e., an arrangement of terms along a line, or an arrangement of terms in a matrix form. In an “arrangement of terms along a line,” terms are arranged along a horizontal line by default. When the arrangement of terms is meant to be implemented along a vertical, diagonal, or curvilinear line, it will be indicated. In an “arrangement of terms in a matrix form,” terms are arranged along a number of parallel horizontal lines, displayed in a two dimensional format. This arrangement is the same as the letters arrangement in a standard text book format.

“Arrays” are defined as the indefinite serial order of terms. By default, the total number and kind of terms in “arrays’ are undefined.

“Attribute of a term” (alphanumeric symbol, letter, or number) is defined as a spatial distinctive related perceptual feature and/or a time distinctive related perceptual feature. An attribute of a term can also be understood as a related on-line perceptual representation carried through a mental simulation that effects the off-line conception of what has been perceived. (Louise Connell, Dermot Lynott. Principles of Representation: Why You Can't Represent the Same Concept Twice. Topics in Cognitive Science (2014) 1-17)

“Collective critical space” is defined as the alphabetic space held in between any two non-contiguous ordinal positions of different letters in a direct or inverse alphabetic set array. A “collective critical space” corresponds to any two non-contiguous different letters which form an open proto-bigram term. The postulation of a “collective critical space” is herein contingent on any pair of non-contiguous different letter symbols in a direct or inverse alphabetic set array, where the sensorial perceptual discriminated orthographic form of the different letter symbols directly and automatically relates a semantic meaning to the subject.

“Collective spatial perceptual related attribute” is defined as a spatial perceptual related attribute pertaining to the relative location of a particular letter term in relation to the other letter terms in a letter set array, an alphabetic set array, or an alphabetic letter symbol sequence. “Collective spatial perceptual related attributes” may include a symbol ordinal position, the physical space occupied by a symbol font, the distance between the physical spaces occupied by the fonts of two consecutive symbols or terms sensorially perceptually discriminated in orthographical form, and the left or right relative edge position of a sensorially perceptually discriminated term or symbol font in a set array. Even if the problem solving of a letter sequence triggers a collective spatial perceptual related attribute in a fluent reasoning subject, the resulting “collective spatial perceptual related attribute” does not generate or convey a semantic meaning by the perceptual relational serial mapping of the one or more letter symbols entailing this kind of spatial perceptual related attribute. In contrast, the “collective critical space” generates and explicitly conveys a semantic meaning in a fluent reasoning subject by the pair of non-contiguous letter symbols implicitly entailing the collective critical space.

“Direct alphabetical sequence” is defined as a serial order of letters from A to Z.

“Discrimination” is the sensorial perceptual discriminating of serial orders of symbols which do not intend or involve decoding or recall-retrieval activity enabling semantic whole word pattern recognition.

“Expletive” is defined to refer to any of the following:
Expletive syntactic: a word that performs a syntactic role but contributes nothing to meaning
Expletive pronoun: a pronoun used as subject or other verb argument that is meaningless but syntactically required
Expletive attributive: a word that contributes nothing to meaning but suggests the strength of feeling of the speaker
Profanity (or swear word): a word or expression that is strongly impolite or offensive.

“Function word” is defined as a word that expresses a grammatical or structural relationship with other words in a sentence. In contrast to a content word, a function word has little or no meaningful content. Function words are also known as grammatical words. “Function words” include determiners (e.g., the or that), conjunctions (e.g., and or but), prepositions (e.g., in or of), pronouns (e.g., she or they), auxiliary verbs (e.g., be or have), modals (e.g., may or could), and quantifiers.

“Generation of terms”, “number of terms generated” (symbols, letters and/or numbers) is defined as terms generally generated by two kinds of “term generation” methods—one method wherein the number of terms is generated in a predefined quantity; and another method wherein the number of terms is generated by a quasi-random method.

It is important to note that, in the above methods of promoting fluent reasoning abilities and in the following exercises and examples implementing the methods, the subject is performing sensorial perceptual discrimination concerning the serial properties of open bigrams or open proto-bigram terms in an array or series of open bigrams and/or open proto-bigram sequences without invoking explicit awareness or accessing prior learning. Such awareness concerns underlying implicit governing rules or abstract concepts/interrelationships characterized by relations, correlations, or cross-correlations among the sensorial perceptual searched, discriminated, and sensory motor manipulated open bigrams and open proto-bigrams terms. In other words, the subject is performing the sensorial perceptual search and discrimination without overtly thinking or strategizing from past experiences or learned pattern information recalled/retrieved from long term memory storage about the necessary actions to effectively accomplish any given sensory motor manipulation of the open bigrams and open proto-bigram terms.

As suggested above, the presented exercises contemplate the use of not only letters but also numbers and alphanumeric symbols relationships. These relationships include interrelations, correlations, and cross-correlations among open bigrams and/or open proto-bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, implications-consequences, fast sensorial perceptual visual and/or aural discrimination of serial patterns and irregularities, mental conceptualizations enacting serial relational mappings involving relations, correlations, and cross-correlations among one or more sequential orders of symbols, extrapolating, transforming sequential information, and abstract relational concept thinking.

It is also important to consider that the methods described herein are not limited to only alphabetic symbols. It is contemplated that the methods involve numeric serial orders and/or alpha-numeric serial orders to be used within the exercises. In other words, while the specific examples set forth employ serial orders of letter symbols, alphabetic open bigram terms and alphabetic open proto-bigram terms, it is contemplated that serial orders comprising numbers and/or alpha-numeric symbols can be used.

The library of complete open proto-bigram sequences comprises a predefined number of set arrays (closed serial orders of terms: alphanumeric symbols/letters/numbers), which may include alphabetic set arrays. Alphabetic set arrays are characterized by a predefined number of different letter terms. Each letter term has a predefined unique ordinal position in the closed set array, and none of the different letter terms are repeated within this predefined unique serial order of letter terms. A non-limiting example of a unique set array is the English alphabet, in which there are 13 predefined different open-bigram terms. In this case, each open-bigram term has a predefined consecutive ordinal position of a unique closed serial order among 13 different members of a set array only comprising 13 open-bigram term members.

In one aspect of the present subject matter, a predefined library of complete open-bigrams sequences may comprise set arrays. A unique serial order of open-bigram terms can be obtained from the English alphabet, as one among the at least six other different unique serial orders of open-bigram terms. In particular, an alphabetic set array obtained from the English alphabet is herein denominated direct alphabetic open-bigram set array. The other five different orders of the same open-bigram terms are also unique alphabetic open-bigram set arrays. These arrays are denominated: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or may comprise more different open-bigram set arrays.

In an aspect of the present methods, the at least one unique serial order comprises a sequence of open-bigram terms. In this case, the predefined library of set arrays may comprise the following set arrays of sequential orders of open-bigrams terms: direct open-bigram set array, inverse open-bigram set array, direct type open-bigram set array, inverse type open-bigram set array, central type open-bigram set array, and inverse central type open-bigram set array. Each open-bigram term is a different member of the set array having a predefined unique ordinal position within the set. It is understood that the predefined library of set arrays may contain additional or fewer set arrays sequences than those listed above.

“Grapheme” is defined herein as the smallest semantically distinguishing unit in a written language, analogous to the phonemes of spoken languages. A “grapheme” may or may not carry meaning by itself and may or may not correspond to a single phoneme. Graphemes include alphabetic letters, typographic ligatures, Chinese characters, numerical digits, punctuation marks, and other individual symbols of any of the world's writing systems. In languages that use alphabetic writing systems, graphemes stand in principle for the phonemes (significant sounds) of the language. In practice, however, the orthographies of such languages entail at least a certain amount of deviation from the ideal of exact grapheme-phoneme correspondence. A phoneme may be represented by a multigraph, a sequence of more than one grapheme. The digraph sh represents a single sound in English, however, sometimes a single grapheme may represent more than one phoneme (e.g., the Russian letter 51). Some graphemes may not represent any sound at all (e.g., the b in English debt). Often the rules of correspondence between graphemes and phonemes become complex or irregular, particularly as a result of historical sound changes that are not necessarily reflected in spelling. “Shallow” orthographies such as those of standard Spanish and Finnish have relatively regular (though not always one-to-one) correspondence between graphemes and phonemes, while those of French and English have much less regular correspondence.

“Higher-order complex relational conceptualization process” is defined as a higher order cognitive abstract thinking activity involving the parallel activation among multiple interacting relational semantic meanings at once. The multiple interacting relational semantic meanings enact a relational knowledge language mapping (lexical relational web) consisting in multiple parallel activated relational semantic meanings relationships of the following types: direct relations among semantic meanings, correlations among semantic meanings, and cross-correlations among semantic meanings. These parallel, dynamically activated, relational semantic meanings relationships mentally coexist with each other. The higher order cognitive complex relational conceptualization process enacts an abstract web of relational language knowledge interactions consisting of dynamic interacting semantic meanings relationships that simultaneously involve at least “3” distinct relational semantic meanings. This lexical relational language web is herein amplified by novel combinations among one or more spatial and/or time perceptual related attribute changes that sensorially perceptually and sensory motor ground and relate the semantic meaning of a term(s) to its orthographic and/or phonological representation(s) (letters, numbers and alphanumeric).

“Incomplete serial order” refers, only in relation, to a serial order of terms which has been previously defined as “complete”.

“Individual spatial perceptual related attribute” is defined as a “spatial perceptual related attribute” that pertains to a particular term. Individual spatial perceptual related attributes may include, symbol case; symbol size; symbol font; symbol boldness; symbol tilted angle relative to a horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

“Inverse alphabetical sequence” is a serial order of letters from Z to A.

“Left visual field” is the visual field comprising the display surface located on the left side intersecting the sagittal plane of a subject viewing that which is being displayed.

“Letter set arrays” are closed serial orders of letters, wherein same letters may be repeated.

“Letter symbol” is defined as a sensorial perceptual graphical representation of a sign or a sensorial perceptual aural discrimination triggering arousal which enables the depiction of one or more specific phonological uttered sounds related to the spoken (uttered) letter symbol in a language. In the same language, different sensorial perceptual graphical discriminated signs depict a particular same letter symbol like letter symbol “a” and “A”.

“Letter term” is defined as a mental abstract conceptualization of a sensorial perceptual discriminated graphical sign or a sensorial perceptual aural phonological discrimination of same. Generally, a letter term is characterized as not representing a concrete thing, item, form, or shape in the physical world. Different alphabetical languages may use the same sensorial perceptual discriminated graphical sign(s) or the same sensorial perceptual aural phonological discriminated sounds to sensorially perceptually represent a particular “letter term” (like letter term “s”).

“Metaphor” (see also conceptual metaphor below) is defined as a figure of speech that identifies one thing as being the same as an unrelated other thing. Metaphors strongly imply the similarities between the two things. A metaphor is a figure of speech that implies comparison between two unlike entities, as distinguished from simile, an explicit comparison signaled by the words “like” or “as.” The distinction is not simple. The “metaphor” makes a qualitative leap from a reasonable, perhaps prosaic comparison, to an identification or fusion of two objects, to make one new entity partaking of the characteristics of both. Many critics regard the making of metaphors as a system of thought antedating or bypassing logic. A metaphor is thus considered more rhetorically powerful than a simile. A simile compares two items, whereas a metaphor directly equates them, without applying any words of comparison, such as “like” or “as.” Metaphor is a type of analogy closely related to other rhetorical figures of speech that achieve their effects via association, comparison, or resemblance including allegory, hyperbole, and simile. One of the most prominent examples of a metaphor in English literature is:

### “All the world's a stage” And all the men and women merely players; They have their exits and their entrances; —William Shakespeare, As You Like It

This quotation contains a metaphor because the world is not literally a stage. By figuratively asserting that the world is a stage, Shakespeare uses the points of comparison between the world and a stage to convey an understanding about the mechanics of the world and the lives of the people within it. The Philosophy of Rhetoric (1937) by I. A. Richards describes a metaphor as having two parts, the tenor and the vehicle. The tenor is the subject (topic-target) to which attributes are ascribed. The vehicle is the object whose attributes are borrowed. In the previous example, “the world” is compared to a stage, describing it with the attributes of “the stage”. “The world” is the tenor (target), and “a stage” is the vehicle. “Men and women” is the secondary tenor and “players” is the secondary vehicle. Other writers employ the general terms ground and figure to denote the tenor and the vehicle. In cognitive linguistics, the conceptual domain from which metaphorical expressions are drawn to understand another conceptual domain is known as the source domain. The conceptual domain understood in this way is the target domain. Thus, the source domain of the sharks (e.g., aggressive non-merciful) is commonly used to explain the target domain of the lawyers.

“Conceptual Metaphors” are defined as being part of the basic-common conceptual apparatus shared by members of a culture. They are systematic in that there is a fixed correspondence between the structure of the domain to be understood (e.g., death) and the structure of the domain in terms of what is understood (e.g., departure). Conceptual metaphors are usually understood in terms of common experiences. They are largely unconscious though attention may be drawn to them. Their operation in cognition is almost automatic. They are widely conventionalized in language. There are a great number of words and idiomatic expressions in our language whose meanings depend upon those conceptual metaphors” (George Lakoff and Mark Turner, More Than Cool Reason. Univ. of Chicago Press, 1989). In Metaphors We Live By, Lakoff and Johnson mention the following variations on the conceptual metaphor:
Time is Money
You're wasting my time.
This gadget will save you hours.
I don't have the time to give you.
How do you spend your time these days?
That flat tire cost me an hour.
I've invested a lot of time in her.
You're running out of time.
Is that worth your while?
He's living on borrowed time.

Conceptual Metaphor theory rejects the notion that metaphor is a decorative device, peripheral to language and thought. Instead, the theory holds that metaphor is central to thought, and therefore to language. From this starting point, a number of tenets, with particular reference to language, are derived. These tenets are:
Metaphors structure thinking;
Metaphors structure knowledge;
Metaphor is central to abstract language;
Metaphor is grounded in physical experience; and
Metaphor is ideological.

### (Alice Deignan, Metaphor and Corpus Linguistics. John Benjamins, 2005).

“Morpheme” is defined as a category representing the smallest unit of grammar, The field of study dedicated to “morphemes” is called morphology. A morpheme is not identical to a word. The principal difference between the two is that a morpheme may or may not stand alone, whereas a word, by definition, is freestanding. When a morpheme stands by itself, it is considered a root because it has a meaning of its own (e.g. the morpheme cat). When a morpheme depends on another morpheme to express an idea, it is considered an affix because it has a grammatical function (e.g., the -s in cats to specify that it is plural). Every word comprises one or more morphemes. The more combinations a morpheme is found in, the more productive it is said to be. Morphemes function as the foundation of language and syntax, the arrangement of words and sentences to create meaning, A morpheme is a meaningful linguistic unit consisting of a word (such as dog) or a word element (such as the -s at the end of dogs) that cannot be divided into smaller meaningful parts. Adjective: morphemic. Morphemes can be divided into two general classes: free morphemes can stand alone as words of a language; and bound morphemes, which must be attached to other morphemes. Free morphemes can be further subdivided into content words and function words. Content words carry most of the content of a sentence whereas function words generally perform some kind of grammatical role, carrying little meaning of their own.

“Non-alphabetic letter sequence” is any letter series that does not follow the sequence and/or ordinal positions of letters in any of the alphabetic set arrays.

“Open bigram” is defined as a closed serial order formed by any two contiguous or non-contiguous letters of the above alphabetic set arrays, unless specified otherwise. Under the provisions set forth above, an “open bigram” may also refer to pairs of numerical or alphanumerical symbols.

For alphabetic set arrays where the members are defined as open bigrams, the following 3 direct and 3 inverse alphabetic open bigrams set arrays are herein defined:
Direct alphabetic open bigram set array: AB, CD, EF, GH, U, KL, MN, OP, QR, ST, UV, WX, YZ.
Inverse alphabetic open bigram set array: ZY, XW, VU, TS, RQ, PO, NM, LK, JI, HG, FE, DC, BA.
Direct alphabetic type open bigram set array: AZ, BY, CX, DW, EV, FU, GT, HS, IR, JQ, KP, LO, MN.
Inverse alphabetic type open bigram set array: ZA, YB, XC, WD, VE, UF, TG, SH, RI, QJ, PK, OL, NM.
Central alphabetic type open bigram set array: AN, BO, CP, DQ, ER, FS, GT, HU, IV, JW, KX, LY, MZ.
Inverse alphabetic central type open bigram set array: NA, OB, PC, QD, RE, SF, TG, UH, VI, WJ, XK, YL, ZM.

“Open bigram term” is a lexical orthographic unit characterized by a pair of letters (n-gram) depicting a minimal sequential order consisting of two letters. The open bigram class to which an “open bigram term” belongs may or may not convey an automatic direct access to semantic meaning in an alphabetic language to a reader.

“Open bigram term sequence” is herein defined as a letters symbol sequence, where two letter symbols are presented as letter pairs representing a term in the sequence instead of an individual letter symbol representing a term in the sequence.

There are 4 classes of open bigram terms, there being a total of 676 different open bigram terms in the English alphabetical language.

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms, wherein 2 open bigram terms are also open bigram terms members of Class I.

Class III—Within the context of the present subject matter, Class III entails the vast majority of open bigram terms in the English alphabetical language, except for all open bigram terms members of Classes I, II, and IV. Specifically, Class III comprises a total of 550 open bigram terms.

Class IV—Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

“Open proto-bigram sequence type” is a complete alphabetic “open proto-bigram sequence” characterized by the pairs of letters comprising each open proto-bigram term in a way that the serial distribution of such open proto-bigram terms establishes a sequence of open proto-bigram terms type that follows a direct or an inverse alphabetic set array order. There are two complete alphabetic open proto-bigram sequence types.

### Types of Open Proto-Bigram Sequences:

Direct type open proto-bigram sequence: AM, AN, AS, AT, BE, BY, DO, GO, IN, IS, IT, MY, NO, OR
Inverse type open proto-bigram sequence: WE, US, UP, TO, SO, ON, OF, ME, IF, HE.
“Complete alphabetic open proto-bigram sequence groups” within the context of the present subject matter, Class I open-proto bigram terms, are further grouped in three sequence groups:
   Open Proto-Bigram Sequence Groups:
   Left Group: AM, BE, HE, IF, ME
   Central Group: AN, AS, AT, BY, DO, GO, IN, IS, IT, MY, OF, WE
   Right Group: NO, ON, OR, SO, TO, UP, US

“Ordinal position” is defined as the numerical order corresponding to the relative location of a term in the closed series of any of the six alphabetic set arrays or any of the six alphabetic open-bigram set arrays of the predefined libraries of complete alphabetic serial orders. The first term of any set array will have a numerical “ordinal position” of #1, and each of the following terms in the alphabetic sequence will have the “ordinal positions” of the following integer numbers (#2, #3, #4, . . . ). Therefore, in relation to the 26 different letters of the direct alphabetic set array of the English language (see above), ordinal position #1 will relate to the letter “A”, and ordinal position #26 will relate to the letter “Z”. In relation to a predefined alphabetic set array, the ordinal position of a particular letter term or a particular open-bigram term will always be conserved as an intrinsic relational serial order property of the particular letter term or particular open-bigram term.

“Orthographic letters contiguity” is the contiguity of letters symbols in a written form by which words are represented in most written alphabetical languages.

“Orthographic letter patterns” are defined as the different one or more kinds of serial orders that can be present in a letter sequence. Serial orders of letters may define different orthographic patterns of: relational open proto-bigrams (ROPB); vowels; consonants; the first and/or last letters of a sequence being a vowel or a consonant; direct or inverse alphabetic serial order of each consecutive pair of letters in a sequence; alphabetic ordinal distance between a pair of consecutive or non-consecutive letters; and for a closed sequence, the total number of letters, vowels, and/or consonants.

“Orthographical topological expansion” of a symbol letter or number is defined as the outcome of introducing graphical changes directed to extend the periphery of the orthographical representation of a symbol letter or number. An “orthographical topological expansion (extension) of a symbol” is achieved by means of adding distinctive points and/or short line segments to the perimeter of its graphical display. An orthographical topological expansion of a symbol aims to enhance a subject's sensorial perception readiness to discriminate the orthographically topological expanded (extended) symbol letter or number faster as a stand-alone orthographic representation or when standing among other orthographic representations.

“Particle” is a word that does not change its form through inflection (morphemes that signal the grammatical variants of a word). Inflection is a process of word formation in which items are added to the base form of a word to express grammatical meanings. Inflections in English include the genitive -'s; the plural -s (e.g., at the end of “ideas”); the third-person singular -s (e.g., she makes but I make and they make); the past tense -d, -ed, or -t; the negative particle -'nt; the gerund forms of verbs -ing; the comparative -er; and the superlative -est. Inflections do not easily fit into the established system of parts of speech. Many word “particles” are closely linked to verbs to form multi-word verbs, such as go away. Other word particles include “to”, used with an infinitive and “not” (a negative particle). Particles are short words, which with just one or two exceptions, are all prepositions unaccompanied by any complement of their own. Some of the most common prepositions belong to the particle category “along, away, back, by, down, forward, in, off, on, out, over, round, under, and up.”

“Phoneme” is defined as a basic unit of a language's phonology, which is combined with other “phonemes” to form meaningful units, such as words or morphemes. The phoneme can be described as “the smallest contrastive linguistic unit which may bring about a change of meaning”. The difference in meaning between the English words kill and kiss is a result of the exchange of the phoneme /l/ for the phoneme /s/. Two words that differ in meaning through a contrast of a single phoneme form a minimal pair. Within linguistics there are differing views as to exactly what phonemes are and how a given language should be analyzed in phonemic (or phonematic) terms. However, a phoneme is generally regarded as an abstraction of a set (or equivalence class) of speech sounds (phones), which are perceived as equivalent to each other in a given language. In English, for example, the “k” sounds in the words kit and skill are not identical, but they are distributional variants of a single phoneme /k/. Different speech sounds that are realizations of the same phoneme are known as allophones. Allophonic variation may be conditioned, in which case a certain phoneme is realized as a certain allophone in particular phonological environments. Alternatively, the phoneme may be free, in which case it may vary randomly. Phonemes are often considered to constitute an abstract underlying representation for segments of words, while speech sounds make up the corresponding phonetic realization, or surface form. While phonemes are normally conceived of as abstractions of discrete segmental speech sounds (vowels and consonants), there are other features of pronunciation, principally tone and stress., In some languages, tone and stress can change the meaning of words in the way that phoneme contrasts do and are consequently called phonemic features of those languages. Still, phonemic stress is encountered in languages such as English. For example, the word invite, which is stressed on the second syllable is a verb, but when it is stressed on the first syllable (without changing any of the individual sounds) it becomes a noun. The position of the stress in the word affects the meaning. Therefore, a full phonemic specification, providing enough detail to enable the word to be pronounced unambiguously, would include indication of the position of the stress: /in'vart/ for the verb, /'invart/ for the noun.

“Polysemy” (from Greek: πoλυ-, poly-, “many” and σ\tilde{η}μα, sêma, “sign”) is defined as the capacity for a sign(s) (e.g., a word, phrase, etc.) to have multiple related meanings (sememes). It is usually regarded as distinct from homonymy, in which the multiple meanings of a word may be unconnected or unrelated. Charles Fillmore and Beryl Atkins' definition stipulates three elements: (i) the various senses of a polysemous word have a central origin; (ii) the links between these senses form a network; and (iii) understanding the ‘inner’ one contributes to understanding of the ‘outer’ one. Accordingly, polyseme is a word or phrase with different but related senses. Since the test for polysemy is the vague concept of relatedness, judgments of polysemy can be difficult to make. Since applying pre-existing words to new situations is a natural process of language change, looking at the etymology of words is helpful in determining polysemy, but it is not the only solution. As words become lost in etymology, what once was a useful distinction of meaning may no longer be so. Some apparently unrelated words share a common historical origin, so etymology is not an infallible test for polysemy. Dictionary writers also often defer to speakers' intuitions to judge polysemy in cases where it contradicts etymology. English has many words which are polysemous. For example, the verb “to get” can mean “procure” (e.g., I'll get the drinks), “become” (e.g, she got scared), “understand” (e.g, I get it), etc. In vertical polysemy, a word refers to a member of a subcategory (e.g., ‘dog’ for ‘male dog’). A closely related idea is a figure of speech named a metonym, in which one word or phrase with one original meaning is substituted for another with which it is closely connected or associated (e.g., “crown” for “royalty”). There are several tests for polysemy. One in particular is zeugma. If one word seems to exhibit zeugma when applied in different contexts, it is likely that the contexts bring out different polysemes of the same word. If the two senses of the same word do not seem to fit, yet seem related, then it is likely that they are polysemous. The fact that this test depends on speakers' judgments about relatedness means that this test for polysemy is not infallible, but is merely a helpful conceptual aid. The difference between homonyms and polysemes is subtle. Lexicographers define polysemes within a single dictionary lemma, numbering different meanings, while homonyms are treated in separate lemmata. Semantic shift can separate a polysemous word into separate homonyms. For example, “check” as in “bank check”, “check” in chess, and “check” meaning “verification” are considered homonyms because they originated as a single word derived from chess in the 14th century. Psycholinguistic experiments have shown that homonyms and polysemes are represented differently within people's mental lexicon. While the different meanings of homonyms, which are semantically unrelated, tend to interfere or compete with each other during comprehension, this does not usually occur for the polysemes that have semantically related meanings. Results for this contention, however, have been mixed.

“Prepositions” (or more generally adpositions) are a class of words expressing spatial or temporal relations (e.g., in, under, towards, before) or mark various syntactic and semantic roles (e.g., of, for). Their primary function is relational. A “preposition” word typically combines with another constituent (called its complement) to form a prepositional phrase relating the complement to the context. The word preposition (from Latin: prae, before and ponere, to put) refers to the situation in Latin and Greek, where prepositions are placed before their complement and hence pre-positioned. English is another language employing them in this way. Similarly, circumpositions consist of two parts that appear on each side of the complement. The technical term used to refer collectively to prepositions, postpositions, and circumpositions is adpositions. Some linguists use the word “preposition” instead of “adposition” for all three cases. Some examples of English prepositions (marked in bold) as used in phrases are:
as an adjunct (locative, temporal, etc.) to a {noun} (marked within braces)
   the {weather} in May
   {cheese} from France with live bacteria
as an adjunct (locative, temporal, etc.) to a {verb}
   {sleep} throughout the winter
   {danced} atop the tables for hours
as an adjunct (locative, temporal, etc.) to an {adjective}
   {happy} for them
   {sick} until recently

The following properties are characteristic of most adpositional systems.
Adpositions are among the most frequently occurring words in languages that have them.

For example, one frequency ranking for English word forms begins as follows (adpositions underlined): the, of, and, to, a, in, that, it, is, was, I, for, on, you, . . .
The most common adpositions are single, monomorphemic words. According to the ranking cited above, the most common English prepositions are the following: on, in, to, by, for, with, at, of, from, up, but . . .
Adpositions form a closed class of lexical items and cannot be productively derived from words of other categories.

### Semantic Classification—

Adpositions can be used to express a wide range of semantic relations between their complement and the rest of the context. The following list is not an exhaustive classification:
spatial relations: location (inclusion, exclusion, proximity) and direction (origin, path, endpoint)
temporal relations
comparison relations: equality, opposition, price, rate
content relations: source, material, subject matter
agent
instrument, means, manner
cause, purpose; and
reference.

Most common adpositions are highly polysemous, and much research is devoted to the description and explanation of the various interconnected meanings of particular adpositions. In many cases a primary, spatial meaning can be identified, which is then extended to non-spatial uses by metaphorical or other processes.

### Classification by Grammatical Function—

Particular uses of adpositions can be classified according to the function of the adpositional phrase in the sentence.

Modification
adverb-like
The athlete ran {across the goal line}.
adjective-like
attributively
A road trip {with children} is not the most relaxing vacation.
in the predicate position
The key is {under the plastic rock}.

### Syntactic Functions

complement
Let's dispense with the formalities

Here, the words dispense and with complement one another, functioning as a unit to mean forego. They also share the direct object [the formalities]. The verb dispense would not have this meaning without the word with to complement it).
{In the cellar} was chosen as the best place to hide the bodies.

Adpositional languages typically single out a particular adposition for the following special functions:
marking possession
marking the agent in the passive construction; and
marking the beneficiary role in transfer relations.

“Pseudowords” are alphabetic arrays which have no semantic meaning, but are pronounceable because they conform to the orthography of the language. In contrast, non-words are not pronounceable and have no semantic meaning.

“Relational correlation(s)” is defined as a reasoning activity that involves inferring a positive or negative relational relationship(s). On one hand, relational correlations can encapsulate and conceptually expose a deep implicit order-pattern structure taking place between temporal events, spatial things, and/or numerical quantity values and alphabetic arrays depicting the same, similar, or different semantic meanings in a language via the formulation of one or more rule based algorithms. On the other hand, relational correlations may intrinsically resist inference of a causal relational direct alignment between these temporal events, spatial objects, numerical quantity values, and/or alphabetic arrays.

“Relational direct relation” is defined as a reasoning activity that involves identifying an explicit and straightforward causal relational-link order (alignment) between interacting temporal events, spatial things, and/or numerical quantity values and alphabetic arrays depicting the same, similar, or different semantic meanings in a language.

“Relational open proto-bigram (ROPB)” is an open proto-bigram of class I contained in an alphabetic array, which retains its intrinsic identity even for the case where the two letters forming the open proto-bigram are separated by up to two other letters. An ROPB may also occur for the case where the two letters forming an open proto-bigram are the first and last letters of alphabetic arrays, which are words or a letter sequence from an alphabetic set array, regardless of the length of the sequence in between the first and last letters.

In a provided alphabetic array representing a word, embedded ROPBs that are not sensorially perceptually graphically represented (or sensorially perceptually visually missing) in the sensorially perceptually discriminated alphabetic array are considered to be orthographically absent. In other words, the two letters forming the ROPB are omitted from the sensorial perceptual graphical representation of the alphabetic array provided to the subject. Orthographically absent ROPBs may be part of a carrier word or carrier non-word. In either case, the two letters forming the ROPB are separated by no more than two other letters of the carrier word.

“Relative incompleteness” is used in association with any previously selected alphabetical serial order, which for the sake of the intended task to be performed by a subject, should be considered to be a complete alphabetical serial order.

“Right visual field” is the visual field comprising the display surface located on the right side intersecting the sagittal plane of a subject viewing that which is being displayed.

“ROPB type I words” are defined as ROPB words formed by a vowel letter serially followed by a consonant (VC) letter. A “ROPB type I” word is of a group comprising 13 different ROPB's words members: AM, AN, AS, AT, IF, IN, IS, IT, OF, ON, OR, UP, US. ROPB type I words stand in addition to the following predefined ROPB type's word groups: Direct Type, Inverse Type, Left Group Type, Central Group Type, and Right Group Type.

“ROPB Type II words” are defined herein as ROPB words formed by a consonant letter serially followed by a vowel (CV) letter. A “ROPB Type II” word is of a group comprising the following 11 different ROPB's words members: BE, BY, DO, GO, HE, ME, MY, NO, SO, TO, WE. ROPB type II words stand in addition to the following predefined ROPB type's word groups: Direct Type, Inverse Type, Left Group Type, Central Group Type, and Right Group Type.

“Selected separable affix” is defined as “selected separable affix” letters which are part of a direct or an inverse alphabetical sequence.

“Serial order” is defined as a sequence of terms characterized by a number of serial constraints including: (a) the relative ordinal spatial position of each term and the relative ordinal spatial positions of those terms following and/or preceding it; (b) the nature of a serial order sequential structure: i) an “indefinite serial order” is defined herein as a “serial order” of terms where neither the first nor the last term are predefined; ii) an “open serial order” is defined herein as a “serial order” where only the first term is predefined; iii) a “closed serial order” is defined herein as a “serial order” where only the first and last terms are predefined; and (c) its number of terms members are predefined exclusively by “a closed serial order”.

“Serial terms” are defined as the individual symbol components of a symbols series.

“Series” is defined as an orderly sequence of terms.

“Set arrays” are defined as closed serial orders of terms, wherein each term is intrinsically a different member of the set and where the kinds of terms, if not specified in advance, are undefined. If the total number of terms is not predefined by the method(s) herein, then the total number of terms is undefined by default.

“Spatial perceptual related attribute” is defined as characterizing a “spatial related perceptual feature” of a term, which can be attended and discriminated by sensorial perception. There are two kinds of spatial related perceptual attributes.

“Stem” is defined as part of a word in linguistics. However, the term “stem” is used with slightly different meanings. In one usage, a stem is a form to which affixes can be attached, In this usage, the English word friendships contains the stem friend, to which the derivational suffix -ship is attached to form a new stem friendship, to which the inflectional suffix -s is attached. In a variant of this usage, the root of the word (in the example, friend) is not counted as a stem. In a slightly different usage, a word has a single stem, namely the part of the word that is common to all its inflected variants. In this usage, all derivational affixes are part of the stem. For example, the stem of friendships is friendship, to which the inflection suffix -s is attached. Stems may be root, e.g., run, or they may be morphologically complex, as in compound words (cf. the compound nouns meat ball or bottle opener) or words with derivational morphemes (cf. the derived verbs black-en or standard-ize). Thus, the stem of the complex English noun photographer is photo•graph•er but not photo. In another example, the root of the English verb form destabilized is stabil-, a form of stable the does not occur alone. The stem is de•stabi•ize, which includes the derivational affixes de- and -ize, but not the inflectional past tense suffix -(e)d. A stem is that part of a word that inflectional affixes attach to.

“Syllable” (from the Greek συλλαβ\acute{η}, syn=‘co, together’+labe=‘grasp’, thus meaning a handful [of letters]) is defined as a unit of organization for a sequence of speech sounds. A syllable is unit of spoken language, above a speech sound, and consisting of one or more vowel sounds, a syllabic consonant, or either with one or more consonant sounds preceding or following. For example, the word water is composed of two syllables: wa and ter. A syllable is typically made up of a syllable nucleus (most often a vowel) with optional initial and final margins (typically consonants). Syllables are often considered the phonological “building blocks” of words. They can influence the rhythm of a language, its prosody, its poetic meter, and its stress patterns. A word that consists of a single syllable (like English dog) is called a monosyllable and is monosyllabic. Similar terms include disyllable (disyllabic) for a word of two syllables; trisyllable (trisyllabic) for a word of three syllables; and polysyllable (polysyllabic), which may refer either to a word of more than three syllables or to any word of more than one syllable. The earliest recorded syllables are on tablets written around 2800 BC in the Sumerian city of Ur. This shift from pictograms to syllables has been called “the most important advance in the history of writing”.

“Symbol” is defined herein as the name label given in a language to a mental abstract conceptualization of a sensorial perceptual discrimination of a graphical sign or representation which includes letters and numbers.

“Terminal points” are defined as the one or more end points of the symbol lines by which the perimeter is graphically represented in the orthographic morphological representation of a symbol letter or number.

“Terms” are represented by one or more symbols or letters, numbers, or alphanumeric symbols.

“Terms arrays” are defined as open serial orders of terms. By default, the total number and kind of terms members in an open serial order of terms is undefined.

“Time perceptual related attribute” is defined as characterizing a temporal related perceptual feature of a term (symbol, letter, or number), which can be attended and discriminated by sensorial perception, such as a) any color of the RGB full color range of the symbols term; b) frequency range for the intermittent display of a symbol, a letter, or a number from a very low frequency rate, up to a high frequency (flickering) rate; frequency is quantified as l/t, where t is in the order of seconds of time; c) particular sound frequencies through which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is considered to take place along a horizontal axis in a spatial direction to be predefined. If the visual perception of constant motion is implemented on a computer screen, the value of V to be assigned is given in pixels per second at a predefined screen resolution.

“Vertice” is defined as the one or more intersection points of any two lines of a symbol perimeter, in the morphological graphical representation of a symbol letter or number, where the two intersecting lines originate from different directions in the morphologic space representing the symbol letter or number.

“Virtual sequential state” is defined as an implicit incomplete alphabetic sequence assembled by the letters corresponding to the ordinal positions entailed in a “collective critical space”. There is at least one implicit incomplete alphabetic sequence entailed per each open proto-bigram term.

These implicit incomplete alphabetic sequences are herein conceptualized to exist in a virtual-like perceptual-cognitive mental state of the subject. Every time this virtual-like perceptual-cognitive mental state is grounded in the subject by means of a programmed goal oriented sensory-motor activity, the subject's reasoning and related mental higher order cognitive relational ability is enhanced.

Based on the above definitions, a letters sequence, which at least entails two non-contiguous letters assembling an open proto-bigram term, will be entitled to possess a “collective critical spatial perceptual related attribute” as a direct consequence of the implicit perceptual condition of the at least one incomplete alphabetic sequence arising from the “virtual sequential state” corresponding with the open proto-bigram term.

This virtual-like (implicit) serial state actualizes and becomes concrete every time a subject is required to reason and perform a goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing an “alphabetical compression” of a selected letters sequence or by performing an “alphabetical expansion” of a selected letters sequence in accordance with the definitions of the terms given below.

Moreover, for a general form of these definitions, the “collective critical space”, “virtual sequential state”, and “collective critical spatial perceptual related attribute” for a predefined Complete Numerical Set Array and a predefined Complete Alphanumeric Set Array, for alphabetic series can also be extended to include numerical and alphanumerical series.

### Example 1

### Sensorial Perceptual Discrimination of Embedded Relational Open Proto-Bigrams (ROPB) in Predefined Alphabetic Arrays

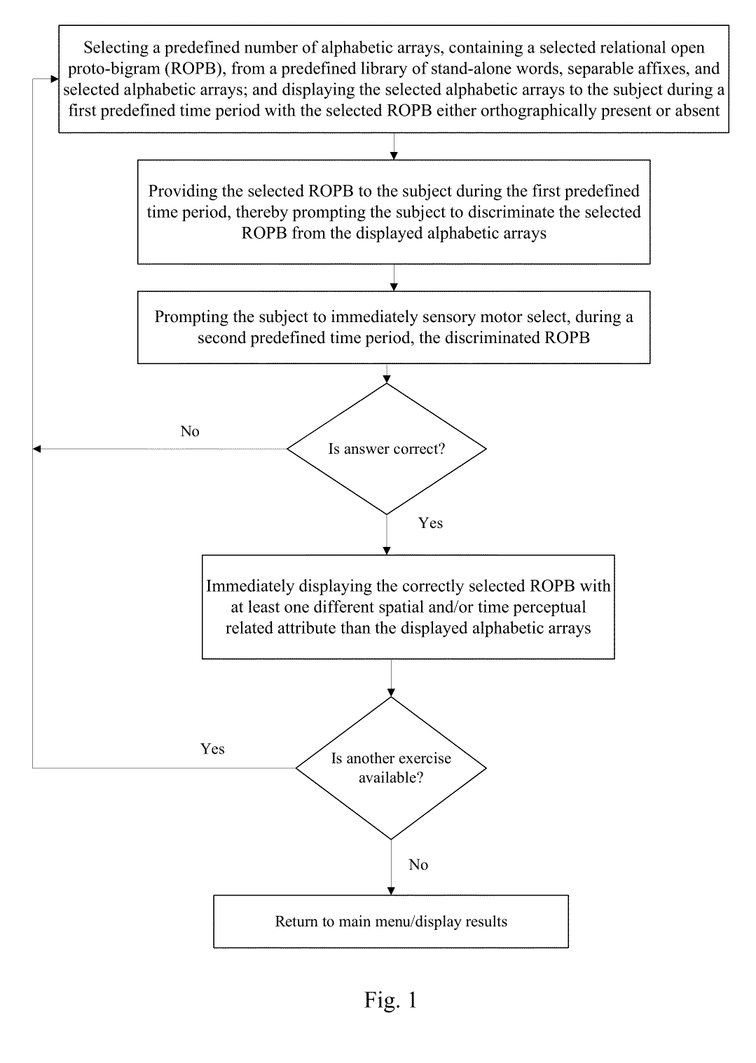

A goal of the exercises presented in Example 1 is to exercise elemental fluid intelligence ability. Particularly, the exercises of Examples 1-6 intentionally promote fluid reasoning to quickly enact an abstract conceptual mental web where a number of direct ROPBs, inverse ROPBs, and incomplete alphabetic arrays having semantic meanings relationally interrelate, correlate, and cross-correlate with each other such that the processing and real-time manipulation of these alphabetic arrays is maximized in short-term memory. Importantly, the alphabetic arrays utilized herein are purposefully selected and arranged with the intention of not eliciting semantic associations and/or comparisons in order to bypass long-term memory processing of stored semantic information in a subject. Accordingly, the real-time sensorial perceptual serial search, discrimination, and motor manipulation of the selected alphabetic arrays does not require the subject to automatically seek for learned semantic information, e.g. retrieval-recall of prior semantic knowledge, to solve the present exercises. Rather, unbeknownst to the subject, the present exercises minimize or eliminate the subject's need to access prior learned and/or stored semantic knowledge by focusing on the intrinsic relational seriality of the alphabetic arrays, even when the presented alphabetic arrays convey a semantic meaning. FIG. 1 is a flow chart setting forth the method that the present exercises use in promoting fluid intelligence abilities in a subject by sensorially perceptually discriminating embedded relational open proto-bigrams (ROPB) from predefined alphabetic arrays.

As can be seen in FIG. 1, the method of promoting fluid intelligence abilities in a subject comprises displaying a predefined number of alphabetic arrays, containing a selected relational open proto-bigram (ROPB), wherein the alphabetic arrays are selected from a predefined library of stand-alone words. Initially, all of the displayed alphabetic arrays have the same spatial and time perceptual related attributes. The subject is provided with the selected ROPB during a first predefined time period with the underlying purpose of prompting the subject to sensorially perceptually discriminate the displayed alphabetic arrays to which the ROPB is an integral part. At the conclusion of the first predefined time period, the subject is prompted to immediately sensory motor select the sensorially perceptually discriminated alphabetic arrays containing the selected ROPB. For each ROPB selection, the subject is required to perform a sensory motor activity corresponding to the selection. If the sensory motor selection made by the subject is an incorrect sensory motor selection, the subject is automatically returned to the initial displaying step of the method without receiving any performance feedback. If the sensory motor selection made by the subject is a correct sensory motor selection, then the correctly selected ROPB is immediately displayed with at least one different spatial and/or time perceptual related attribute than the displayed alphabetic arrays.

The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 1, the method of promoting fluid intelligence abilities in a subject is implemented through a computer program product. In particular, the subject matter in Example 1 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a predefined number of alphabetic arrays containing a selected relational open proto-bigram (ROPB), wherein the alphabetic arrays are selected from a predefined library of stand-alone words. Initially, all of the displayed alphabetic arrays have the same spatial and time perceptual related attributes. The subject is provided with the selected ROPB during a first predefined time period with the underlying purpose of prompting the subject to sensorially perceptually discriminate the displayed alphabetic arrays to which the selected ROPB is an integral part. At the conclusion of the first predefined time period, the subject is prompted to immediately sensory motor select the sensorially perceptually discriminated alphabetic arrays containing the selected ROPB. For each ROPB selection, the subject is required to perform a sensory motor activity corresponding to the selection. If the sensory motor selection made by the subject is an incorrect sensory motor selection, the subject is automatically returned to the initial displaying step of the method without receiving any performance feedback. If the sensory motor selection made by the subject is a correct selection, then the correctly selected ROPB is immediately displayed with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections.

In a further aspect of Example 1, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a predefined number of alphabetic arrays containing a selected relational open proto-bigram (ROPB) on the GUI, wherein the alphabetic arrays are selected from a predefined library of stand-alone words. Initially, all of the displayed alphabetic arrays have the same spatial and time perceptual related attributes. The subject is provided with the selected ROPB on the GUI during a first predefined time period with the underlying purpose of prompting the subject to sensorially perceptually discriminate the displayed alphabetic arrays to which the selected ROPB is an integral part. At the conclusion of the first predefined time period, the subject is prompted to immediately sensory motor select on the GUI, the sensorially perceptually discriminated alphabetic arrays containing the selected ROPB. For each ROPB selection, the subject is required to perform a sensory motor activity corresponding to the selection. Once the subject has made a sensory motor selection, the processor determines whether the sensory motor selection is either correct or incorrect. If the sensory motor selection made by the subject is an incorrect selection, the subject is automatically returned to the initial displaying step without receiving any performance feedback. If the sensory motor selection made by the subject is a correct selection, then the correctly selected ROPB is immediately displayed on the GUI with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections.

In a preferred embodiment, Example 1 includes a single block exercise having at least two sequential trial exercises. In each trial exercise, a predefined number of alphabetic arrays are presented to the subject. Shortly after the alphabetic arrays are displayed, the subject is presented with a selected ROPB. Upon seeing the selected ROPB, the user is required to scan the provided alphabetic arrays, without delay, to sensorially perceptually discriminate all instances of the selected ROPB embedded therein. Importantly, the present trial exercises have been designed to reduce cognitive workload by minimizing the dependency of the subject's reasoning and derived inferring skills on real-time manipulation of lexical information by the subject's working memory. Therefore, the selected ROPB is presented as a sensorial perceptual related reference for the subject in each trial exercise.

The subject is given a limited time frame within which the subject must validly sensory motor perform the exercises. If the subject does not sensory motor perform a given exercise within the second predefined time interval, also referred to as “a valid performance time period”, then after a delay, which could be of about 2 seconds, the next iteration for the subject to perform is automatically displayed. Importantly, the subject is not provided with performance feedback when failing to sensory motor perform. In one embodiment, the second predefined time interval or maximal valid performance time period for lack of response is from 10-20 seconds, preferably from 15-20 seconds, and more preferably 17 seconds. In another embodiment, the second predefined time interval is at least 30 seconds.

In providing the exercises in Example 1, relational open proto-bigrams (ROPB) may be displayed in either a partial or a complete predefined ROPB list or ruler containing one or more ROPB types to be provided to the subject with the predefined number of alphabetic arrays. The ROPB list, whether partial or complete, serves as a facilitating reference for the subject to sensorially perceptually discriminate embedded ROPB terms in the trial exercises in Example 1.

In another aspect of the exercises of Example 1, any selected ROPB that the subject is required to sensorially perceptually discriminate from within the provided alphabetic arrays may be highlighted for a first predefined time interval. Highlighting of the selected ROPBs is effectuated to facilitate the sensorial perceptual discrimination of the same ROPBs in the provided alphabetic arrays by the subject. The duration of the first predefined time interval is not particularly limited. In one embodiment, the first predefined time interval is any interval between 0.5 and 3 seconds.

In another aspect of the exercises of Example 1, the predefined alphabetic arrays comprise stand-alone words. The stand-alone words may further comprise a carrier word and a sub-word embedded in the carrier word. Any stand-alone word may also be complemented with one or two separable affixes. In general, the length of each alphabetic array provided to the subject during any given exercise of Example 1 is not particularly limited. In one preferred embodiment, each of the provided alphabetic arrays has a maximum length of seven letters.

In a further aspect of the exercises of Example 1, the location of a sensory motor selected ROPB in the alphabetic array(s) impacts the change(s) in spatial and/or time perceptual related attribute(s). For example, a correctly sensory motor selected ROPB located in the right visual field of the subject will have a different spatial and/or time perceptual related attribute change than a correctly sensory motor selected ROPB located in the left visual field of the subject. In another example, a correctly sensory motor selected ROPB that is located at the beginning of a stand-alone word from the displayed alphabetic array may have a different spatial and/or time perceptual related attribute that a correctly sensory motor selected ROPB located at the end of a stand-alone word. Further, the difference in spatial and/or time perceptual related attribute changes between a correctly sensory motor selected ROPB at the beginning of a stand-alone word and a correctly sensory motor selected ROPB at the end of a stand-alone word will occur irrespective of and in addition to the location of the ROPB in either the left or right visual field of a subject.

As discussed above, upon sensory motor selection of a correct ROPB answer by the subject, the correctly selected ROPB is immediately displayed with a spatial and/or time perceptual related attribute that is different from the displayed alphabetic arrays. The changed spatial or time perceptual related attributes of the two symbols forming the correctly selected ROPB may include, without being limited to, the following: symbol color, symbol sound, symbol size, symbol font style, symbol spacing, symbol case, boldness of symbol, angle of symbol rotation, symbol mirroring, or combinations thereof. Furthermore, the symbols of the correctly selected ROPB may be displayed with a time perceptual related attribute “flickering” behavior in order to further highlight the differences in perceptual related attributes thereby facilitating the subject's sensorial perceptual discrimination of the differences.

As previously indicated above with respect to the general methods for implementing the present subject matter, the exercises in Example 1 are useful in promoting fluid intelligence abilities in the subject through the sensorial motor and sensorial perceptual domains that jointly engage when the subject performs the given exercise. That is, the serial sensory motor manipulating and sensorial perceptual discrimination of relational open proto-bigrams by the subject engages body movements to execute the sensory motor selecting of the next ROPB and combinations thereof. The motor activity engaged within the subject may be any motor activity jointly involved in the sensorial perception of the complete and incomplete alphabetic arrays. While any body movements can be considered motor activity implemented by the subject's body, the present subject matter is mainly concerned with implemented body movements selected from body movements of the subject's eyes, head, neck, arms, hands, fingers and combinations thereof.

In a preferred embodiment, the sensory motor activity the subject is required to perform is selected from the group including: mouse-clicking on the ROPB, voicing the ROPB, and touching the ROPB with a finger or stick. Additionally, the sensory motor activity may be performed at one or more preselected locations of the displayed alphabetic arrays.

By requesting that the subject engage in specific degrees of body motor activity, the exercises of Example 1 require the subject to bodily-ground cognitive fluid intelligence abilities. The exercises of Example 1 cause the subject to revisit an early developmental realm wherein the subject implicitly acted and/or experienced a fast and efficient enactment of fluid cognitive abilities when specifically dealing with the serial pattern sensorial perceptual discrimination of non-concrete symbol terms and/or symbol terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 1 downplay or mitigate, as much as possible, the subject's need to recall-retrieve and use verbal semantic or episodic memory knowledge in order to support or assist inductive reasoning strategies to problem solve the exercises. The exercises of Example 1 mainly concern promoting fluid intelligence, in general, and do not rise to the cognitive operational level of promoting crystalized intelligence via explicit associative learning and/or word recognition strategies facilitated by retrieval of declarative semantic knowledge from long term memory. Accordingly, each set of displayed alphabetic arrays are intentionally selected and arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 1, the predefined library, which supplies the alphabetic arrays for each exercise, comprises stand-alone words which may or may not contain relational open proto-bigrams. It is contemplated that the predefined library is not limited to stand-alone words, but may also comprise preselected alphabetic arrays.

In an aspect of the present subject matter, the exercises of Example 1 include providing a graphical representation of the selected ROPB to the subject when providing the subject with the predefined number of alphabetic arrays of the exercise. The visual presence of the selected ROPB helps the subject to sensory motor perform the exercise, by promoting a fast, visual spatial, sensorial perceptual discrimination of the presented ROPB. In other words, the visual presence of the selected ROPB assists the subject to sensory motor manipulate and sensorially perceptually discriminate all instances of the selected ROPB from within the displayed alphabetic arrays.

The methods implemented by the exercises of Example 1 also contemplate situations in which the subject fails to perform the given task. The following failure to perform criteria is applicable to any exercise of the present task in which the subject fails to perform. Specifically, there are two kinds of “failure to perform” criteria. The first kind of “failure to perform” criteria occurs in the event that the subject fails to perform by not click-selecting. In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise to be performed without receiving any feedback about his/her actual performance. In some embodiments, this valid performance time period is 17 seconds.

The second “failure to perform” criteria occurs in the event where the subject fails to make a correct sensory motor ROPB selection for three consecutive attempts. As an operational rule applicable for any failed trial exercise in Example 1, failure to perform results in the automatic display of the next trial exercise to be performed from the predefined number of iterations. Importantly, the subject does not receive any performance feedback during any failed trial exercise and prior to the implementation of the automatic display of the next trial exercise to be performed.

In the event the subject fails to correctly sensorially perceptually discriminate and select the selected ROPB(s) in excess of 2 non-consecutive trial exercises (a single block exercise), then one of the following two options will occur: 1) if the failure to perform occurs for more than 2 non-consecutive trial exercises, then the subject's current block-exercise performance is immediately halted. After a time interval of about 2 seconds, the next trial exercise to be performed from the predetermined number of iterations will immediately be displayed and the subject will not be provided with any feedback concerning his/her performance of the previous trial exercise; or 2) when there are no other further trial exercises left to be performed, the subject will be immediately exited from the exercise and returned back to the main menu of the computer program without receiving any performance feedback.

The total duration of the time to complete the exercises of Example 1, as well as the time it took to implement each of the individual trial exercises, are registered in order to help generate an individual and age-gender group performance score. Records of all of the subject's incorrect sensory motor selections from each trial exercise are generated and may be displayed. In general, the subject will perform this task about 6 times during the based brain mental fitness training program.

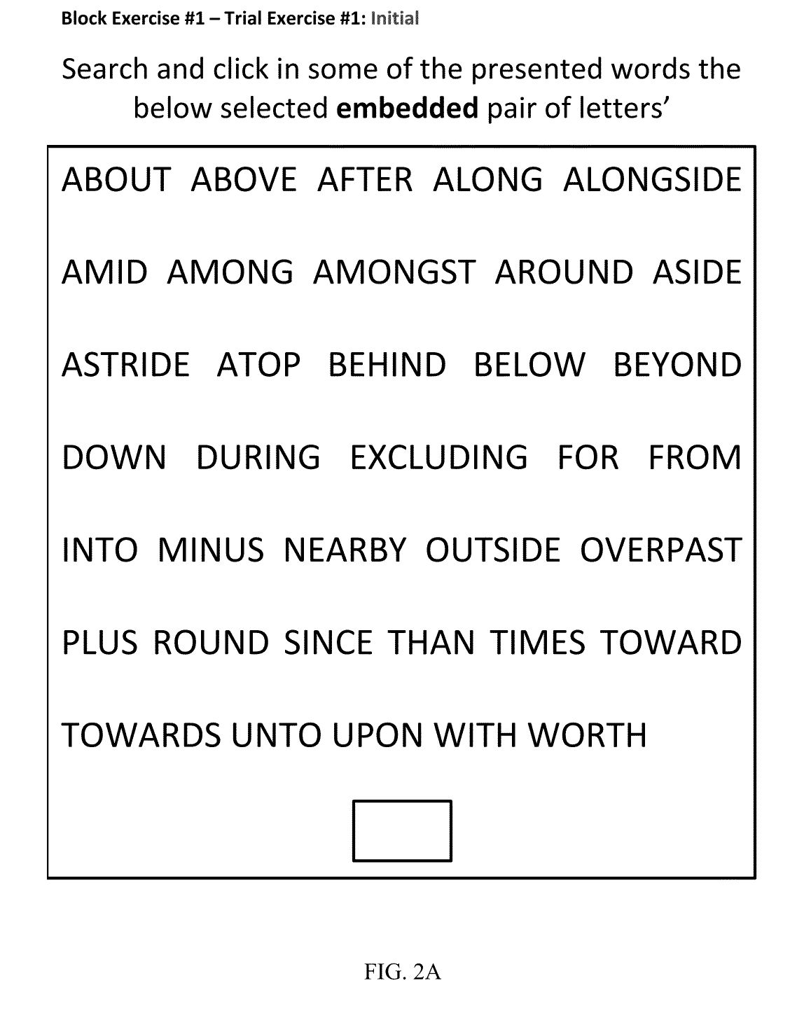

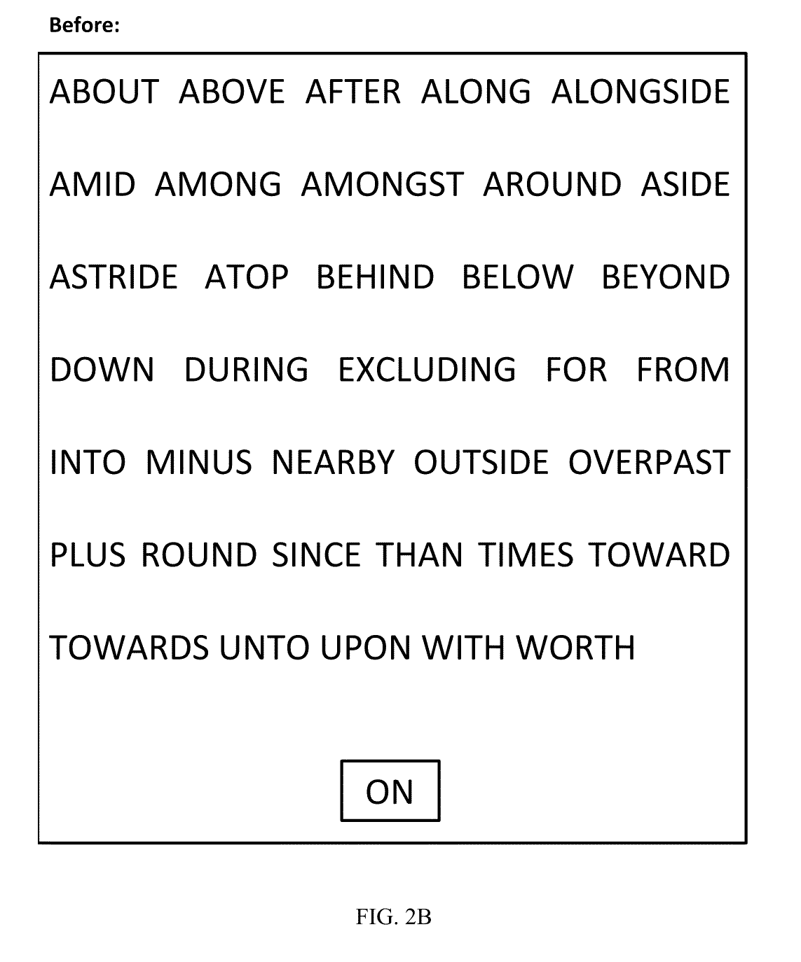

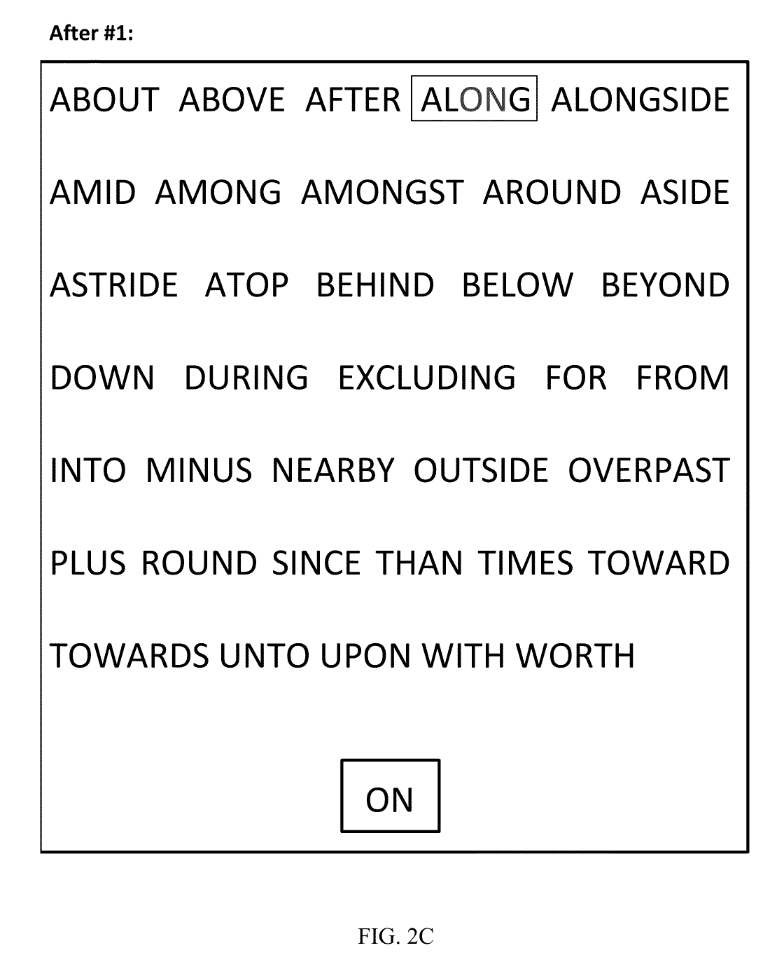

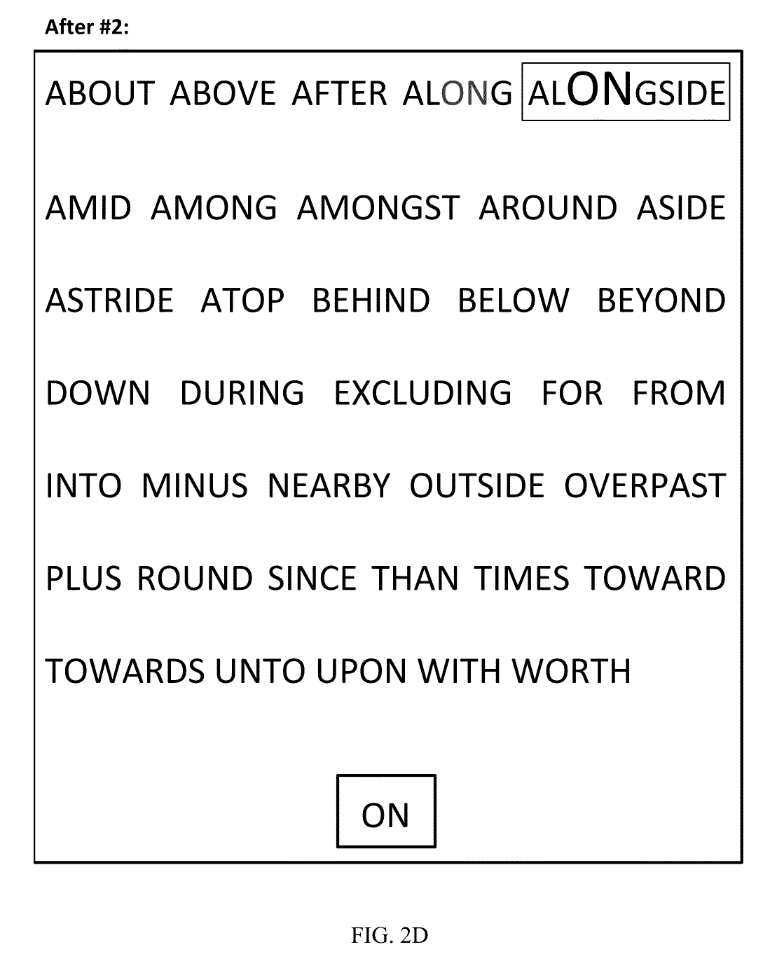

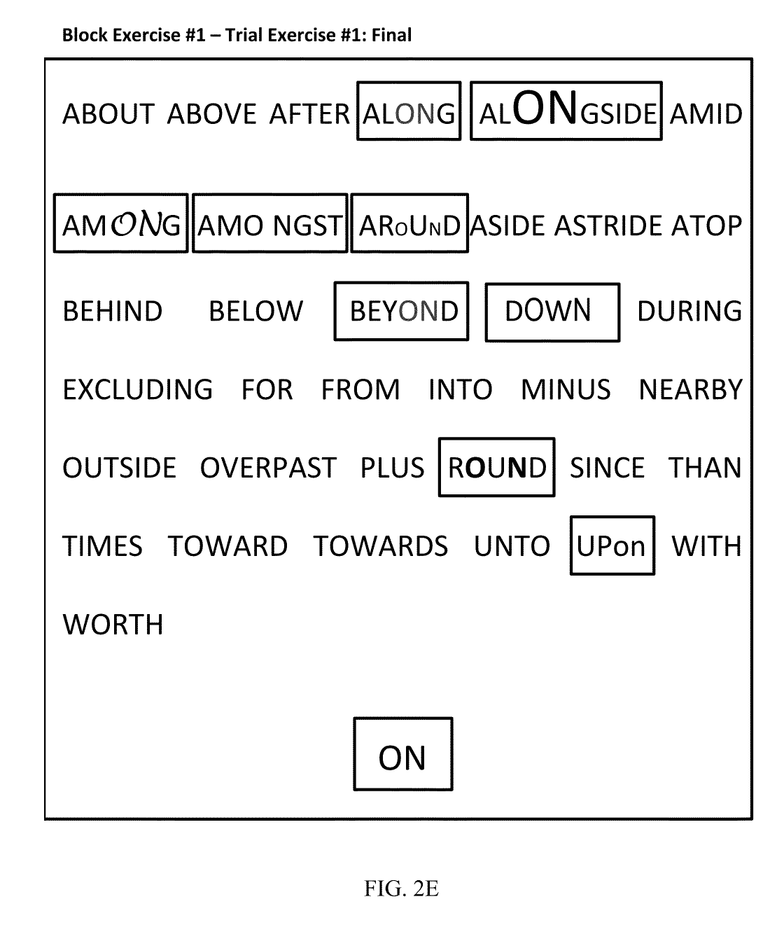

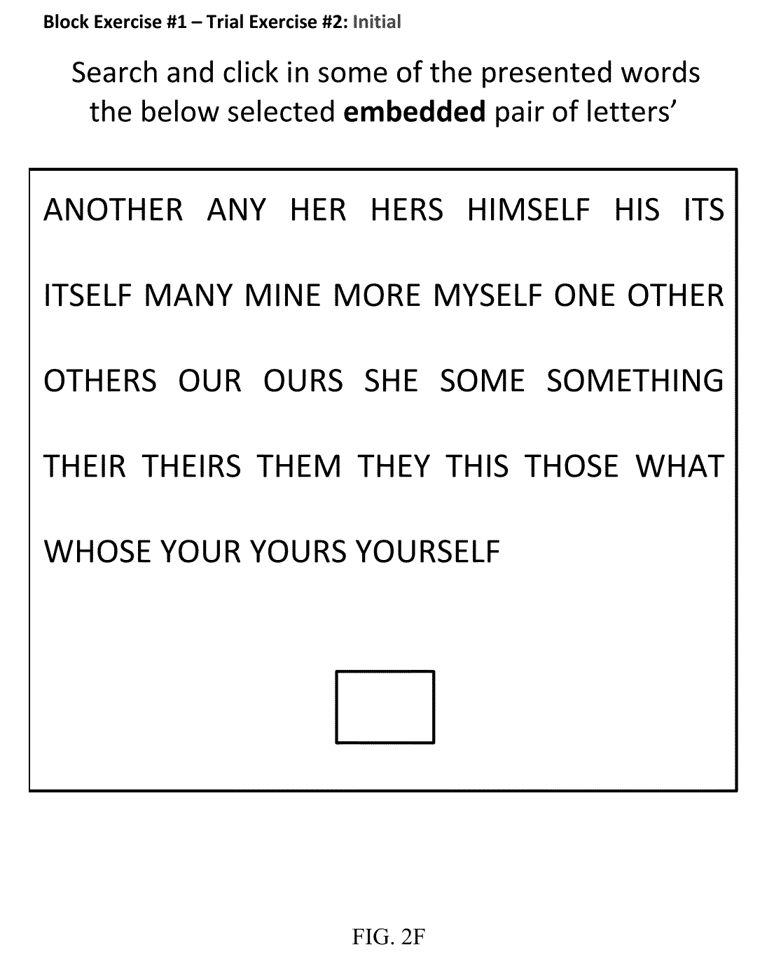

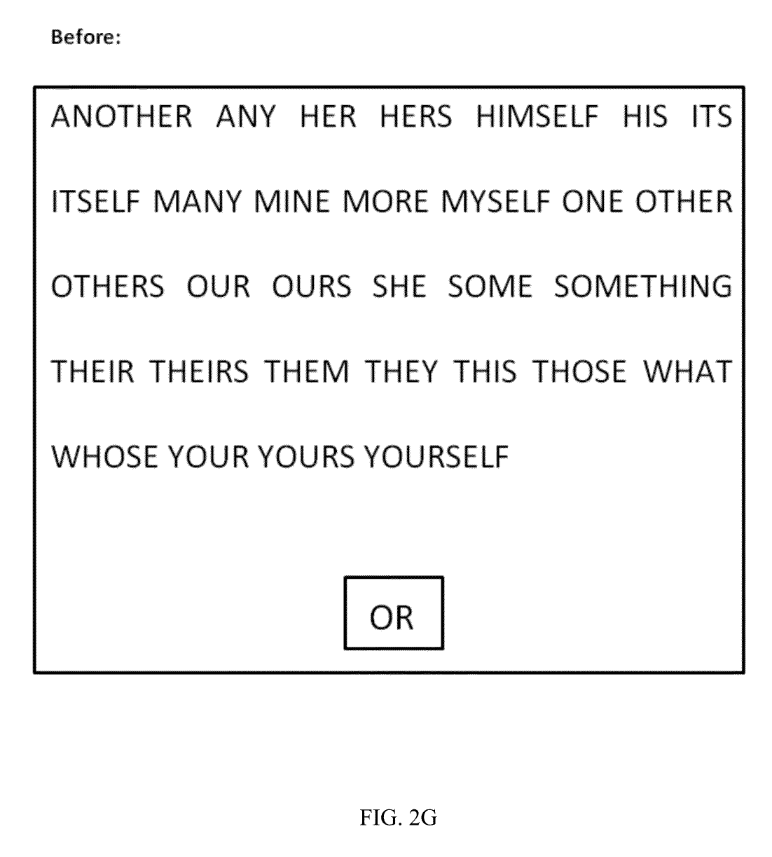

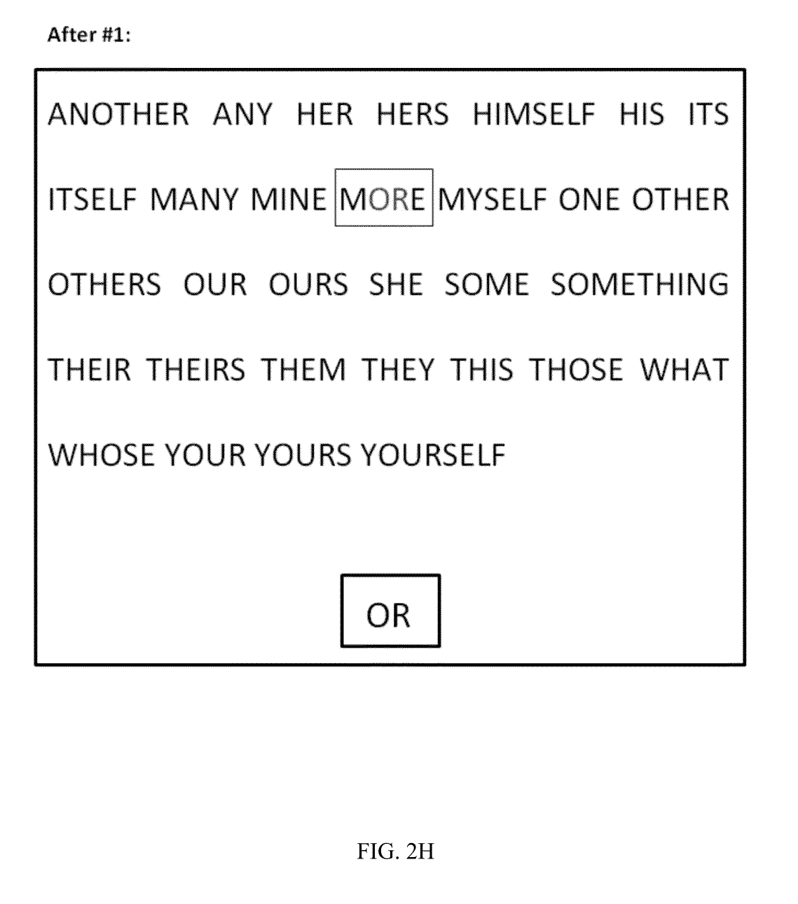

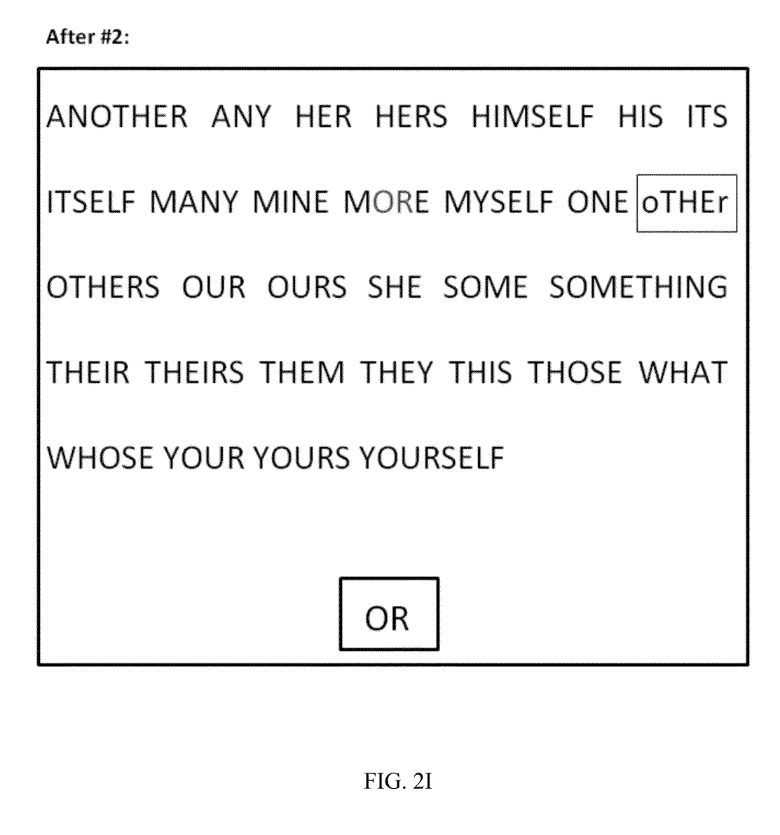

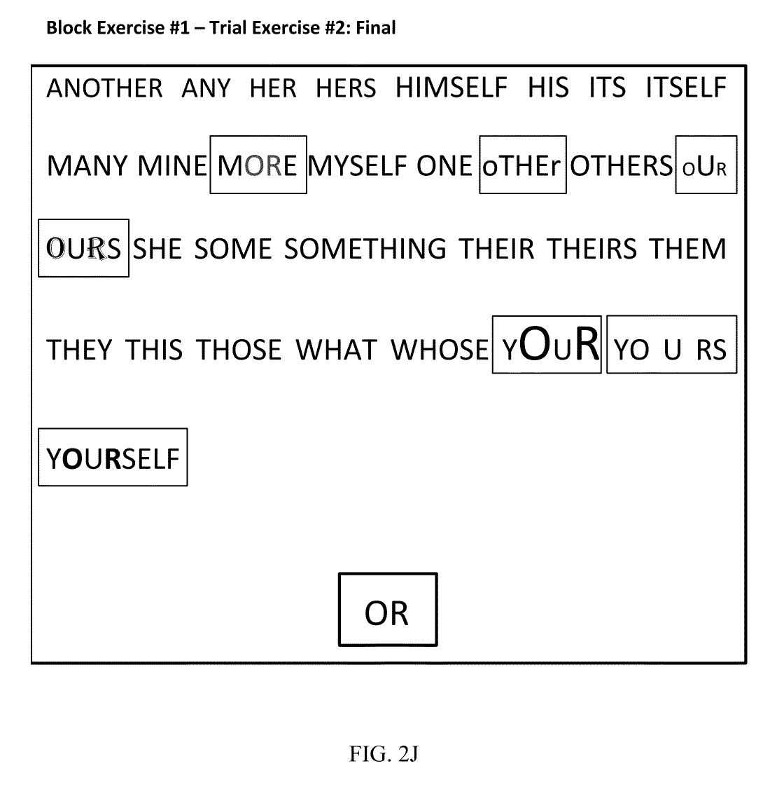

FIGS. 2A-2J depict a number of non-limiting examples of the exercises for sensorially perceptually discriminating relational open proto-bigrams (ROPB) embedded in predefined alphabetic arrays. FIG. 2A shows an arrangement of a number of alphabetic arrays comprising stand-alone words. The stand-alone words are arranged such that the first letter of each word follows the serial order of an incomplete direct alphabetical sequence. In FIG. 2B, the subject is provided with the selected ROPB ‘ON’ which the subject is required to sensorially perceptually discriminate from the stand-alone words. FIG. 2C shows one correct sensory motor selection of the stand-alone word ‘ALONG’. More importantly, the correctly discriminated ROPB ‘ON’ is highlighted by changing the time perceptual related attribute of font color from default to blue. FIG. 2D shows a second correct sensory motor selection of the stand-alone word ‘ALONGSIDE’ with the correctly discriminated ROPB ‘ON’ highlighted by a change in the spatial perceptual related attribute font boldness. It is noted that the ROPB ‘ON’ in the previously selected word ‘ALONG’ remains highlighted with its blue font color. In FIG. 2E, all instances of the correctly sensory motor selected ROPB ‘ON’ have been discriminated, with each correct selection demonstrating at least one spatial and/or time perceptual related attribute different from the spatial and time perceptual related attributes of the displayed alphabetic arrays. In this particular example, the correctly sensory motor selected ROPB ‘ON’ is displayed having at least one of the following spatial and/or time perceptual related attribute changes to highlight the correct selection to the subject: blue font color, font boldness, italicized font, font spacing, and font size (large and small).

FIG. 2F shows a second trial exercise of the same format with a new arrangement of alphabetic arrays comprising stand-alone words. Again, the first letter of each stand-alone word is arranged to follow the serial order of an incomplete direct alphabetical sequence. In FIG. 2G, the subject is provided with the selected ROPB ‘OR’. FIG. 2H shows one sensory motor selection of the stand-alone word ‘MORE’. More importantly, the correctly discriminated ROPB ‘OR’ is highlighted by changing the time perceptual related attribute of font color from default to red. FIG. 2I shows a second correct sensory motor selection of the stand-alone word ‘OTHER’ with the correctly discriminated ROPB ‘OR’ highlighted by a change in the spatial perceptual related attribute font size. It is noted that the embedded ROPB ‘OR’ in the previously selected word ‘MORE’ remains highlighted with its red font color. Finally, in FIG. 2J all instances of the sensory motor selected ROPB ‘OR’ have been correctly discriminated, with each correct sensory motor selection having at least one spatial and/or time perceptual related attribute different from the spatial and time perceptual related attributes of the displayed alphabetic arrays.

### Example 2

### Inserting the Missing Different-Type Relational Open Proto-Bigrams (ROPB) in Predefined Alphabetic Arrays

A goal of the exercises presented in Example 2 is to exercise elemental fluid intelligence ability. As referenced above, the exercises of Example 2 intentionally promote fluid reasoning to quickly enact an abstract conceptual mental web where a number of direct ROPBs, inverse ROPBs, and incomplete alphabetic arrays having semantic meanings relationally interrelate, correlate, and cross-correlate with each other such that the processing and real-time manipulation of these alphabetic arrays is maximized in short-term memory. Importantly, the alphabetic arrays utilized herein are purposefully selected and arranged such to not elicit semantic associations and/or comparisons in order to bypass long-term memory processing of stored semantic information in a subject. Consequently, the real-time sensorial perceptual serial search, discrimination, and motor manipulation of the selected alphabetic arrays does not require the subject to automatically seek for learned semantic information to solve the exercises. Rather, unbeknownst to the subject, the present exercises minimize or eliminate the subject's need to automatically access prior learned and/or stored semantic knowledge by focusing on the intrinsic relational seriality of the alphabetic arrays, even when the presented alphabetic arrays convey a semantic meaning. The general method of the present exercises is directed to promoting fluid intelligence abilities in a subject by inserting the missing different type relational open proto-bigrams (ROPB) in predefined alphabetic arrays. Additionally, it should be noted that this general method will also be applicable to the exercises of Example 3.

The method of promoting fluid intelligence abilities in a subject comprises displaying a predefined number of incomplete alphabetic arrays missing one or more selected relational open proto-bigrams (ROPB) along with a ruler containing a number of ROPB answer choices, wherein the alphabetic arrays are selected from a predefined library of stand-alone words. It is noted that the stand-alone words may also comprise names in the exercises of Example 2. Initially, all of the displayed alphabetic arrays have the same spatial and time perceptual related attributes. The subject is provided with the ruler of ROPB answer choices for the underlying purpose of assisting the subject in sensorially perceptually discriminating which ROPBs complete the displayed alphabetic arrays to form stand-alone words. At the conclusion of the first predefined time period, the subject is prompted to immediately sensory motor select the correct ROPB answer choice(s), which when inserted in the incomplete alphabetic arrays form stand-alone words. For each ROPB selection, the subject is required to perform a sensory motor activity corresponding to the selection. If the sensory motor insertion made by the subject is an incorrect insertion, the subject is automatically returned to the initial displaying step of the method without receiving any performance feedback. If the sensory motor insertion made by the subject is a correct insertion, then the correctly inserted ROPB is immediately displayed with at least one different spatial and/or time perceptual related attribute than the displayed incomplete alphabetic arrays.

The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor insertions. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 2, the method of promoting fluid intelligence abilities in a subject is implemented through a computer program product. In particular, the subject matter in Example 2 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a predefined number of incomplete alphabetic arrays missing one or more selected relational open proto-bigrams (ROPB) along with a ruler containing a number of ROPB answer choices, wherein the alphabetic arrays are selected from a predefined library of stand-alone words. Initially, all of the displayed incomplete alphabetic arrays have the same spatial and time perceptual related attributes. The subject is provided with the ruler of ROPB answer choices for the underlying purpose of assisting the subject in sensorially perceptually discriminating which ROPBs complete the displayed incomplete alphabetic arrays to form stand-alone words. At the conclusion of a first predefined time period, the subject is prompted to sensory motor select the ROPB answer choices, which when inserted in the incomplete alphabetic arrays form stand-alone words. For each ROPB selection, the subject is required to perform a sensory motor activity corresponding to the selection. If the sensory motor insertion made by the subject is an incorrect insertion, the subject is automatically returned to the initial displaying step of the method without receiving any performance feedback. If the sensory motor insertion made by the subject is a correct insertion, then the correctly inserted ROPB is immediately displayed with at least one different spatial and/or time perceptual related attribute than the displayed incomplete alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor insertions.

In a further aspect of Example 2, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a predefined number of incomplete alphabetic arrays missing one or more selected relational open proto-bigrams (ROPB) along with a ruler containing a number of ROPB answer choices on the GUI, wherein the alphabetic arrays selected from a predefined library of stand-alone words. Initially, all of the displayed incomplete alphabetic arrays have the same spatial and time perceptual related attributes. The subject is provided with the ruler of ROPB answer choices on the GUI for the underlying purpose of assisting the subject in sensorially perceptually discriminating which ROPBs complete the displayed alphabetic arrays to form stand-alone words. At the conclusion of a first predefined time period, the subject is prompted to sensory motor select the ROPB answer choices on the GUI, which when inserted in the incomplete alphabetic arrays form stand-alone words. For each ROPB selection, the subject is required to perform a sensory motor activity corresponding to the selection. Once the subject has made a selection, the processor determines whether the sensory motor selection is either correct or incorrect. If the sensory motor insertion made by the subject is an incorrect insertion, the subject is automatically returned to the initial displaying step of the method without receiving any performance feedback. If the sensory motor insertion made by the subject is a correct insertion, then the correctly inserted ROPB is immediately displayed on the GUI with at least one different spatial and/or time perceptual related attribute than the displayed incomplete alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor insertions.

In a preferred embodiment, Example 2 includes a single block exercise having at least three sequential trial exercises. In each trial exercise, a predefined number of alphabetic arrays and a ruler containing ROPB answer choices are presented to the subject. Upon seeing the incomplete alphabetic arrays, the user is required to sensorially perceptually discriminate the ROPBs, which when inserted in the incomplete alphabetic arrays to form stand-alone words. Thereafter, and without delay, the subject must sensory motor insert the discriminated the ROPBs, one at a time, in the incomplete alphabetic arrays. Importantly, the present trial exercises have been designed to reduce cognitive workload by minimizing the dependency of the subject's reasoning and derived inferring skills on real-time manipulation of lexical information by the subject's working memory. Therefore, the ruler of ROPB answer choices is presented as a sensorial perceptual reference tool for the subject in each trial exercise.

The subject is given a limited time frame within which the subject must validly sensory motor perform the exercises. If the subject does not sensory motor perform a given exercise within the second predefined time interval, also referred to as “a valid performance time period”, then after a delay, which could be of about 2 seconds, the next iteration for the subject to sensory motor perform is automatically displayed. Importantly, the subject is not provided with performance feedback when failing to sensory motor perform. In one embodiment, the second predefined time interval or maximal valid performance time period for lack of response is from 10-20 seconds, preferably from 15-20 seconds, and more preferably 17 seconds. In another embodiment, the second predefined time interval is at least 30 seconds.

In providing the exercises in Example 2, relational open proto-bigrams (ROPB) may be displayed in either a partial or a complete predefined ROPB list or ruler containing one or more ROPB types to be provided to the subject with the predefined number of alphabetic arrays. The ROPB list, whether partial or complete, serves as a reference for the subject in sensorially perceptually discriminating embedded ROPB terms to complete each of the trial exercises in Example 2.

In another aspect of the exercises of Example 2, any selected ROPB that the subject is required to sensorially perceptually discriminate from within the provided alphabetic arrays may be highlighted for a first predefined time interval. Highlighting of the selected ROPBs is effectuated to promote the sensorial perceptual discrimination of the same in the provided alphabetic arrays by the subject. The duration of the first predefined time interval is not particularly limited. In one embodiment, the first predefined time interval is any interval between 0.5 and 3 seconds.

In another aspect of the exercises of Example 2, the predefined alphabetic arrays comprise stand-alone words. It is also contemplated that the stand-alone words may comprise names. The stand-alone words may further comprise a carrier word and a sub-word embedded in the carrier word. Any stand-alone word may also be complemented with one or two separable affixes. In general, the length of each alphabetic array provided to the subject during any given exercise of Example 2 is not particularly limited. In one embodiment, each of the provided alphabetic arrays has a maximum length of seven letters.

In a further aspect of the exercises of Example 2, the location of a correctly sensory motor inserted ROPB in the alphabetic array(s) impacts the change(s) in spatial and/or time perceptual related attribute(s). For example, a correctly sensory motor inserted ROPB located in the right visual field of the subject will have a different spatial and/or time perceptual related attribute change than a correctly sensory motor inserted ROPB located in the left visual field of the subject. In another example, a correctly sensory motor inserted ROPB that is located at the beginning of a stand-alone word from the displayed alphabetic arrays may have a different spatial and/or time perceptual related attribute than a correctly sensory motor inserted ROPB located at the end of a stand-alone word. Further, the difference in spatial and/or time perceptual related attribute changes between a correctly sensory motor inserted ROPB at the beginning of a stand-alone word and a correctly sensory motor inserted ROPB at the end of a stand-alone word will occur irrespective of and in addition to the location of the ROPB in either the left or right visual field of a subject.

As discussed above, upon sensory motor insertion of a correct answer by the subject, the correctly inserted ROPB is immediately displayed with a spatial and/or time perceptual related attribute that is different from the displayed incomplete alphabetic arrays. The changed spatial or time perceptual related attributes of the two symbols forming the correctly inserted ROPB may include, without being limited to, the following: symbol color, symbol sound, symbol size, symbol font style, symbol spacing, symbol case, boldness of symbol, angle of symbol rotation, symbol mirroring, or combinations thereof. Furthermore, the symbols of the correctly inserted ROPB may be displayed with a time perceptual attribute “flickering” behavior in order to further highlight the differences in perceptual related attributes thereby facilitating the subject's sensorial perceptual discrimination of the differences.

As previously indicated above with respect to the general methods for implementing the present subject matter, the exercises in Example 2 are useful in promoting fluid intelligence abilities in the subject through the sensorial motor and perceptual domains that jointly engage when the subject performs the given exercise. That is, the serial manipulating or sensorial perceptual discrimination of relational open proto-bigrams by the subject engages body movements to execute inserting the next ROPB, and combinations thereof. The motor activity engaged within the subject may be any motor activity jointly involved in the sensorial perception of the complete and incomplete alphabetic arrays. While any body movements can be considered motor activity implemented by the subject's body, the present subject matter is mainly concerned with implemented body movements selected from body movements of the subject's eyes, head, neck, arms, hands, fingers and combinations thereof.

In a preferred embodiment, the sensory motor activity the subject is required to perform is selected from the group including: mouse-clicking on the ROPB, voicing the ROPB, and touching the ROPB with a finger or stick.

By requesting that the subject engage in specific degrees of body motor activity, the exercises of Example 2 require the subject to bodily-ground cognitive fluid intelligence abilities. The exercises of Example 2 cause the subject to revisit an early developmental realm wherein the subject implicitly acted and/or experienced a fast and efficient enactment of fluid cognitive abilities when specifically dealing with the serial pattern sensorial perceptual discrimination of non-concrete symbol terms and/or symbol terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 2 downplay or mitigate, as much as possible, the subject's need to recall-retrieve and use verbal semantic or episodic memory knowledge in order to support or assist inductive reasoning strategies to problem solve the exercises. The exercises of Example 2 mainly concern promoting fluid intelligence, in general, and do not rise to the cognitive operational level of promoting crystalized intelligence via explicit associative learning and/or word recognition strategies facilitated by retrieval of declarative semantic knowledge from long term memory. Accordingly, each set of displayed alphabetic arrays are intentionally selected and arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 2, the predefined library, which supplies the alphabetic arrays for each exercise, comprises stand-alone words, which may or may not contain relational open proto-bigrams. It is contemplated that the predefined library is not limited to stand-alone words, but may also comprise preselected alphabetic arrays.

In an aspect of the present subject matter, the exercises of Example 2 include providing a graphical representation of selected ROPB answer choices to the subject in the form of a ruler when providing the subject with the predefined number of incomplete alphabetic arrays of the exercise. The visual presence of the ruler helps the subject to perform the exercise, by promoting a fast, visual spatial, sensorial perceptual discrimination of the missing ROPB(s). In other words, the visual presence of the selected ROPB answer choices assists the subject to sensory motor manipulate and sensorially perceptually discriminate the ROPBs, which when inserted in the incomplete alphabetic arrays form a stand-alone word.

The methods implemented by the exercises of Example 2 also contemplate situations in which the subject fails to perform the given task. The following failure to perform criteria is applicable to any exercise of the present task in which the subject fails to perform. Specifically, there are two kinds of “failure to perform” criteria. The first kind of “failure to perform” criteria occurs in the event that the subject fails to perform by not click-selecting. In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise to be performed without receiving any feedback about his/her actual performance. In some embodiments, this valid performance time period is 17 seconds.

The second “failure to perform” criteria occurs in the event where the subject fails to make a correct sensory motor ROPB selection for three consecutive attempts. As an operational rule applicable for any failed trial exercise in Example 2, failure to perform results in the automatic display of the next trial exercise to be performed from the predefined number of iterations. Importantly, the subject does not receive any performance feedback during any failed trial exercise and prior to the implementation of the automatic display of the next trial exercise to be performed.

In the event the subject fails to correctly sensorially perceptually discriminate and sensory motor insert the correct ROPB(s) in excess of 2 non-consecutive trial exercises (a single block exercise), then one of the following two options will occur: 1) if the failure to perform occurs for more than 2 non-consecutive trial exercises, then the subject's current block exercise performance is immediately halted. After a time interval of about 2 seconds, the next trial exercise to be performed from the predetermined number of iterations will immediately be displayed and the subject will not be provided with any feedback concerning his/her performance of the previous trial exercise; or 2) when there are no other further trial exercises left to be performed, the subject will be immediately exited from the exercise and returned back to the main menu of the computer program without receiving any performance feedback.

The total duration of the time to complete the exercises of Example 2, as well as the time it took to implement each of the individual trial exercises, are registered in order to help generate an individual and age-gender group performance score. Records of all of the subject's incorrect sensory motor selections from each trial exercise are generated and may be displayed. In general, the subject will perform this task about 6 times during the based brain mental fitness training program.

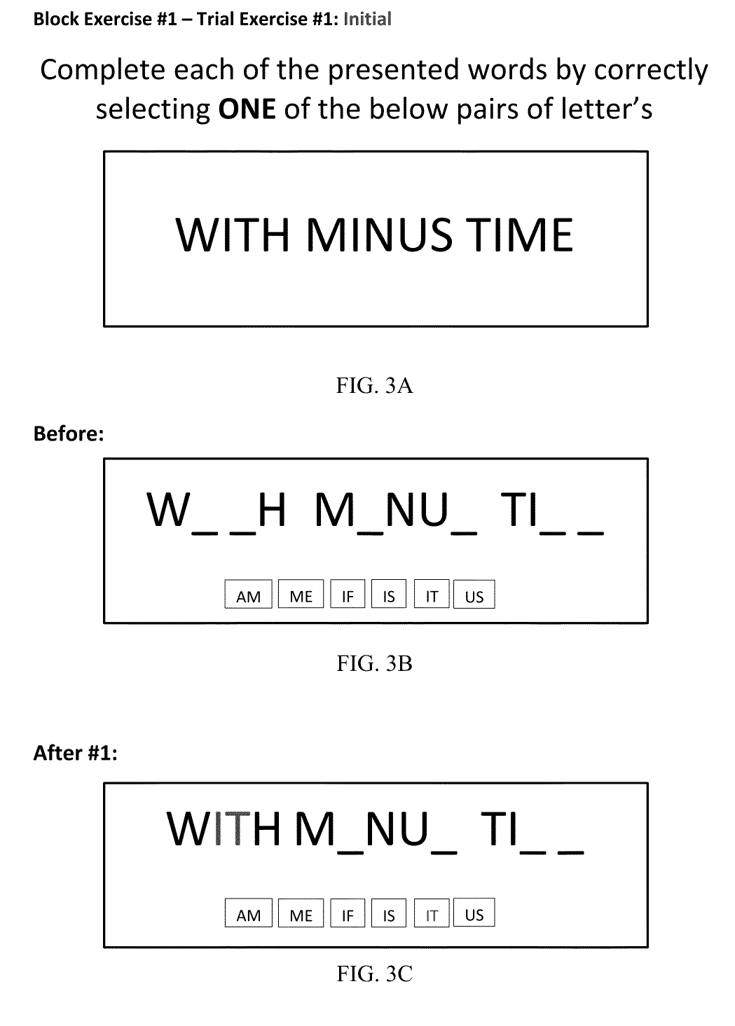

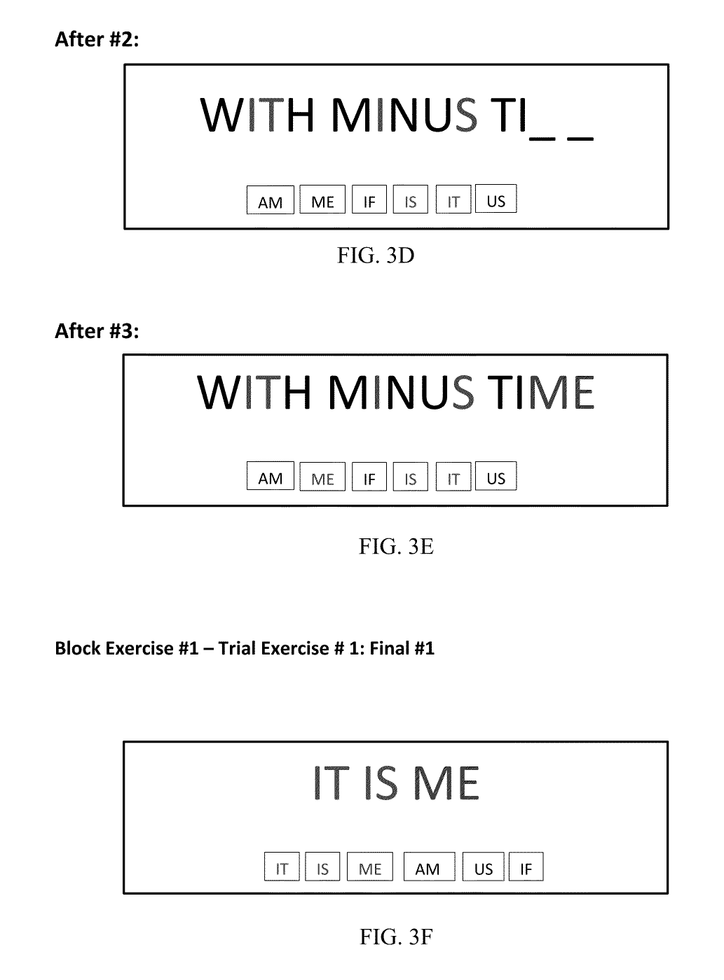

FIGS. 3A-3F depict a number of non-limiting examples of the exercises for inserting missing different-type relational open proto-bigrams (ROPB) in predefined alphabetic arrays. FIG. 3A shows an arrangement of selected predefined alphabetic arrays comprising stand-alone words. In FIG. 3B, the subject is provided with the incomplete alphabetic arrays of stand-alone words along with a ruler of ROPB answer choices. FIG. 3C shows one correct sensory motor insertion of the ROPB ‘IT’ in the incomplete alphabetic array ‘W_{— —} H’, thereby forming the stand-alone word ‘WITH’. More importantly, the correctly inserted ROPB ‘IT’ is highlighted by changing the time perceptual related attribute of font color from default to red. It is noted that the ROPB ‘IT’ is also displayed in the ruler with the same red font color.

FIG. 3D shows a second correct sensory motor insertion of the ROPB ‘IS’ in the incomplete alphabetic array ‘M_NU_’ with the correctly inserted ROPB ‘IS’ highlighted by a change in the default time perceptual related attribute of font color from default to red. The ROPB ‘IS’ is also displayed in the ruler with the same red font color. It is noted that the ROPB ‘IT’ from the previous correct insertion remains highlighted with its red font color in the alphabetic array and the ruler. In FIG. 3E, the last ROPB ‘ME’ is correctly inserted in the incomplete alphabetic array ‘TI_{— —}’ and is highlighted in both the alphabetic array and the ruler by being displayed in the time perceptual related attribute of font color blue.

In the final step of the trial exercise, as shown in FIG. 3F, the provided incomplete alphabetic arrays are removed, leaving only the correctly inserted different-type ROPBs to be displayed. Removal of the provided incomplete alphabetic arrays further reveals the grammatically correct sentence “it is me” that is formed by the correctly inserted ROPBs ‘IT’, ‘IS’, and ‘ME’. Additionally, it is noted that the inserted ROPBs retain the changed time and/or spatial perceptual related attributes when the incomplete alphabetic arrays are removed.

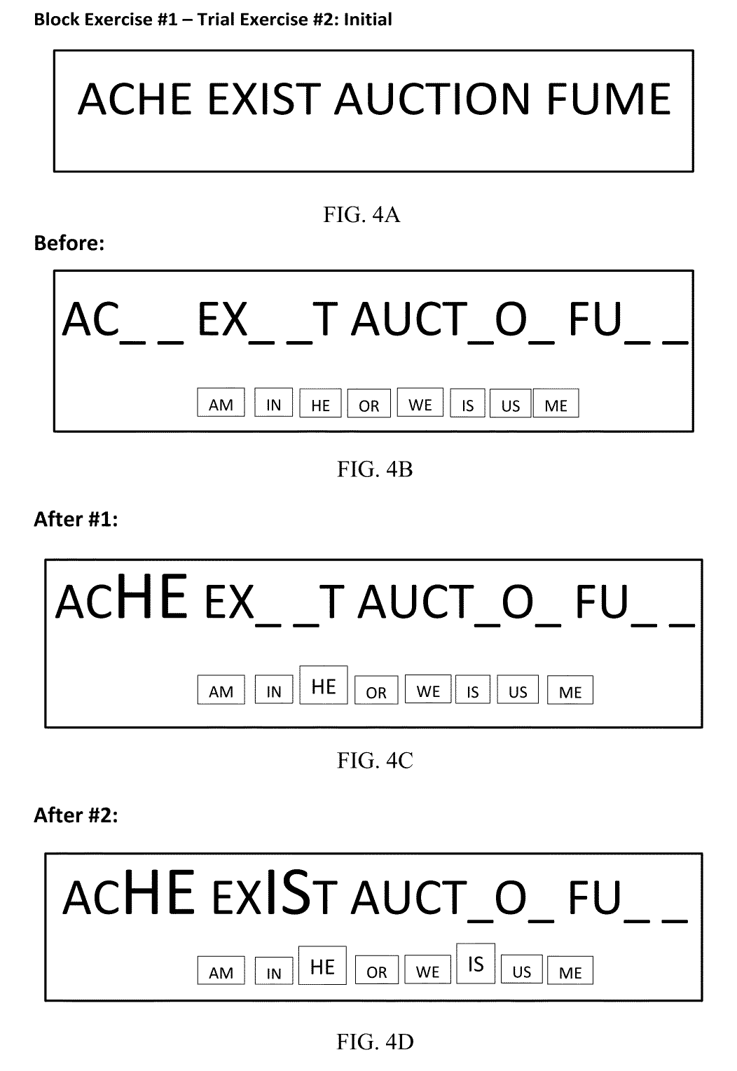

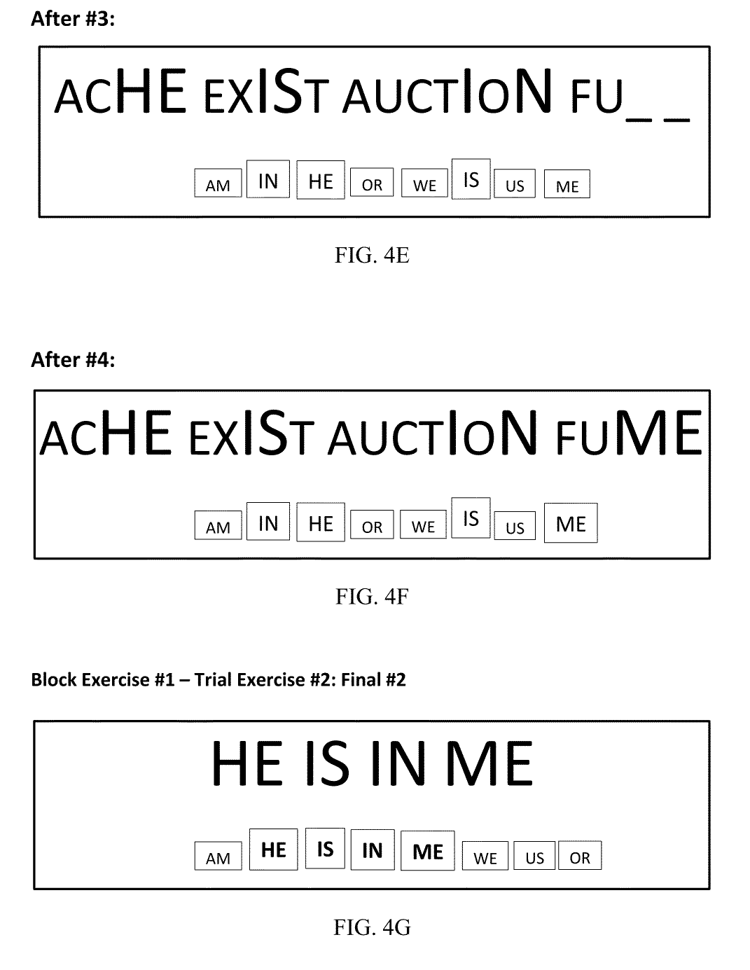

FIGS. 4A-4G depict another example of the trial exercises for inserting missing different-type relational open proto-bigrams (ROPB) in predefined alphabetic arrays. FIG. 4A shows an arrangement of selected predefined alphabetic arrays comprising stand-alone words. In FIG. 4B, the subject is provided with the incomplete alphabetic arrays of stand-alone words along with a ruler of ROPB answer choices. FIG. 4C shows one correct sensory motor insertion of the ROPB ‘HE’ in the incomplete alphabetic array ‘AC_{— —} ’, thereby forming the stand-alone word ‘ACHE’. More importantly, the correctly inserted ROPB ‘HE’ is highlighted by changing the spatial perceptual related attribute of font size to a larger font size. It is noted that the ROPB ‘HE’ is also displayed in the ruler with the same larger font size.

FIG. 4D shows a second correct sensory motor insertion of the ROPB ‘IS’ in the incomplete alphabetic array ‘EX_{— —}T’ with the correctly inserted ROPB ‘IS’ highlighted by a change in the spatial perceptual related attribute of font size to a larger size. The ROPB ‘IS’ is also displayed in the ruler with the same larger font size. It is noted that the ROPB ‘HE’ from the previous correct insertion remains highlighted by its larger font size in the alphabetic array and the ruler. In FIG. 4E, the next ROPB ‘IN’ is correctly sensory motor inserted in the incomplete alphabetic array ‘AUCT_O_’ and is highlighted in both the alphabetic array and the ruler by being displayed with a larger font size. FIG. 4F shows the last ROPB ‘ME’ as correctly inserted in the incomplete alphabetic array ‘FU_{— —}’ and is highlighted in both the alphabetic array and the ruler by being displayed with a larger font size.

In the final step of the trial exercise, as shown in FIG. 4G, the provided incomplete alphabetic arrays are removed, leaving only the correctly inserted different-type ROPBs to be displayed. Removal of the provided incomplete alphabetic arrays further reveals the grammatically correct sentence “he is in me” that is formed by the correctly inserted ROPBs ‘HE’ ‘IS’, ‘IN’, and ‘ME’. Additionally, it is noted that the inserted ROPBs retain the changed time and/or spatial perceptual related attributes when the incomplete alphabetic arrays are removed.

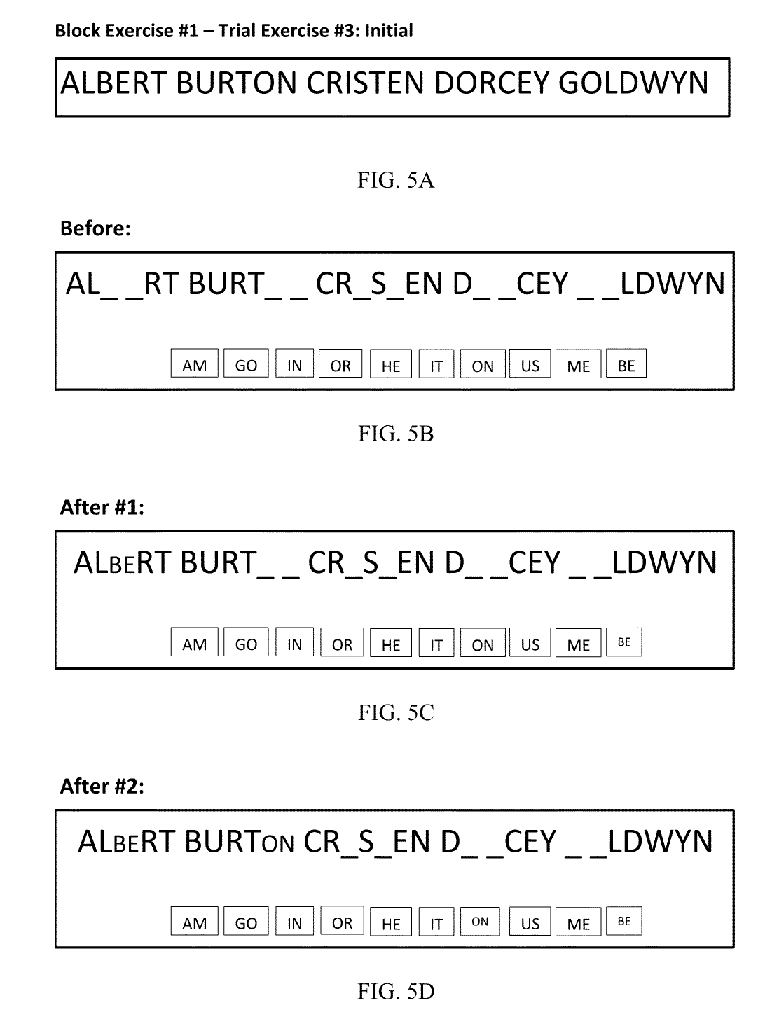

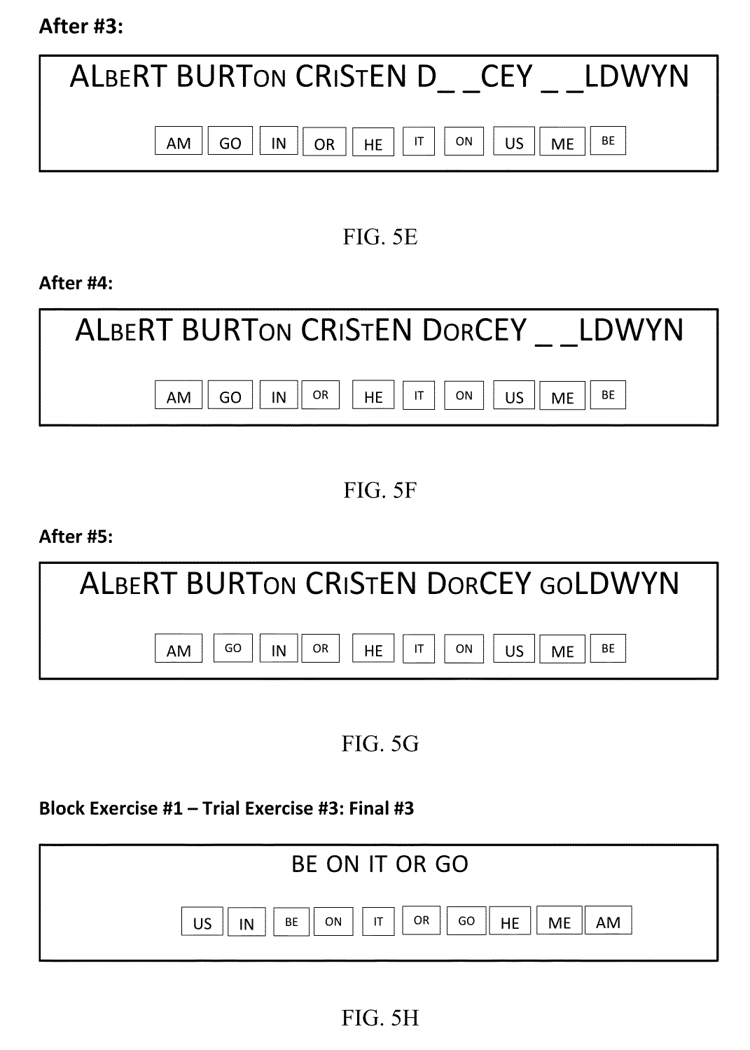

FIGS. 5A-5H depict yet another example of the trial exercises for inserting missing different-type relational open proto-bigrams (ROPB) in predefined alphabetic arrays. FIG. 5A shows an arrangement of selected predefined alphabetic arrays comprising names. In FIG. 5B, the subject is provided with the incomplete alphabetic arrays and with a ruler of ROPB answer choices FIG. 5C shows one correct sensory motor insertion of the ROPB ‘BE’ in the incomplete alphabetical array ‘AL_{— —}RT’ to form the name ‘ALBERT’. More importantly, the correctly inserted ROPB ‘BE’ is highlighted by changing to the spatial perceptual related attribute of font size to a smaller size. It is noted that the ROPB ‘BE’ is also displayed in the ruler with the same smaller font size.

FIG. 5D shows a second correct sensory motor insertion of the ROPB ‘ON’ in the incomplete alphabetic array ‘BURT_{— —}’ with the correctly inserted ROPB ‘ON’ highlighted by a change in the spatial perceptual related attribute of font size to a smaller font size. The ROPB ‘ON’ is also displayed in the ruler with the same smaller font size. It is noted that the ROPB ‘BE’ from the previous correct insertion remains highlighted by its smaller font size in the alphabetic array and the ruler. In FIG. 5E, the next ROPB ‘IT’ is correctly sensory motor inserted in the incomplete alphabetic array ‘CR_S_EN’ and is highlighted in both the alphabetic array and the ruler by being displayed in a smaller font size. FIG. 5F shows the correctly sensory motor inserted ROPB ‘OR’ in the incomplete alphabetic array ‘D_{— —}CEY’ and is highlighted in both the alphabetic array and the ruler by being displayed with a smaller font size. In FIG. 5G, the last ROPB ‘GO’ is correctly sensory motor inserted in the incomplete alphabetic array ‘_{— —}LDWYN’ and is highlighted in both the alphabetic array and the ruler by being displayed in a smaller font size. In the final step of the trial exercise, as shown in FIG. 5H, the provided incomplete alphabetic arrays are removed, leaving only the correctly sensory motor inserted different-type ROPBs to be displayed. Removal of the provided incomplete alphabetic arrays further reveals the grammatically correct sentence “be on it or go” that is formed by the correctly inserted ROPBs ‘BE’ ‘ON’, ‘IT’ ‘OR’, and ‘GO’. Additionally, it is noted that the inserted ROPBs retain the changed time and/or spatial perceptual related attributes when the incomplete alphabetic arrays are removed.

### Example 3

### Inserting the Missing Same-Type Relational Open Proto-Bigrams (ROPB) in Predefined Alphabetic Arrays

A goal of the exercises presented in Example 3 is to exercise elemental fluid intelligence ability. Much like Example 2, the exercises of Example 3 intentionally promote fluid reasoning to quickly enact an abstract conceptual mental web where a number of relational direct ROPBs, inverse ROPBs, and incomplete alphabetic arrays having semantic meanings relationally interrelate, correlate, and cross-correlate with each other such that the processing and real-time manipulation of these alphabetic arrays is maximized in short-term memory. Importantly, the alphabetic arrays utilized herein are purposefully selected and arranged such to not elicit semantic associations and/or comparisons in order to bypass long-term memory processing of stored semantic information in a subject. Consequently, the real-time sensorial perceptual serial search, discrimination, and motor manipulation of the selected alphabetic arrays does not require the subject to automatically retrieve-recall semantic information learned from past experiences to solve the present exercises. Rather, unbeknownst to the subject, the present exercises minimize or eliminate the subject's need to access prior learned and/or stored semantic knowledge by focusing on the intrinsic relational seriality of the alphabetic arrays, even when the presented alphabetic array convey a semantic meaning.

As referenced above, the general method of the present exercises is directed to promoting fluid intelligence abilities in a subject by inserting the missing same-type relational open proto-bigrams (ROPB) in predefined alphabetic arrays. Examples 2 and 3, as described herein, share similarities in operation but differ in the type of ROPB insertions. In other words, the correct ROPB insertions in the non-limiting examples of Example 3 are of the same type or are repeated whereas the inserted ROPBs depicted in the exercises of Example 2 are different or do not repeat.

The method of promoting fluid intelligence abilities in a subject comprises displaying a predefined number of incomplete alphabetic arrays missing one or more selected relational open proto-bigrams (ROPB) along with a ruler containing a number of ROPB answer choices, wherein the alphabetic arrays are selected from a predefined library of stand-alone words. Initially, all of the displayed alphabetic arrays have the same spatial and time perceptual related attributes. The subject is provided with the ruler of ROPB answer choices for the underlying purpose of assisting the subject in sensorially perceptually discriminating which ROPBs complete the displayed incomplete alphabetic arrays to form stand-alone words. At the conclusion of the first predefined time period, the subject is prompted to immediately sensory motor select the correct ROPB answer choice(s), which when inserted in the incomplete alphabetic arrays form stand-alone words. For each ROPB selection, the subject is required to perform a sensory motor activity corresponding to the selection. If the sensory motor insertion made by the subject is an incorrect insertion, the subject is automatically returned to the initial displaying step of the method without receiving any performance feedback. If the sensory motor insertion made by the subject is a correct insertion, then the correctly inserted ROPB is immediately displayed with at least one different spatial and/or time perceptual related attribute than the displayed incomplete alphabetic arrays.

The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor insertions. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 3, the method of promoting fluid intelligence abilities in a subject is implemented through a computer program product. In particular, the subject matter in Example 3 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a predefined number of incomplete alphabetic arrays missing one or more selected relational open proto-bigrams (ROPB) along with a ruler containing a number of ROPB answer choices, wherein the alphabetic arrays are selected from a predefined library of stand-alone words. Initially, all of the displayed incomplete alphabetic arrays have the same spatial and time perceptual related attributes. The subject is provided with the ruler of ROPB answer choices for the underlying purpose of assisting the subject in sensorially perceptually discriminating which ROPBs complete the displayed incomplete alphabetic arrays to form stand-alone words. At the conclusion of a first predefined time period, the subject is prompted to sensory motor select the ROPB answer choices, which when inserted in the incomplete alphabetic arrays form stand-alone words. For each ROPB selection, the subject is required to perform a sensory motor activity corresponding to the selection. If the sensory motor insertion made by the subject is an incorrect insertion, the subject is automatically returned to the initial displaying step of the method without receiving any performance feedback. If the sensory motor insertion made by the subject is a correct insertion, then the correctly inserted ROPB is immediately displayed with at least one different spatial and/or time perceptual related attribute than the displayed incomplete alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor insertions.

In a further aspect of Example 3, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a predefined number of incomplete alphabetic arrays missing one or more selected relational open proto-bigrams (ROPB) along with a ruler containing a number of ROPB answer choices on the GUI, wherein the alphabetic arrays are selected from a predefined library of stand-alone words. Initially, all of the displayed incomplete alphabetic arrays have the same spatial and time perceptual related attributes. The subject is provided with the ruler of ROPB answer choices on the GUI for the underlying purpose of assisting the subject in sensorially perceptually discriminating which ROPBs complete the displayed incomplete alphabetic arrays to form stand-alone words. At the conclusion of a first predefined time period, the subject is prompted to sensory motor select the ROPB answer choices on the GUI, which when inserted in the incomplete alphabetic arrays form stand-alone words. For each ROPB selection, the subject is required to perform a sensory motor activity corresponding to the selection. Once the subject has made a sensory motor selection, the processor determines whether the sensory motor selection is either correct or incorrect. If the sensory motor insertion made by the subject is an incorrect insertion, the subject is automatically returned to the initial displaying step of the method without receiving any performance feedback. If the sensory motor insertion made by the subject is a correct insertion, then the correctly inserted ROPB is immediately displayed on the GUI with at least one different spatial and/or time perceptual related attribute than the displayed incomplete alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor insertions.

In a preferred embodiment, Example 3 includes two block exercises each having at least two sequential trial exercises. In each trial exercise, a predefined number of incomplete alphabetic arrays and a ruler containing ROPB answer choices are presented to the subject. Upon seeing the incomplete alphabetic arrays, the user is required to sensorially perceptually discriminate the ROPB, which when inserted in the incomplete alphabetic arrays to forms stand-alone words. Thereafter, and without delay, the subject must sensory motor insert the discriminated ROPB in the incomplete alphabetic arrays. Importantly, the present trial exercises have been designed to reduce cognitive workload by minimizing the dependency of the subject's reasoning and derived inferring skills on real-time manipulation of lexical information by the subject's working memory. Therefore, the ruler of ROPB answer choices is presented as a sensorial perceptual reference tool for the subject in each trial exercise.

The subject is given a limited time frame within which the subject must validly sensory motor perform the exercises. If the subject does not sensory motor perform a given exercise within the second predefined time interval, also referred to as “a valid performance time period”, then after a delay, which could be of about 2 seconds, the next iteration for the subject to sensory motor perform is automatically displayed. Importantly, the subject is not provided with performance feedback when failing to sensory motor perform. In one embodiment, the second predefined time interval or maximal valid performance time period for lack of response is from 10-20 seconds, preferably from 15-20 seconds, and more preferably 17 seconds. In another embodiment, the second predefined time interval is at least 30 seconds.

In providing the exercises in Example 3, relational open proto-bigrams (ROPB) may be displayed in either a partial or a complete predefined ROPB list or ruler containing one or more ROPB types to be provided to the subject with the predefined number of alphabetic arrays. The ROPB list, whether partial or complete, serves as a reference for the subject in sensorially perceptually discriminating embedded ROPB terms to complete each of the trial exercises in Example 3.

In another aspect of the exercises of Example 3, any selected ROPB that the subject is required to sensorially perceptually discriminate from within the provided incomplete alphabetic arrays may be highlighted for a first predefined time interval. Highlighting of the selected ROPBs is effectuated to promote the sensorial perceptual discrimination of the same ROPB as either partially or totally completing the provided incomplete alphabetic arrays by the subject. The duration of the first predefined time interval is not particularly limited. In one embodiment, the first predefined time interval is any interval between 0.5 and 3 seconds.

In another aspect of the exercises of Example 3, the predefined alphabetic arrays comprise stand-alone words. The stand-alone words may further comprise a carrier word and a sub-word embedded in the carrier word. Any stand-alone word may also be complemented with one or two separable affixes. In general, the length of each alphabetic array provided to the subject during any given exercise of Example 3 is not particularly limited. In one embodiment, each of the provided alphabetic arrays has a maximum length of seven letters.

In a further aspect of the exercises of Example 3, the location of a correctly sensory motor inserted ROPB in the alphabetic array(s) impacts the change(s) in spatial and/or time perceptual related attribute(s). For example, a correctly sensory motor inserted ROPB located in the right visual field of the subject will have a different spatial and/or time perceptual related attribute change than a correctly sensory motor inserted ROPB located in the left visual field of the subject. In another example, a correctly sensory motor inserted ROPB that is located at the beginning of a stand-alone word from the displayed alphabetic arrays may have a different spatial and/or time perceptual related attribute change that a correctly sensory motor inserted ROPB located at the end of a stand-alone word. Further, the difference in perceptual related attribute changes between a correctly sensory motor inserted ROPB at the beginning of a stand-alone word and a correctly sensory motor inserted ROPB at the end of a stand-alone word will occur irrespective of and in addition to the location of the ROPB in either the left or right visual field of a subject.

As discussed above, upon the sensory motor insertion of a correct answer by the subject, the correctly inserted ROPB is immediately displayed with a spatial and/or time perceptual related attribute that is different from the displayed incomplete alphabetic arrays. The changed spatial or time perceptual related attributes of the two symbols forming the correctly inserted ROPB may include, without being limited to, the following: symbol color, symbol sound, symbol size, symbol font style, symbol spacing, symbol case, boldness of symbol, angle of symbol rotation, symbol mirroring, or combinations thereof. Furthermore, the symbols of the correctly inserted ROPB may be displayed with a time perceptual attribute “flickering” behavior in order to further highlight the differences in perceptual related attributes thereby facilitating the subject's sensorial perceptual discrimination of the differences.

As previously indicated above with respect to the general methods for implementing the present subject matter, the exercises in Example 3 are useful in promoting fluid intelligence abilities in the subject through the sensorial motor and sensorial perceptual domains that jointly engage when the subject performs the given exercise. That is, the serial manipulating and the sensorial perceptual discrimination of relational open proto-bigrams by the subject engage body movements to execute sensory motor inserting the correct ROPB, and combinations thereof. The motor activity engaged within the subject may be any motor activity jointly involved in the sensorial perception of the complete and incomplete alphabetic arrays. While any body movements can be considered motor activity implemented by the subject's body, the present subject matter is mainly concerned with implemented body movements selected from body movements of the subject's eyes, head, neck, arms, hands, fingers and combinations thereof.

In a preferred embodiment, the sensory motor activity the subject is required to perform is selected from the group including: mouse-clicking on the ROPB, voicing the ROPB, and touching the ROPB with a finger or stick.

By requesting that the subject engage in specific degrees of body motor activity, the exercises of Example 3 require the subject to bodily-ground cognitive fluid intelligence abilities. The exercises of Example 3 cause the subject to revisit an early developmental realm wherein the subject implicitly acted and/or experienced a fast and efficient enactment of fluid intelligence cognitive abilities when specifically dealing with the serial pattern sensorial perceptual discrimination of non-concrete symbol terms and/or symbol terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 3 downplay or mitigate, as much as possible, the subject's need to recall-retrieve and therefore use verbal semantic or episodic memory knowledge in order to support or assist inductive reasoning strategies to problem solve the exercises. The exercises of Example 3 mainly concern promoting fluid intelligence, in general, and do not rise to the cognitive operational level of promoting crystalized intelligence via explicit associative learning and/or word recognition decoding strategies facilitated by retrieval of declarative semantic knowledge from long term memory. Accordingly, each set of displayed alphabetic arrays are intentionally selected and arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 3, the predefined library, which supplies the alphabetic arrays for each exercise, comprises stand-alone words, which may or may not contain relational open proto-bigrams. It is contemplated that the predefined library is not limited to stand-alone words, but may also comprise preselected alphabetic arrays.

In an aspect of the present subject matter, the exercises of Example 3 include providing a graphical representation of selected ROPB answer choices to the subject in the form of a ruler when providing the subject with the predefined number of incomplete alphabetic arrays of the exercise. The visual presence of the ruler helps the subject to perform the exercise, by facilitating a fast, visual spatial, sensorial perceptual discrimination of the missing ROPB(s). In other words, the visual presence of the selected ROPB answer choices assists the subject to sensory motor manipulate and sensorially perceptually discriminate the ROPBs, which when inserted in the incomplete alphabetic arrays form stand-alone words.

The methods implemented by the exercises of Example 3 also contemplate situations in which the subject fails to perform the given task. The following failure to perform criteria is applicable to any exercise of the present task in which the subject fails to perform. Specifically, there are two kinds of “failure to perform” criteria. The first kind of “failure to perform” criteria occurs in the event that the subject fails to perform by not click-selecting. In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise to be performed without receiving any feedback about his/her actual performance. In some embodiments, this valid performance time period is 17 seconds.

The second “failure to perform” criteria occurs in the event where the subject fails to make a correct ROPB sensory motor selection for three consecutive attempts. As an operational rule applicable for any failed trial exercise in Example 3, failure to perform results in the automatic display of the next trial exercise to be performed from the predefined number of iterations. Importantly, the subject does not receive any performance feedback during any failed trial exercise and prior to the implementation of the automatic display of the next trial exercise to be performed.

In the event the subject fails to correctly sensorially perceptually discriminate and sensory motor insert the correct ROPB(s) in excess of 2 non-consecutive trial exercises (a single block exercise), then one of the following two options will occur: 1) if the failure to perform occurs for more than 2 non-consecutive trial exercises, then the subject's current block exercise performance is immediately halted. After a time interval of about 2 seconds, the next trial exercise to be performed from the predetermined number of iterations will immediately be displayed and the subject will not be provided with any feedback concerning his/her performance of the previous trial exercise; or 2) when there are no other further trial exercises left to be performed, the subject will be immediately exited from the exercise and returned back to the main menu of the computer program without receiving any performance feedback.

The total duration of the time to complete the exercises of Example 3, as well as the time it took to implement each of the individual trial exercises, are registered in order to help generate an individual and age-gender group performance score. Records of all of the subject's incorrect sensory motor selections from each trial exercise are generated and may be displayed. In general, the subject will perform this task about 6 times during the based brain mental fitness training program.

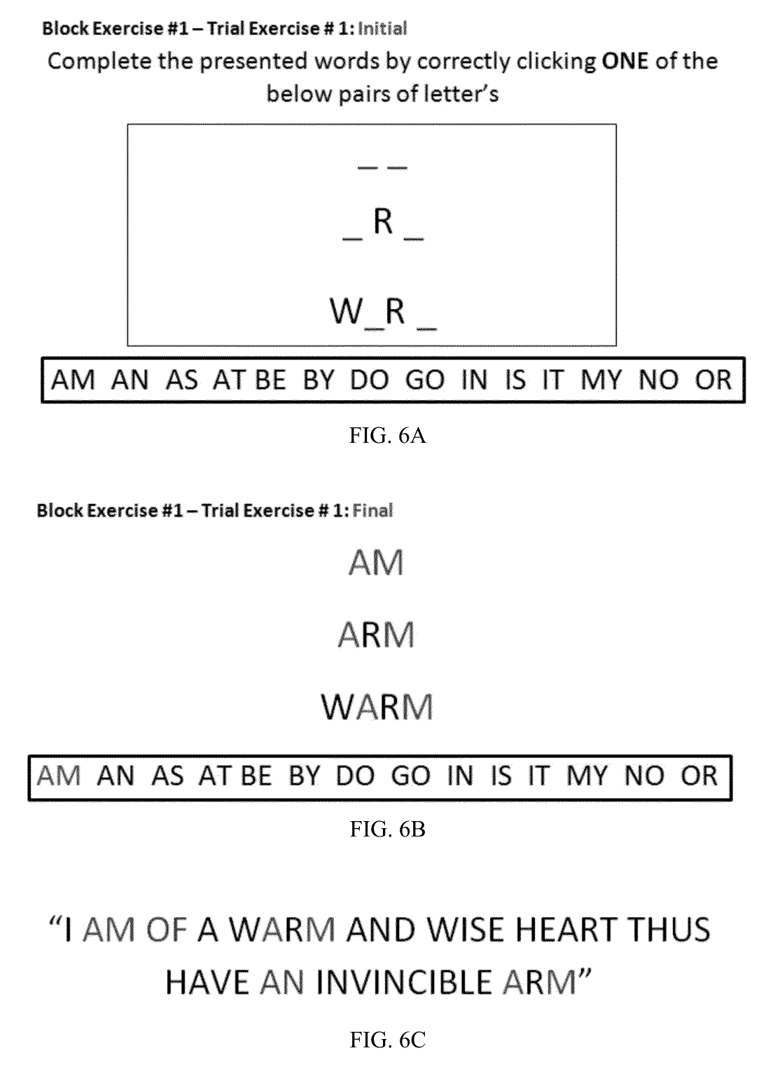

FIGS. 6A-6C depict a non-limiting example of the block 1 exercises for inserting missing same-type relational open proto-bigrams (ROPB) in predefined alphabetic arrays. FIG. 6A shows an arrangement of predefined incomplete alphabetic arrays comprising stand-alone words. A ruler containing direct alphabetical ROPB answer choices is also provided for the subject's sensorial perceptual reference. In this example, the subject is required to sensory motor select the one correct ROPB that completes each of the three provided incomplete alphabetic arrays. In FIG. 6B, the correct sensory motor selected ROPB ‘AM’ is shown inserted in each incomplete alphabetic array. More importantly, the correctly sensory motor inserted ROPB ‘AM’ is immediately highlighted by changing the time perceptual related attribute of font color from default to red. It is noted that ROPB ‘AM’ is also displayed in the ruler with the same red font color.

In FIG. 6C, the completed alphabetic arrays are used to form a grammatically correct sentence that is displayed to the subject. The correctly inserted ROPB ‘AM’ remains highlighted to the subject with the changed time perceptual related attribute of red font color. Further, any open proto-bigram terms, which independently carry a semantic meaning (e.g., ‘OF’), appearing in the sentence are displayed with at least one spatial and/or time perceptual related attribute different from the correctly inserted ROPB ‘AM’ and also different from the remainder of the words forming the grammatically correct sentence. As shown in FIG. 6C, open proto-bigrams ‘OF’ and ‘AN’ are displayed with the time perceptual related attribute of blue font color.

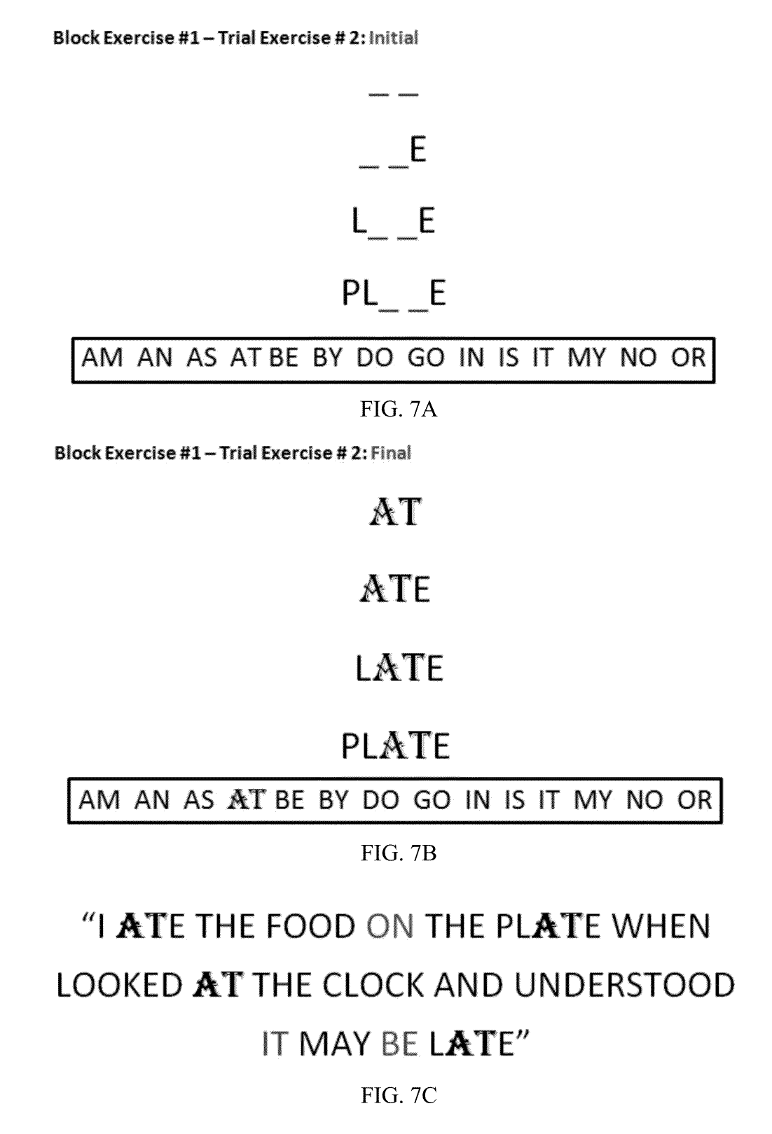

FIGS. 7A-7C depict another non-limiting example of the block 1 exercises for inserting missing same-type relational open proto-bigrams (ROPB) in predefined alphabetic arrays. FIG. 7A shows an arrangement of predefined incomplete alphabetic arrays comprising stand-alone words. A ruler containing direct alphabetical ROPB answer choices is also provided for the subject's sensorial perceptual reference. In this example, the subject is required to sensory motor select the one correct ROPB that completes each of the three provided incomplete alphabetic arrays. In FIG. 7B, the correct sensory motor selected ROPB ‘AT’ is shown inserted in each incomplete alphabetic array. More importantly, the correctly sensory motor inserted ROPB ‘AT’ is immediately highlighted by changing the spatial perceptual related attribute of font type. It is noted that ROPB ‘AT’ is also displayed in the ruler with the same font type change.

In FIG. 7C, the completed alphabetic arrays are used to form a grammatically correct sentence that is displayed to the subject. The correctly inserted ROPB ‘AT’ remains highlighted to the subject with the changed spatial perceptual related attribute of font type. Further, any open proto-bigram terms, which independently carry a semantic meaning (e.g., ‘ON’), appearing in the sentence are displayed with at least one spatial and/or time perceptual related attribute different from the correctly inserted ROPB ‘AT’ and also different from the remainder of the words forming the grammatically correct sentence. As shown in FIG. 7C, open proto-bigrams ‘ON’, ‘IT’, and ‘BE’ are displayed with the time perceptual related attribute of red font color.

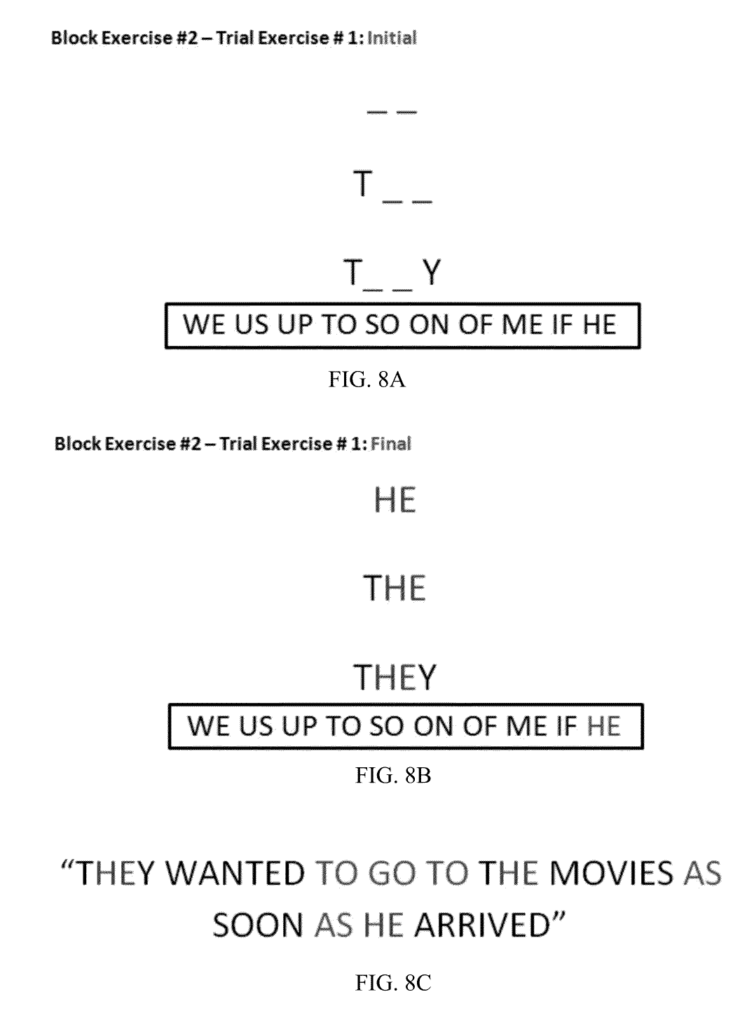

FIGS. 8A-8C depict a non-limiting example of the block 2 exercises for inserting missing same-type relational open proto-bigrams (ROPB) in predefined alphabetic arrays. FIG. 8A shows an arrangement of predefined incomplete alphabetic arrays comprising stand-alone words. A ruler containing inverse alphabetical ROPB answer choices is also provided for the subject's sensorial perceptual reference. In this example, the subject is required to sensory motor select the one correct ROPB that completes each of the three provided incomplete alphabetic arrays. In FIG. 8B, the correct sensory motor selected ROPB ‘HE’ is shown inserted in each incomplete alphabetic array. More importantly, the correctly inserted ROPB ‘HE’ is immediately highlighted by changing the time perceptual related attribute of font color from default to blue. It is noted that ROPB ‘HE’ is also displayed in the ruler with the same blue font color.

In FIG. 8C, the completed alphabetic arrays are used to form a grammatically correct sentence that is displayed to the subject. The correctly inserted ROPB ‘HE’ remains highlighted to the subject with the changed time perceptual related attribute of blue font color. Further, any open proto-bigram terms, which independently carry a semantic meaning (e.g., ‘TO’), appearing in the sentence are displayed with at least one spatial and/or time perceptual related attribute different from the correctly inserted ROPB ‘HE’ and also different from the remainder of the words forming the grammatically correct sentence. As shown in FIG. 8C, open proto-bigrams ‘TO’, ‘GO’, and ‘AS’ are displayed with the time perceptual related attribute of red font color.

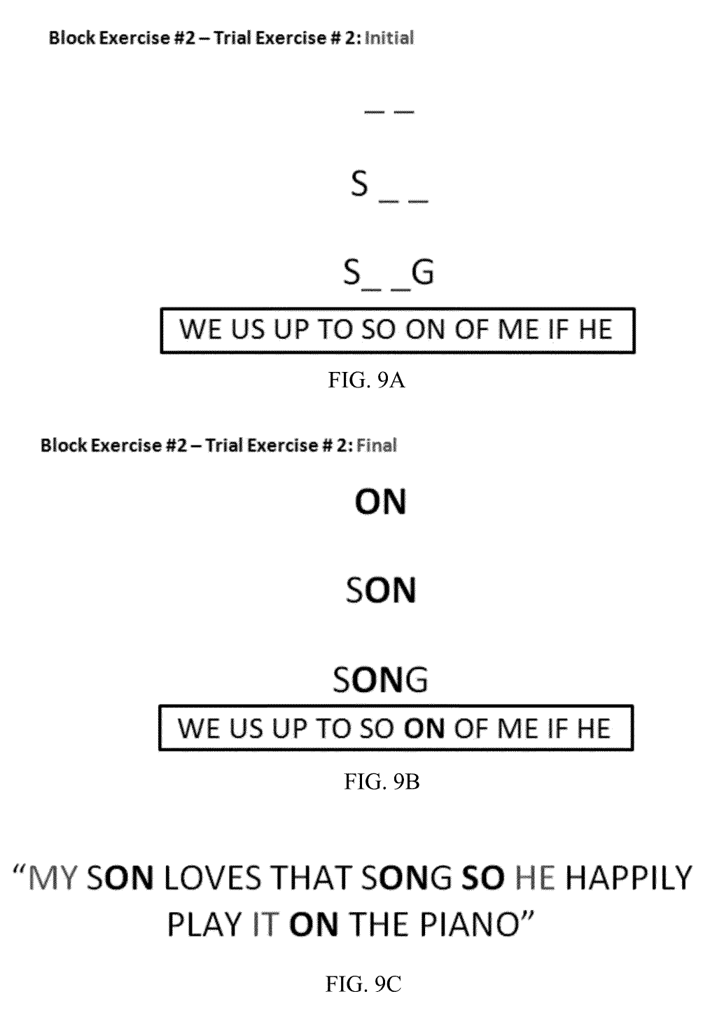

FIGS. 9A-9C depict another non-limiting example of the block 2 exercises for inserting missing same-type relational open proto-bigrams (ROPB) in predefined alphabetic arrays. FIG. 9A shows an arrangement of predefined incomplete alphabetic arrays comprising stand-alone words. A ruler containing inverse alphabetical ROPB answer choices is also provided for the subject's sensorial perceptual reference. In this example, the subject is required to sensory motor select the one correct ROPB that completes each of the three provided incomplete alphabetic arrays. In FIG. 9B, the correct sensory motor selected ROPB ‘ON’ is shown inserted in each incomplete alphabetic array. More importantly, the correctly inserted ROPB ‘ON’ is immediately highlighted by changing the spatial perceptual related attribute of font boldness. It is noted that ROPB ‘ON’ is also displayed in the ruler with the same font boldness change.

In FIG. 9C, the completed alphabetic arrays are used to form a grammatically correct sentence that is displayed to the subject. The correctly inserted ROPB ‘ON’ remains highlighted to the subject with the changed spatial perceptual related attribute of font boldness. Further, any open proto-bigram terms, which independently carry a semantic meaning (e.g., ‘MY’), appearing in the sentence are displayed with at least one spatial and/or time perceptual related attribute different from the correctly inserted ROPB ‘ON’ and also different from the remainder of the words forming the grammatically correct sentence. As shown in FIG. 9C, open proto-bigrams ‘MY’, ‘HE’, and ‘IT’ are displayed with the time perceptual related attribute of red font color.

### Example 4

### Sensorial Perceptual Discrimination of Embedded Same-Type Relational Open Proto-Bigrams (ROPB) in Predefined Alphabetic Arrays

A goal of the exercises presented in Example 4 is to exercise elemental fluid intelligence ability. As mentioned above, the exercises of Example 4 intentionally promote fluid reasoning to quickly enact an abstract conceptual mental web where a number of relational direct ROPBs, inverse ROPBs, and incomplete alphabetic arrays having semantic meanings relationally interrelate, correlate, and cross-correlate with each other such that the processing and real-time manipulation of these alphabetic arrays is maximized in short-term memory. Importantly, the alphabetic arrays utilized herein are purposefully selected and arranged such to not elicit semantic associations and/or comparisons in order to bypass long-term memory processing of stored semantic information in a subject. Consequently, the real-time sensorial perceptual serial search, discrimination, and motor manipulation of the selected alphabetic arrays does not require the subject to automatically retrieve-recall semantic information learned from past experiences to solve the present exercises. Rather, unbeknownst to the subject, the present exercises minimize or eliminate the subject's need to access prior learned and/or stored semantic knowledge by focusing on the intrinsic relational seriality of the alphabetic arrays, even when the presented alphabetic arrays conveys a semantic meaning. The general method of the present exercises is directed to promoting fluid intelligence abilities in a subject by sensorially perceptually discriminating embedded same-type relational open proto-bigrams (ROPB) from predefined alphabetic arrays. Additionally, it should be noted that this general method will also be applicable to the exercises of Example 5.

The method of promoting fluid intelligence abilities in a subject comprises displaying a predefined number of alphabetic arrays containing one or more selected relational open proto-bigrams (ROPB), wherein the alphabetic arrays selected from a predefined library of stand-alone words, which may be assembled in combination to form a sentence. Initially, all of the displayed alphabetic arrays have the same spatial and time perceptual related attributes. The subject is provided with the selected ROPB during a first predefined time period with the underlying purpose of prompting the subject to sensorially perceptually discriminate the displayed alphabetic arrays to which the ROPB is an integral part. At the conclusion of the first predefined time period, the subject is prompted to immediately sensory motor select the discriminated alphabetic arrays containing the selected ROPB. For each ROPB selection, the subject is required to perform a sensory motor activity corresponding to the selection. If the sensory motor selection made by the subject is an incorrect selection, the subject is automatically returned to the initial displaying step of the method without receiving any performance feedback. If the sensory motor selection made by the subject is a correct selection, then the correctly selected ROPB is immediately displayed with at least one different spatial and/or time perceptual related attribute than the displayed alphabetic arrays.

The above steps in the method are repeated for a predetermined number of iterations separated by one or more predefined time intervals. Upon completion of the predetermined number of iterations for each sensorial perceptual discrimination exercise, the subject is provided the results therefor, including all of the correctly performed ROPB sensory motor selections. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 4, the method of promoting fluid intelligence abilities in a subject is implemented through a computer program product. In particular, the subject matter in Example 4 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a predefined number of alphabetic arrays containing one or more selected relational open proto-bigrams (ROPB), wherein the alphabetic arrays are selected from a predefined library of stand-alone words, which may be assembled in combination to form a sentence. Initially, all of the displayed alphabetic arrays have the same spatial and time perceptual related attributes. The subject is provided with the selected ROPB during a first predefined time period with the underlying purpose of prompting the subject to sensorially perceptually discriminate the displayed alphabetic arrays to which the ROPB is an integral part. At the conclusion of the first predefined time period, the subject is prompted to immediately sensory motor select the discriminated alphabetic arrays containing the selected ROPB. For each ROPB selection, the subject is required to perform a sensory motor activity corresponding to the selection. If the sensory motor selection made by the subject is an incorrect selection, the subject is automatically returned to the initial displaying step of the method without receiving any performance feedback. If the sensory motor selection made by the subject is a correct selection, then the correctly selected ROPB is immediately displayed with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections.

In a further aspect of Example 4, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a predefined number of alphabetic arrays containing one or more selected relational open proto-bigrams (ROPB) on the GUI, wherein the alphabetic arrays are selected from a predefined library of stand-alone words, which may be assembled in combination to form a sentence. Initially, all of the displayed alphabetic arrays have the same spatial and time perceptual related attributes. The subject is provided with the selected ROPB on the GUI during a first predefined time period with the underlying purpose of prompting the subject to sensorially perceptually discriminate the displayed alphabetic arrays to which the ROPB is an integral part. At the conclusion of the first predefined time period, the subject is prompted to immediately sensory motor select on the GUI, the discriminated alphabetic arrays containing the selected ROPB. For each ROPB selection, the subject is required to perform a sensory motor activity corresponding to the selection. Once the subject has made a sensory motor selection, the processor determines whether the sensory motor selection is either correct or incorrect. If the sensory motor selection made by the subject is an incorrect selection, the subject is automatically returned to the initial displaying step without receiving any performance feedback. If the sensory motor selection made by the subject is a correct selection, then the correctly selected ROPB is immediately displayed on the GUI with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections.

In a preferred embodiment, Example 4 includes a single block exercise having at least two sequential trial exercises. In each trial exercise, at least one alphabetic array is presented to the subject. Shortly after the alphabetic array(s) is/are displayed, the subject is presented with a selected ROPB. Upon seeing the selected ROPB, the user is required to scan the provided alphabetic array(s) to sensorially perceptually discriminate all instances of the selected ROPB embedded therein. Thereafter, and without delay, the subject must sensory motor select the discriminated alphabetic array(s) containing the selected ROPB. Importantly, the present trial exercises have been designed to reduce cognitive workload by minimizing the dependency of the subject's reasoning and derived inferring skills on real-time manipulation of lexical information by the subject's working memory. Therefore, the selected ROPB is presented as a sensorial perceptual reference for the subject in each trial exercise.

The subject is given a limited time frame within which the subject must validly sensory motor perform the exercises. If the subject does not sensory motor perform a given exercise within the second predefined time interval, also referred to as “a valid performance time period”, then after a delay, which could be of about 2 seconds, the next iteration for the subject to sensory motor perform is automatically displayed. Importantly, the subject is not provided with any performance feedback when failing to sensory motor perform. In one embodiment, the second predefined time interval or maximal valid performance time period for lack of response is from 10-20 seconds, preferably from 15-20 seconds, and more preferably 17 seconds. In another embodiment, the second predefined time interval is at least 30 seconds.

In providing the exercises in Example 4, relational open proto-bigrams (ROPB) may be displayed in either a partial or a complete direct or inverse serial order predefined ROPB list or ruler containing one or more ROPB types to be provided to the subject with the predefined number of alphabetic arrays. The ROPB list, whether partial or complete, serves as a reference for facilitating the subject in sensorially perceptually discriminating embedded ROPB terms to complete each of the trial exercises in Example 4.

In another aspect of the exercises of Example 4, any selected ROPB that the subject is required to sensorially perceptually discriminate from within the provided alphabetic arrays may be highlighted for a first predefined time interval. Highlighting of the selected ROPBs is effectuated to promote the sensorial perceptual discrimination of the same in the provided alphabetic arrays by the subject. The duration of the first predefined time interval is not particularly limited. In one embodiment, the first predefined time interval is any interval between 0.5 and 3 seconds.

In another aspect of the exercises of Example 4, the predefined alphabetic arrays comprise stand-alone words. The stand-alone words may further comprise a carrier word and a sub-word embedded in the carrier word. Any stand-alone word may also be complemented with one or two separable affixes. In another aspect of the exercises of Example 4, the predefined alphabetic arrays comprise sentences. For the case when the provided alphabetic arrays comprise sentences, at least one of the sentences may be a grammatically correct figurative speech sentence which represents a metaphor, irony, idiom, proverb, or adage.

In general, the length of each alphabetic array provided to the subject during any given exercise of Example 4 is not particularly limited. In one embodiment, each of the provided alphabetic arrays has a maximum length of seven letters.

In a further aspect of the exercises of Example 4, the location of a correctly sensory motor selected ROPB in the alphabetic array(s) impacts the change(s) in spatial and/or time perceptual related attribute(s). For example, a correctly sensory motor selected ROPB located in the right visual field of the subject will have a different spatial and/or time perceptual related attribute change than a correctly sensory motor selected ROPB located in the left visual field of the subject. In another example, a correctly sensory motor selected ROPB that is located at the beginning of a stand-alone word from the displayed alphabetic array may have a different spatial and/or time perceptual related attribute than a correctly sensory motor selected ROPB located at the end of a stand-alone word. Further, the difference in spatial and/or time perceptual related attribute changes between a correctly sensory motor selected ROPB at the beginning of a stand-alone word and a correctly sensory motor selected ROPB at the end of a stand-alone word will occur irrespective of and in addition to the location of the ROPB in either the left or right visual field of a subject.

In a further aspect of the exercises of Example 4, the at least one changed spatial and/or time perceptual related attribute for a correctly selected ROPB is an orthographical topological expansion. The orthographical topological expansion may occur where the correctly sensory motor selected ROPB is of any type and is located at the beginning of the first word in a sentence, or where the correctly sensory motor selected ROPB does not have any letters contained in between the letter pair forming the ROPB and is located at the end of the last word in a sentence. Specifically, the orthographical topological expansion of a symbol representing a letter or number may be realized by graphically changing the orthographical morphology of the symbol at one or more vertices and/or terminal points of the symbol's graphical representation. Graphical changes may be selected from the group including: predefined changes of color, brightness, and/or thickness of one or more vertices; adding a preselected straight line length having a predefined spatial orientation; and combinations thereof.

In another non-limiting example, the orthographical topological expansion may be performed on letters of an alphabetic set array which is segmented into a predefined number of letter sectors. For example, an alphabetic set array may be segmented into at least a first and a last letter sector, where each letter sector has a selected number of letters. In one example, the last ordinal position in the last letter sector is occupied by the letter ‘Z’ in a direct alphabetic set array while the first ordinal position of the first letter sector is occupied by the letter ‘A’ in a direct alphabetic set array. It is further contemplated that the letters of the last letter sector will have a greater number of graphical changes than the letters of any preceding letter sector. Likewise, the letters of the first letter sector will have a fewer number of graphical changes than the letters of any following letter sector. In a preferred embodiment, the orthographical morphology changes will only be performed on the letters of a correctly sensory motor selected ROPB.

In another non-limiting example, the orthographical topological expansion may be performed on symbols of a sentence, where the sentence is segmented into a predefined number of sentence sectors. For example, the sentence may be segmented into at least a first and a last sentence sector. In one example, the symbols of the last sentence sector will have a greater number of graphical changes than the symbols of any preceding sentence sector. Likewise, the symbols of the first sentence sector will have a fewer number of graphical changes than the symbols of any following sentence sector. In a preferred embodiment, the orthographical morphology changes will only be performed on the letters of a correctly sensory motor selected ROPB.

As discussed above, upon sensory motor selection of a correct ROPB answer by the subject, the correctly sensory motor selected ROPB is immediately displayed with a spatial and/or time perceptual related attribute that is different from the displayed alphabetic arrays. The changed spatial and/or time perceptual related attributes of the two symbols forming the correctly sensory motor selected ROPB may include, without being limited to, the following: symbol color, symbol sound, symbol size, symbol font style, symbol spacing, symbol case, boldness of symbol, angle of symbol rotation, symbol mirroring, or combinations thereof. Furthermore, the symbols of the correctly sensory motor selected ROPB may be displayed with a time perceptual attribute “flickering” behavior in order to further highlight the differences in perceptual related attributes thereby facilitating the subject's sensorial perceptual discrimination of the differences.

As previously indicated above with respect to the general methods for implementing the present subject matter, the exercises in Example 4 are useful in promoting fluid intelligence abilities in the subject through the sensorial motor and sensorial perceptual domains that jointly engage when the subject performs the given exercise. That is, the serial sensorial perceptual search, discrimination, and/or sensory motor manipulating of relational open proto-bigrams by the subject engages body movements to execute sensory motor selecting the correct ROPB, and combinations thereof. The motor activity engaged within the subject may be any motor activity jointly involved in the sensorial perception of the complete and incomplete alphabetic arrays. While any body movements can be considered motor activity implemented by the subject's body, the present subject matter is mainly concerned with implemented body movements selected from body movements of the subject's eyes, head, neck, arms, hands, fingers and combinations thereof.

In a preferred embodiment, the sensory motor activity the subject is required to perform is selected from the group including: mouse-clicking on the ROPB, voicing the ROPB, and touching the ROPB with a finger or stick.

By requesting that the subject engage in specific degrees of body motor activity, the exercises of Example 4 require the subject to bodily-ground cognitive fluid intelligence abilities. The exercises of Example 4 cause the subject to revisit an early developmental realm wherein the subject implicitly acted and/or experienced a fast and efficient enactment of fluid cognitive abilities when specifically dealing with the serial pattern sensorial perceptual discrimination of non-concrete symbol terms and/or symbol terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 4 downplay or mitigate, as much as possible, the subject's need to recall-retrieve and use verbal semantic or episodic memory knowledge in order to support or assist inductive reasoning strategies to problem solve the exercises. The exercises of Example 4 mainly concern promoting fluid intelligence, in general, and do not rise to the cognitive operational level of promoting crystalized intelligence via explicit associative learning and/or word recognition decoding strategies facilitated by retrieval of declarative semantic knowledge from long term memory. Accordingly, each set of displayed alphabetic arrays are intentionally selected and arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 4, the predefined library, which supplies the alphabetic arrays for each exercise, comprises stand-alone words, which may be assembled in combination to form sentences, and preselected alphabetic arrays which may or may not contain relational open proto-bigrams.

In an aspect of the present subject matter, the exercises of Example 4 include providing a graphical representation of the selected ROPB to the subject when providing the subject with the predefined number of alphabetic arrays of the exercise. The visual presence of the selected ROPB helps the subject to perform the exercise, by facilitating a fast, visual spatial, sensorial perceptual discrimination of the presented ROPB. In other words, the visual presence of the selected ROPB assists the subject to sensory motor manipulate and sensorially perceptually discriminate the selected ROPB from within the displayed alphabetic arrays.

The methods implemented by the exercises of Example 4 also contemplate situations in which the subject fails to perform the given task. The following failure to perform criteria is applicable to any exercise of the present task in which the subject fails to perform. Specifically, there are two kinds of “failure to perform” criteria. The first kind of “failure to perform” criteria occurs in the event that the subject fails to perform by not click-selecting. In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise to be performed without receiving any feedback about his/her actual performance. In some embodiments, this valid performance time period is 17 seconds.

The second “failure to perform” criteria occurs in the event where the subject fails to make a correct ROPB sensory motor selection for three consecutive attempts. As an operational rule applicable for any failed trial exercise in Example 4, failure to perform results in the automatic display of the next trial exercise to be performed from the predefined number of iterations. Importantly, the subject does not receive any performance feedback during any failed trial exercise and prior to the implementation of the automatic display of the next trial exercise to be performed.

In the event the subject fails to correctly sensorially perceptually discriminate and sensory motor select the correct ROPB(s) in excess of 2 non-consecutive trial exercises (a single block exercise), then one of the following two options will occur: 1) if the failure to sensory motor perform occurs for more than 2 non-consecutive trial exercises, then the subject's current block-exercise sensory motor performance is immediately halted. After a time interval of about 2 seconds, the next trial exercise to be performed from the predetermined number of iterations will immediately be displayed and the subject will not be provided with any feedback concerning his/her performance of the previous trial exercise; or 2) when there are no other further trial exercises left to be performed, the subject will be immediately exited from the exercise and returned back to the main menu of the computer program without receiving any performance feedback.

The total duration of the time to complete the exercises of Example 4, as well as the time it took to implement each of the individual trial exercises, are registered in order to help generate an individual and age-gender group performance score. Records of all of the subject's incorrect sensory motor selections from each trial exercise are generated and may be displayed. In general, the subject will perform this task about 6 times during the based brain mental fitness training program.

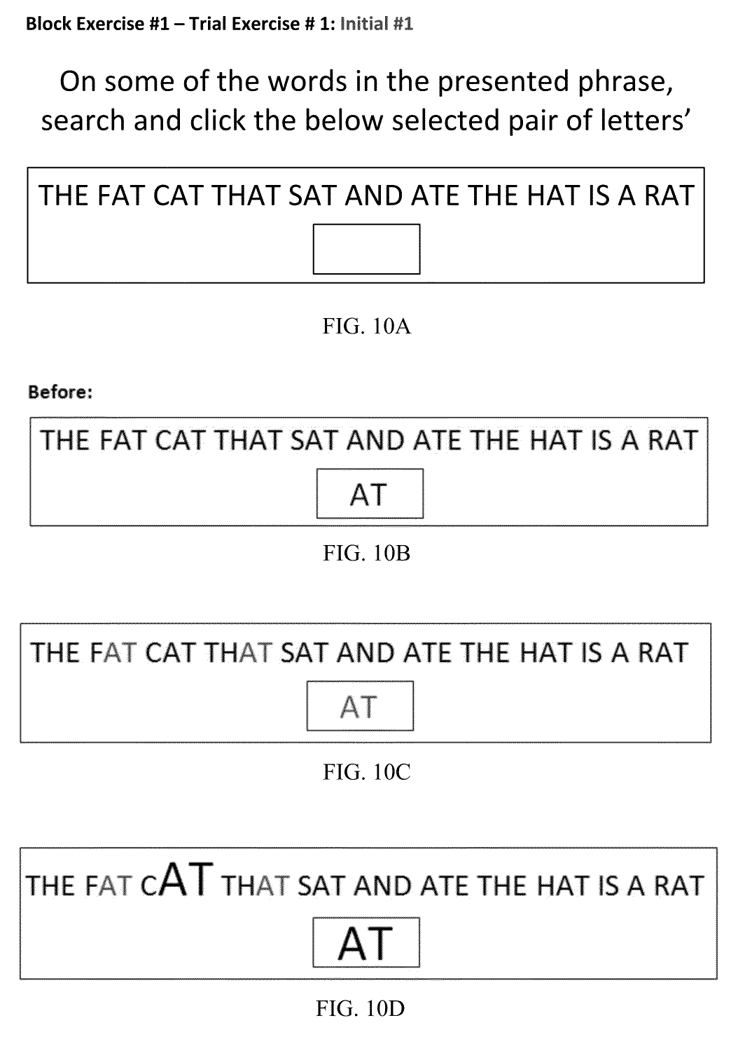

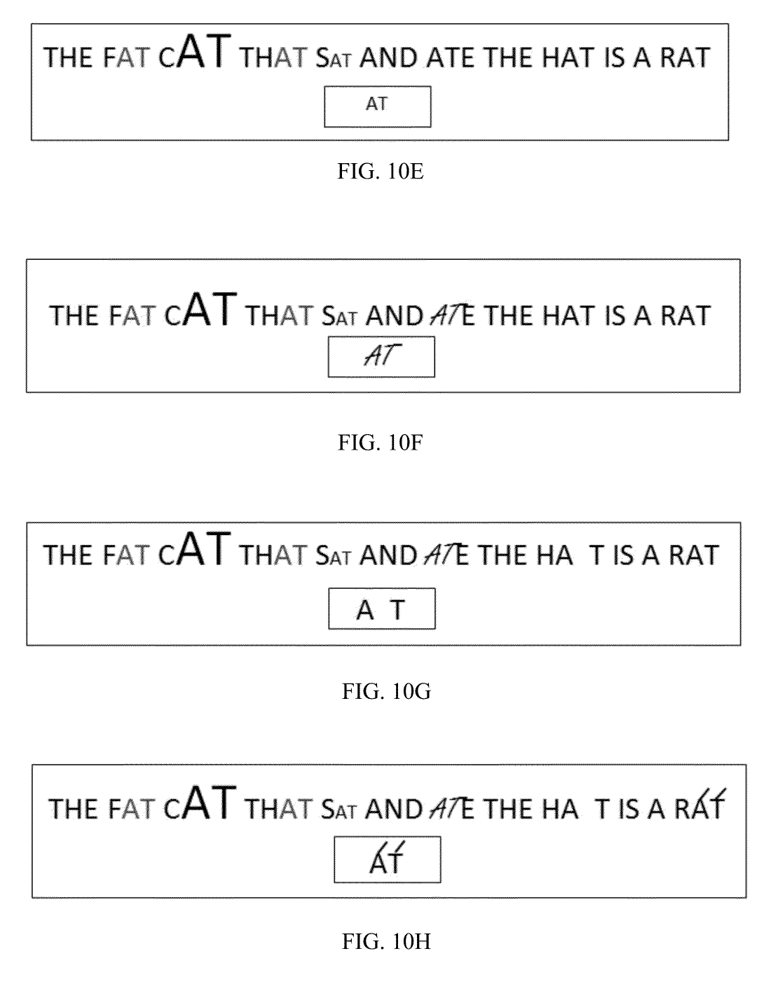

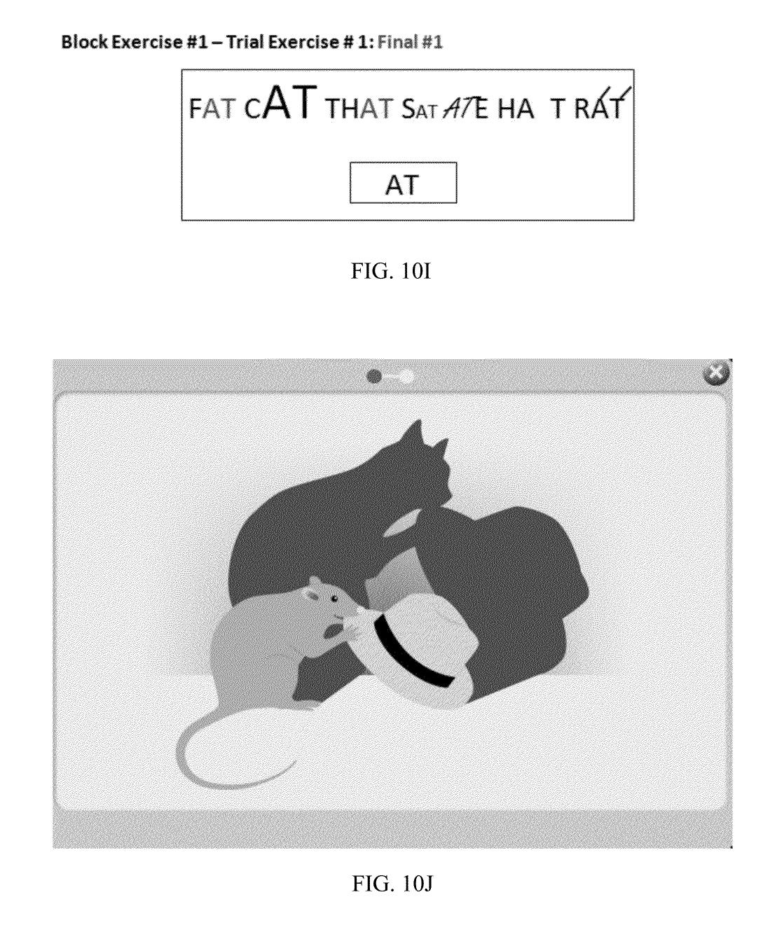

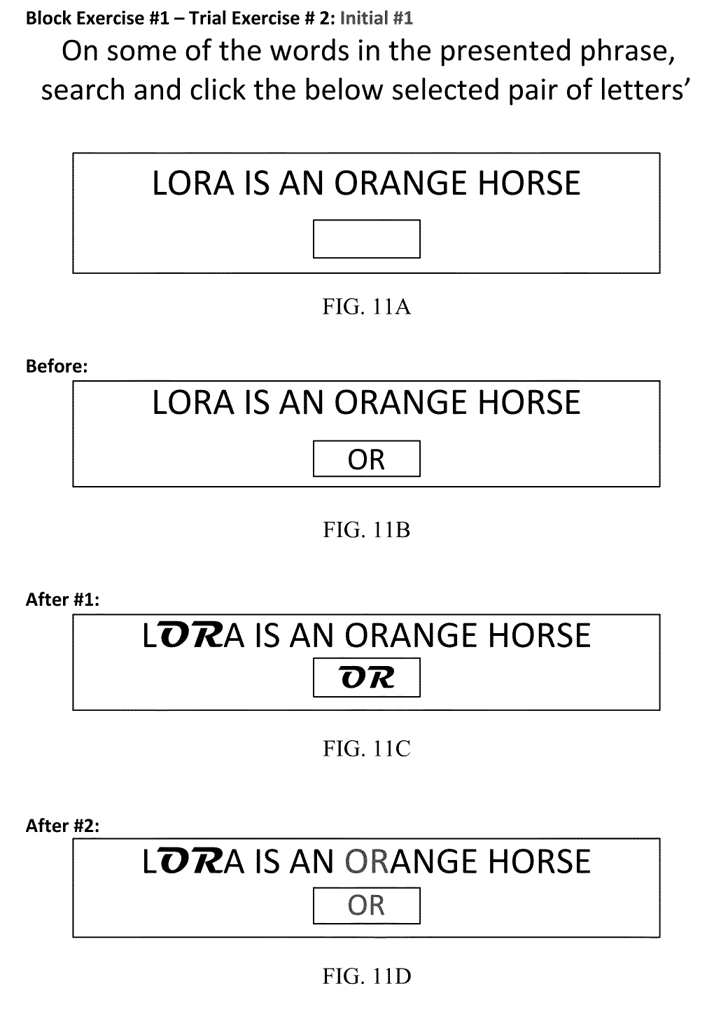

FIGS. 10A-10J depict a number of non-limiting examples of the exercises for sensorially perceptually discriminating same-type relational open proto-bigrams (ROPB) in predefined alphabetic arrays. FIG. 10A shows a selected alphabetic array comprising a grammatically correct figurative speech sentence. In FIG. 10B, the subject is provided the selected alphabetic array and the selected ROPB ‘AT’, which the subject is required to sensorially perceptually discriminate all instances thereof in the provided alphabetic array. FIGS. 10C-10H all illustrate correct sensory motor selections of the selected ROPB ‘AT’. More importantly, the correctly sensory motor selected ROPB ‘AT’ is highlighted by changing at least one time and/or spatial perceptual related attribute for each correctly discriminated occurrence in the alphabetic array. Some non-limiting examples of time and/or spatial perceptual related attributes changes include font color (FIG. 10C), font size (FIG. 10D, 10E), font boldness (FIG. 10D), font type (FIG. 10F), font spacing (FIG. 10G), and font orthographic topological expansion (FIG. 10H).

In FIG. 10I, all of the individual words from the selected grammatically correct figurative speech sentence that do not contain the selected ROPB are removed, leaving only words containing the selected ROPB. As shown in FIG. 10I, all of the correctly sensory motor selected ROPBs retain the changed time and/or spatial perceptual related attributes when the other words from the alphabetic array are removed. Lastly, in FIG. 10J a pictorial image of the words forming the selected grammatically correct figurative speech sentence from the exercise depicted in FIGS. 10A-10I is shown.

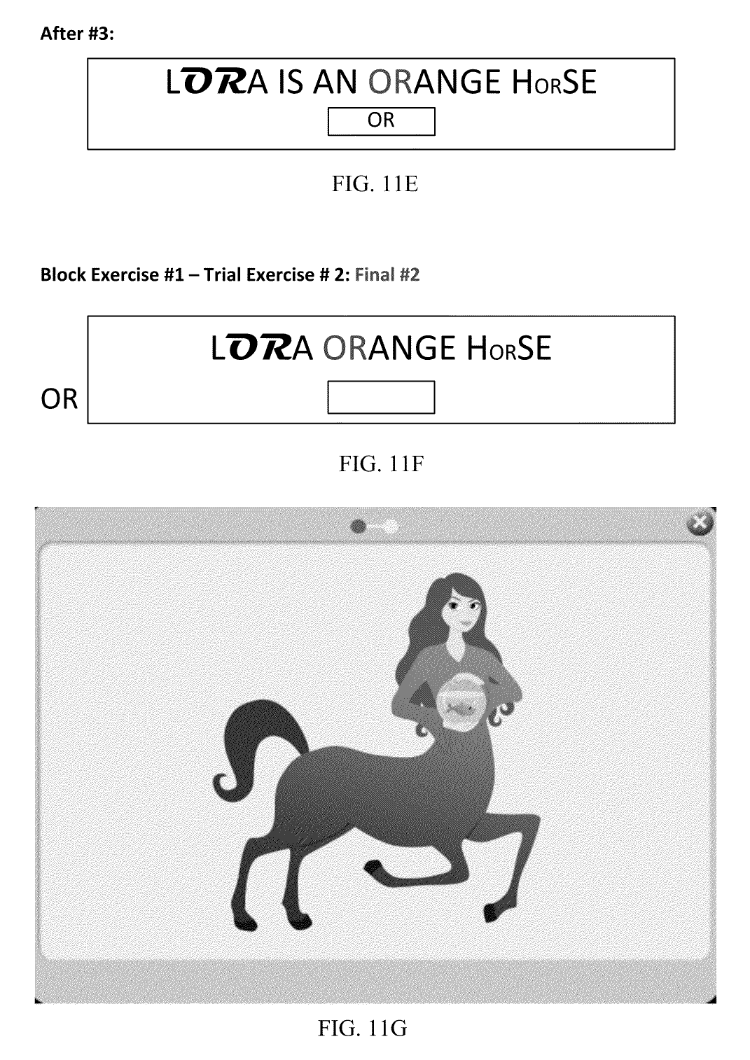

FIGS. 11A-11G depict another non-limiting example of the exercises for sensorially perceptually discriminating same-type relational open proto-bigrams (ROPB) in predefined alphabetic arrays. FIG. 11A shows a selected alphabetic array comprising a grammatically correct figurative speech sentence. In FIG. 11B, the subject is provided the selected alphabetic array and the selected ROPB ‘OR’, which the subject is required to sensorially perceptually discriminate all instances thereof in the provided alphabetic array. FIGS. 11C-11E each illustrate correct sensory motor selections of the selected ROPB ‘OR’. More importantly, the correctly sensory motor selected ROPB ‘OR’ is highlighted by changing at least one time and/or spatial perceptual related attribute in each correctly discriminated occurrence in the alphabetic array. Some non-limiting examples of time and/or spatial perceptual attributes changes include font type (FIG. 11C), font color (FIG. 11D), and font size (FIG. 11E).

In FIG. 11F, all of the individual words from the selected grammatically correct figurative speech sentence that do not contain the selected ROPB are removed, leaving only words containing the selected ROPB. As shown in FIG. 11F, all of the correctly sensory motor selected ROPBs retain the changed time and/or spatial perceptual related attributes when the other words from the alphabetic array are removed. Lastly, in FIG. 11G a pictorial image of the words forming the selected grammatically correct figurative speech sentence from the exercise depicted in FIGS. 11A-11F is shown.

### Example 5

### Sensorial Perceptual Discrimination of Embedded Different-Type Relational Open Proto-Bigrams (ROPB) in Predefined Alphabetic Arrays

A goal of the exercises presented in Example 5 is to exercise elemental fluid intelligence ability. Similar to Example 4, the exercises of Example 5 intentionally promote fluid reasoning to quickly enact an abstract conceptual mental web where a number of direct ROPBs, inverse ROPBs, and incomplete alphabetic arrays having semantic meanings relationally interrelate, correlate, and cross-correlate with each other such that the processing and real-time manipulation of these alphabetic arrays is maximized in short-term memory. Importantly, the alphabetic arrays utilized herein are purposefully selected and arranged such to not elicit semantic associations and/or comparisons in order to bypass long-term memory processing of stored semantic information in a subject. Consequently, the real-time sensorial perceptual serial search, discrimination, and motor manipulation of the selected alphabetic arrays does not require the subject to automatically retrieve-recall semantic information learned from past experiences to solve the present exercises. Rather, unbeknownst to the subject, the present exercises minimize or eliminate the subject's need to access prior learned and/or stored semantic knowledge by focusing on the intrinsic relational seriality of the alphabetic arrays, even when the alphabetic array(s) conveys a semantic meaning.

The general method of the present exercises is directed to promoting fluid intelligence abilities in a subject by sensorial perceptual discriminating embedded different-type relational open proto-bigrams (ROPB) from predefined alphabetic arrays. Examples 4 and 5, as described herein, share similarities in operation but differ in the type of ROPB selections. In other words, the correct ROPB selections in the non-limiting examples of Example 4 are of the same type or are repeated whereas the selected ROPBs depicted in the exercises of Example 5 are different or do not repeat.

The method of promoting fluid intelligence abilities in a subject comprises displaying a predefined number of alphabetic arrays containing one or more selected relational open proto-bigrams (ROPB), wherein the alphabetic arrays are selected from a predefined library of stand-alone words, which may be assembled in combination to form a sentence. Initially, all of the displayed alphabetic arrays have the same spatial and time perceptual related attributes. The subject is provided with the selected ROPB during a first predefined time period with the underlying purpose of prompting the subject to sensorially perceptually discriminate the displayed alphabetic arrays to which the ROPB is an integral part. At the conclusion of the first predefined time period, the subject is prompted to immediately sensory motor select the discriminated alphabetic arrays containing the selected ROPB. For each ROPB selection, the subject is required to perform a sensory motor activity corresponding to the selection. If the sensory motor selection made by the subject is an incorrect selection, the subject is automatically returned to the initial displaying step of the method without receiving any performance feedback. If the sensory motor selection made by the subject is a correct selection, then the correctly selected ROPB is immediately displayed with at least one different spatial and/or time perceptual related attribute than the displayed alphabetic arrays.

The above steps in the method are repeated for a predetermined number of iterations separated by one or more predefined time intervals. Upon completion of the predetermined number of iterations for each sensorial perceptual discrimination exercise, the subject is provided with the results thereof, including all of the correctly performed ROPB sensory motor selections. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 5, the method of promoting fluid intelligence abilities in a subject is implemented through a computer program product. In particular, the subject matter in Example 5 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a predefined number of alphabetic arrays containing one or more selected relational open proto-bigrams (ROPB), wherein the alphabetic arrays are selected from a predefined library of stand-alone words, which may be assembled in combination to form a sentence. Initially, all of the displayed alphabetic arrays have the same spatial and time perceptual related attributes. The subject is provided with the selected ROPB during a first predefined time period with the underlying purpose of prompting the subject to sensorially perceptually discriminate the displayed alphabetic arrays to which the selected ROPB is an integral part. At the conclusion of the first predefined time period, the subject is prompted to immediately sensory motor select the discriminated alphabetic arrays containing the selected ROPB. For each ROPB selection, the subject is required to perform a sensory motor activity corresponding to the selection. If the sensory motor selection made by the subject is an incorrect selection, the subject is automatically returned to the initial displaying step of the method without receiving any performance feedback. If the sensory motor selection made by the subject is a correct selection, then the correctly selected ROPB is immediately displayed with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections.

In a further aspect of Example 5, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a predefined number of alphabetic arrays containing one or more selected relational open proto-bigrams (ROPB) on the GUI, wherein the alphabetic arrays are selected from a predefined library of stand-alone words, which may be assembled in combination to form a sentence. Initially, all of the displayed alphabetic arrays have the same spatial and time perceptual related attributes. The subject is provided with the selected ROPB on the GUI during a first predefined time period with the underlying purpose of prompting the subject to sensorially perceptually discriminate the displayed alphabetic arrays to which the ROPB is an integral part. At the conclusion of the first predefined time period, the subject is prompted to immediately sensory motor select on the GUI, the discriminated alphabetic arrays containing the selected ROPB. For each ROPB selection, the subject is required to perform a sensory motor activity corresponding to the selection. Once the subject has made a sensory motor selection, the processor determines whether the sensory motor selection is either correct or incorrect. If the sensory motor selection made by the subject is an incorrect selection, the subject is automatically returned to the initial displaying step without receiving any performance feedback. If the sensory motor selection made by the subject is a correct selection, then the correctly selected ROPB is immediately displayed on the GUI with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed ROPB sensory motor selections.

In a preferred embodiment, Example 5 includes a single block exercise having at least two sequential trial exercises. In each trial exercise, at least one alphabetic array is presented to the subject. Shortly after the alphabetic array(s) is/are displayed, the subject is presented with a selected ROPB. Upon seeing the selected ROPB, the user is required to scan the provided alphabetic array(s) to sensorially perceptually discriminate all instances of the selected ROPB embedded therein. Thereafter, and without delay, the subject must sensory motor selected the discriminated alphabetic array(s) containing the selected ROPB. Importantly, the present trial exercises have been designed to reduce cognitive workload by minimizing the dependency of the subject's reasoning and derived inferring skills on real-time manipulation of lexical information by the subject's working memory. Therefore, the selected ROPB is presented as a sensorial perceptual reference for the subject in each trial exercise.

The subject is given a limited time frame within which the subject must validly sensory motor perform the exercises. If the subject does not sensory motor perform a given exercise within the second predefined time interval, also referred to as “a valid performance time period”, then after a delay, which could be of about 2 seconds, the next iteration for the subject to perform is automatically displayed. Importantly, the subject is not provided with any performance feedback when failing to sensory motor perform. In one embodiment, the second predefined time interval or maximal valid performance time period for lack of response is from 10-20 seconds, preferably from 15-20 seconds, and more preferably 17 seconds. In another embodiment, the second predefined time interval is at least 30 seconds.

In providing the exercises in Example 5, relational open proto-bigrams (ROPB) may be displayed in either a partial or a complete direct or inverse serial order of predefined ROPB list or ruler containing one or more ROPB types to be provided to the subject with the predefined number of alphabetic arrays. The ROPB list, whether partial or complete, serves as a reference for the subject in sensorially perceptually discriminating embedded ROPB terms to complete each of the trial exercises in Example 5.

In another aspect of the exercises of Example 5, any selected ROPB that the subject is required to sensorially perceptually discriminate from within the provided alphabetic arrays may be highlighted for a first predefined time interval. Highlighting of the selected ROPBs is effectuated to promote the sensorial perceptual discrimination of the same in the provided alphabetic arrays by the subject. The duration of the first predefined time interval is not particularly limited. In one embodiment, the first predefined time interval is any interval between 0.5 and 3 seconds.

In another aspect of the exercises of Example 5, the predefined alphabetic arrays comprise stand-alone words. The stand-alone words may further comprise a carrier word and a sub-word embedded in the carrier word. Any stand-alone word may also be complemented with one or two separable affixes. In another aspect of the exercises of Example 5, the predefined alphabetic arrays comprise sentences. For the case when the provided alphabetic arrays comprise sentences, at least one of the sentences may be a grammatically correct figurative speech type sentence represents a metaphor, irony, idiom, proverb, or adage.

In general, the length of each alphabetic array provided to the subject during any given exercise of Example 5 is not particularly limited. In one embodiment, each of the provided alphabetic arrays has a maximum length of seven letters.

In a further aspect of the exercises of Example 5, the location of a correctly sensory motor selected ROPB in the alphabetic array(s) impacts the change(s) in spatial and/or time perceptual related attribute(s). For example, a correctly sensory motor selected ROPB located in the right visual field of the subject will have a different spatial and/or time perceptual related attribute change than a correctly sensory motor selected ROPB located in the left visual field of the subject. In another example, a correctly sensory motor selected ROPB that is located at the beginning of a stand-alone word from the displayed alphabetic array may have a different spatial and/or time perceptual related attribute than a correctly sensory motor selected ROPB located at the end of a stand-alone word. Further, the difference in spatial and/or time perceptual related attribute changes between a correctly sensory motor selected ROPB at the beginning of a stand-alone word and a correctly sensory motor selected ROPB at the end of a stand-alone word will occur irrespective of and in addition to the location of the ROPB in either the left or right visual field of a subject.

As discussed above, upon sensory motor selection of a correct answer by the subject, the correctly selected ROPB is immediately displayed with a spatial and/or time perceptual related attribute that is different from the displayed alphabetic arrays. The changed spatial or time perceptual related attributes of the two symbols forming the correctly selected ROPB may include, without being limited to, the following: symbol color, symbol sound, symbol size, symbol font style, symbol spacing, symbol case, boldness of symbol, angle of symbol rotation, symbol mirroring, or combinations thereof. Furthermore, the symbols of the correctly selected ROPB may be displayed with a time perceptual related attribute “flickering” behavior in order to further highlight the differences in perceptual related attributes thereby facilitating the subject's sensorial perceptual discrimination of the differences.

As previously indicated above with respect to the general methods for implementing the present subject matter, the exercises in Example 5 are useful in promoting fluid intelligence abilities in the subject through the sensorial motor and sensorial perceptual domains that jointly engage when the subject performs the given exercise. That is, the serial manipulating and sensorial perceptual discrimination of relational open proto-bigrams by the subject engages body movements to execute sensory motor selecting the correct ROPB, and combinations thereof. The sensory motor activity engaged within the subject may be any sensory motor activity jointly involved in the sensorial perception of the complete and incomplete alphabetic arrays. While any body movements can be considered sensory motor activity implemented by the subject's body, the present subject matter is mainly concerned with implemented body movements selected from body movements of the subject's eyes, head, neck, arms, hands, fingers and combinations thereof.

In a preferred embodiment, the sensory motor activity the subject is required to perform is selected from the group including: mouse-clicking on the ROPB, voicing the ROPB, and touching the ROPB with a finger or stick.

By requesting that the subject engage in specific degrees of body motor activity, the exercises of Example 5 require the subject to bodily-ground cognitive fluid intelligence abilities. The exercises of Example 5 cause the subject to revisit an early developmental realm wherein the subject implicitly acted and/or experienced a fast and efficient enactment of fluid cognitive abilities when specifically dealing with the serial pattern sensorial perceptual discrimination of non-concrete symbol terms and/or symbol terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 5 downplay or mitigate, as much as possible, the subject's need to recall-retrieve and use verbal semantic or episodic memory knowledge in order to support or assist inductive reasoning strategies to problem solve the exercises. The exercises of Example 5 mainly concern promoting fluid intelligence, in general, and do not rise to the cognitive operational level of promoting crystalized intelligence via explicit associative learning and/or word recognition decoding strategies facilitated by retrieval of declarative semantic knowledge from long term memory. Accordingly, each set of displayed alphabetic arrays are intentionally selected and arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 5, the predefined library, which supplies the alphabetic arrays for each exercise, comprises stand-alone words, which may be assembled in combination to form sentences, and preselected alphabetic arrays which may or may not contain relational open proto-bigrams.

In an aspect of the present subject matter, the exercises of Example 5 include providing a graphical representation of the selected ROPB to the subject when providing the subject with the predefined number of alphabetic arrays of the exercise. The visual presence of the selected ROPB helps the subject to perform the exercise, by facilitating a fast, visual spatial, sensorial perceptual discrimination of the presented ROPB. In other words, the visual presence of the selected ROPB assists the subject to sensory motor manipulate and sensorially perceptually discriminate the selected ROPB from within the displayed alphabetic arrays.

The methods implemented by the exercises of Example 5 also contemplate situations in which the subject fails to perform the given task. The following failure to perform criteria is applicable to any exercise of the present task in which the subject fails to perform. Specifically, there are two kinds of “failure to perform” criteria. The first kind of “failure to perform” criteria occurs in the event that the subject fails to perform by not click-selecting, In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise to be performed without receiving any feedback about his/her actual performance. In some embodiments, this valid performance time period is 17 seconds.

The second “failure to perform” criteria occurs in the event where the subject fails to make a correct sensory motor ROPB selection for three consecutive attempts. As an operational rule applicable for any failed trial exercise in Example 5, failure to sensory motor perform results in the automatic display of the next trial exercise to be performed from the predefined number of iterations. Importantly, the subject does not receive any performance feedback during any failed trial exercise and prior to the implementation of the automatic display of the next trial exercise to be performed.

In the event the subject fails to correctly sensorially perceptually discriminate and sensory motor select the correct ROPB(s) in excess of 2 non-consecutive trial exercises (a single block exercise), then one of the following two options will occur: 1) if the failure to sensory motor perform occurs for more than 2 non-consecutive trial exercises, then the subject's current block-exercise performance is immediately halted. After a time interval of about 2 seconds, the next trial exercise to be performed from the predetermined number of iterations will immediately be displayed and the subject will not be provided with any feedback concerning his/her performance of the previous trial exercise; or 2) when there are no other further trial exercises left to be performed, the subject will be immediately exited from the exercise and returned back to the main menu of the computer program without receiving any performance feedback.

The total duration of the time to complete the exercises of Example 5, as well as the time it took to implement each of the individual trial exercises, are registered in order to help generate an individual and age-gender group performance score. Records of all of the subject's incorrect sensory motor selections from each trial exercise are generated and may be displayed. In general, the subject will perform this task about 6 times during the based brain mental fitness training program.

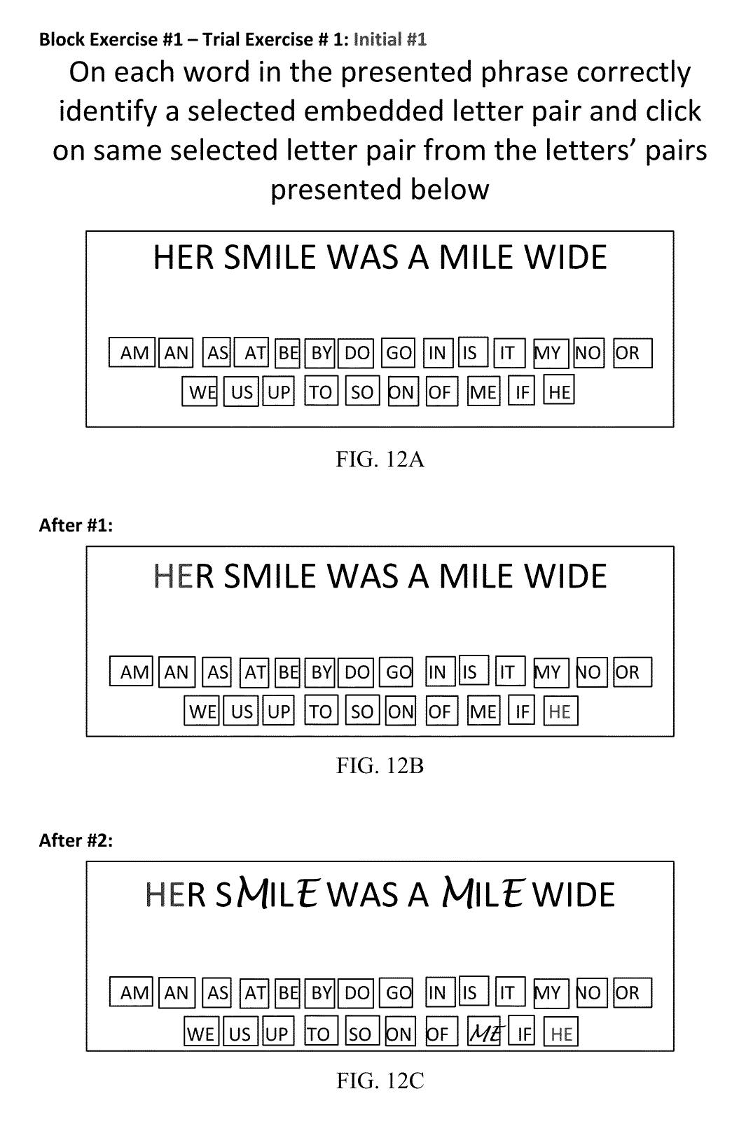

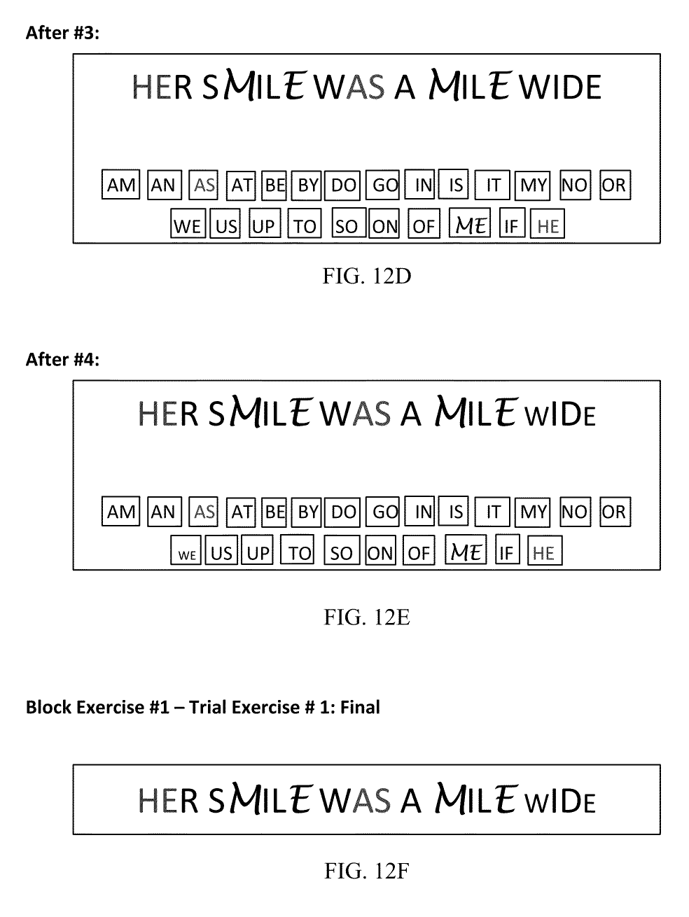

FIGS. 12A-12F depict a number of non-limiting examples of the exercises for sensorially perceptually discriminating different-type relational open proto-bigrams (ROPB) embedded in predefined alphabetic arrays. FIG. 12A shows a selected alphabetic array comprising a figurative speech sentence. A ruler containing both direct and inverse alphabetical ROPB possible answer choices is also provided to the subject with the selected figurative speech sentence. FIG. 12B shows the correctly sensory motor selected ROPB ‘HE’. More importantly, the ROPB ‘HE’ is highlighted in both the provided sentence and the ruler by a change in the time perceptual related attribute of font color from default to blue. FIG. 12C shows the next correctly sensory motor selected ROPB ‘ME’. Instances of the ROPB ‘ME’ in the provided sentence and the ruler are highlighted by a change in the spatial perceptual related attribute of font type. FIGS. 12D and 12E also depict correct ROPB sensory motor selections. In FIG. 12D, the correctly sensory motor selected ROPB ‘AS’ is highlighted in the provided sentence and the ruler by a change in the time perceptual related attribute of font color from default to red. In FIG. 12E, the last correctly sensory motor selected ROPB ‘WE’ is shown as highlighted in the provided sentence and the ruler by a change in the spatial perceptual related attribute of font size.

Finally, in FIG. 12F, only the provided sentence is displayed with each of the correctly sensory motor selected different ROPBs, ‘HE’, ‘ME’, ‘AS’, and ‘WE’ highlighted by their respective changed time and/or spatial perceptual related attributes.

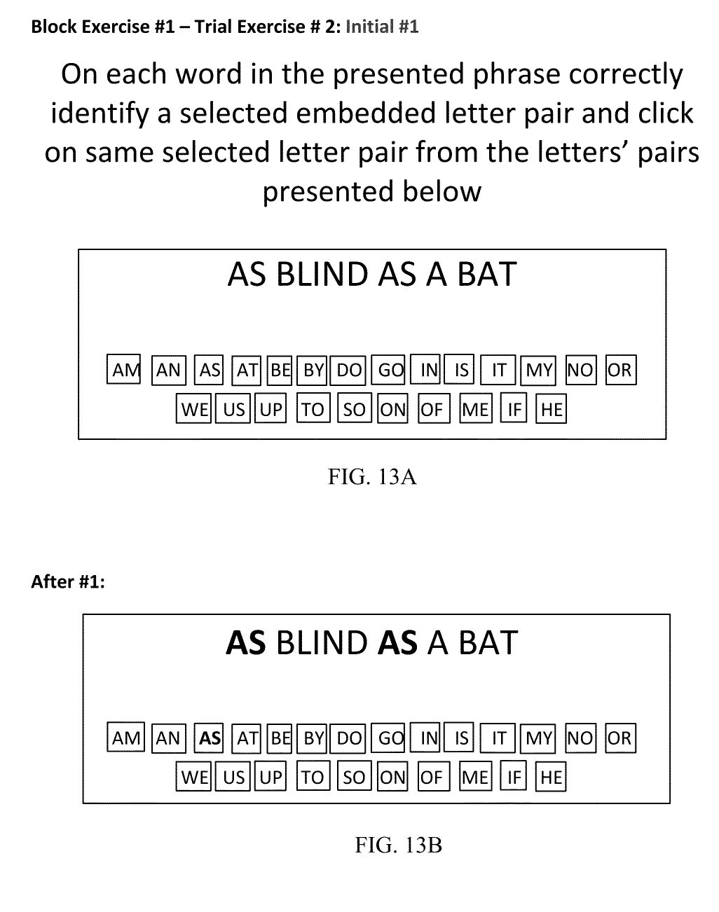

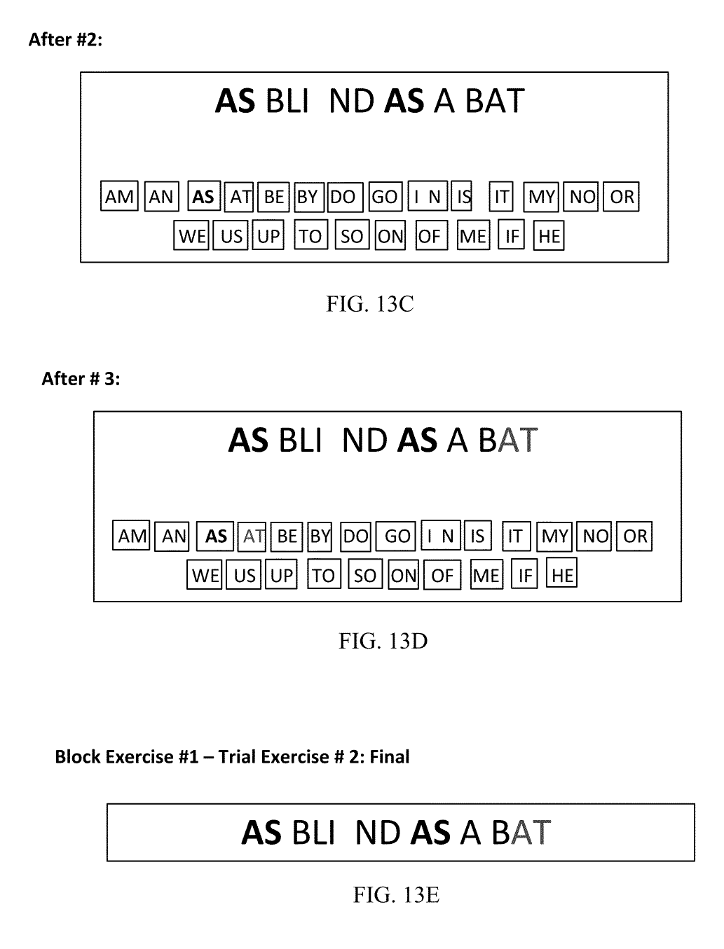

FIGS. 13A-13E depict another example of the exercises for sensorially perceptually discriminating different-type relational open proto-bigrams (ROPB) embedded in predefined alphabetic arrays. FIG. 13A shows a selected alphabetic array comprising a figurative speech sentence. A ruler containing both direct and inverse alphabetical ROPB possible answer choices is also provided to the subject with the selected sentence. FIG. 13B shows the correctly sensory motor selected ROPB ‘AS’. More importantly, the ROPBs ‘AS’ are highlighted in both the provided sentence and the ruler by a change in the spatial perceptual related attribute of font boldness. FIG. 13C shows the next correctly sensory motor selected ROPB ‘IN’ in the provided sentence and the ruler highlighted by a change in the spatial perceptual related attribute of font spacing. In FIG. 13D, the last correctly sensory motor selected ROPB ‘AT’ is highlighted in the provided sentence and the ruler by a change in the time perceptual related attribute of font color from default to red.

Finally, in FIG. 13E, only the provided figurative speech sentence is displayed with each of the correctly selected different ROPBs, ‘AS’, ‘IN’, and ‘AT’ highlighted by their respective changed time and/or spatial perceptual related attributes.

### Example 6

### Sensorial Perceptual Discrimination of Embedded Relational Open Proto-Bigrams (ROPB) in Selected Affixes within Predefined Alphabetic Arrays

A goal of the exercises presented in Example 6 is to exercise elemental fluid intelligence ability. The exercises of Example 6 intentionally promote fluid reasoning to quickly enact an abstract conceptual mental web where a number of relational direct ROPBs, inverse ROPBs, and incomplete alphabetic arrays having semantic meanings relationally interrelate, correlate, and cross-correlate with each other such that the processing and real-time manipulation of these alphabetic arrays is maximized in short-term memory. Importantly, the alphabetic arrays utilized herein are purposefully selected and arranged with the intention of not eliciting semantic associations and/or comparisons in order to bypass long-term memory processing of stored semantic information in a subject. Accordingly, the real-time sensorial perceptual serial search, discrimination, and motor manipulation of the selected alphabetic arrays does not require the subject to automatically retrieve-recall semantic information learned from past experiences to solve the present exercises. Rather, unbeknownst to the subject, the present exercises minimize or eliminate the subject's need to access prior learned and/or stored semantic knowledge by focusing on the intrinsic relational seriality of the alphabetic arrays, even when the presented alphabetic array(s) conveys a semantic meaning. The general method of the present exercises is directed to promoting fluid intelligence abilities in a subject by sensorially perceptually discriminating selected embedded relational open proto-bigrams (ROPB) in selected affixes within predefined alphabetic arrays.

The method of promoting fluid intelligence abilities in a subject comprises displaying a predefined number of alphabetic arrays containing one or more selected relational open proto-bigrams (ROPB) embedded in selected affixes, wherein the alphabetic arrays are selected from a predefined library of words comprising one or more separable affixes. Initially, all of the displayed alphabetic arrays have the same spatial and time perceptual related attributes. The subject is provided with a selected affix having the selected ROPB embedded therein during a first predefined time period with the underlying purpose of prompting the subject to sensorially perceptually discriminate any displayed alphabetic arrays to which the selected affix is an integral part. At the conclusion of the first predefined time period, the subject is prompted to immediately select the discriminated alphabetic arrays containing the selected affix having the selected ROPB embedded therein. For each selected affix selection, the subject is required to perform a sensory motor activity corresponding to the selection. If the sensory motor selection made by the subject is an incorrect selection, the subject is automatically returned to the initial displaying step of the method without receiving any performance feedback. If the sensory motor selection made by the subject is a correct selection, then the correctly selected affix containing the selected ROPB is immediately displayed with at least one different spatial and/or time perceptual related attribute than the displayed alphabetic arrays.

The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed selected affix sensory motor selections. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, it is contemplated that any number of iterations can be performed. In a preferred embodiment, the number of predetermined iterations is between 3 and 10.

In another aspect of Example 6, the method of promoting fluid intelligence abilities in a subject is implemented through a computer program product. In particular, the subject matter in Example 6 includes a computer program product for promoting fluid intelligence abilities in a subject, stored on a non-transitory computer-readable medium which when executed causes a computer system to perform a method. The method executed by the computer program on the non-transitory computer readable medium comprises the steps of: displaying a predefined number of alphabetic arrays containing one or more selected relational open proto-bigrams (ROPB) embedded in selected affixes, wherein the alphabetic arrays are selected from a predefined library of words comprising one or more separable affixes. Initially, all of the displayed alphabetic arrays have the same spatial and time perceptual related attributes. The subject is provided with a selected affix having the selected ROPB embedded therein during a first predefined time period with the underlying purpose of prompting the subject to sensorially perceptually discriminate any displayed alphabetic arrays to which the selected affix is an integral part. At the conclusion of the first predefined time period, the subject is prompted to immediately sensory motor select the discriminated alphabetic arrays containing the selected affix having the selected ROPB embedded therein. For each selected affix selection, the subject is required to perform a sensory motor activity corresponding to the selection. If the sensory motor selection made by the subject is an incorrect selection, the subject is automatically returned to the initial displaying step of the method without receiving any performance feedback. If the sensory motor selection made by the subject is a correct selection, then the correctly selected affix containing the selected ROPB is immediately displayed with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed selected affix sensory motor selections.

In a further aspect of Example 6, the method of promoting fluid intelligence abilities in a subject is implemented through a system. The system for promoting fluid intelligence abilities in a subject comprises: a computer system comprising a processor, memory, and a graphical user interface (GUI). Further, the processor contains instructions for: displaying a predefined number of alphabetic arrays containing one or more selected relational open proto-bigrams (ROPB) embedded in selected affixes on the GUI, wherein the alphabetic arrays are selected from a predefined library of words comprising one or more separable affixes. Initially, all of the displayed alphabetic arrays have the same spatial and time perceptual related attributes. The subject is provided with a selected affix having the selected ROPB embedded therein on the GUI during a first predefined time period with the underlying purpose of prompting the subject to sensorially perceptually discriminate any displayed alphabetic arrays to which the selected affix is an integral part. At the conclusion of the first predefined time period, the subject is prompted to immediately sensory motor select on the GUI, the discriminated alphabetic arrays containing the selected affix having the selected ROPB embedded therein. For each selected affix selection, the subject is required to perform a sensory motor activity corresponding to the selection. Once the subject has made a sensory motor selection, the processor determines whether the sensory motor selection is either correct or incorrect. If the sensory motor selection made by the subject is an incorrect selection, the subject is automatically returned to the initial displaying step without receiving any performance feedback. If the sensory motor selection made by the subject is a correct selection, then the correctly selected affix containing the selected ROPB is immediately displayed on the GUI with at least one different spatial and/or time perceptual related attribute than the displayed alphabetic arrays. The above steps in the method are repeated for a predetermined number of iterations separated by one or more predefined time intervals. Upon completion of the predetermined number of iterations for each sensorial perceptual discrimination exercise, the subject is provided with the results therefor, including all of the correctly performed selected affix sensory motor selections.

In a preferred embodiment, Example 6 includes a single block exercise having at least one trial exercise. In each trial exercise, at least one alphabetic array is presented to the subject. Shortly after the alphabetic array(s) is/are displayed, the subject is presented with a selected affix containing the selected ROPB embedded therein. Upon seeing the selected affix, the user is required to scan the provided alphabetic array(s) to sensorially perceptually discriminate all instances of the selected affix containing the selected ROPB. Thereafter, and without delay, the subject must sensory motor select the discriminated alphabetic array(s) containing the selected affix. Importantly, the present trial exercises have been designed to reduce cognitive workload by minimizing the dependency of the subject's reasoning and derived inferring skills on real-time manipulation of lexical information by the subject's working memory. Therefore, the selected affix containing the selected ROPB is presented as a sensorial perceptual reference for the subject in each trial exercise.

The subject is given a limited time frame within which the subject must validly sensory motor perform the exercises. If the subject does not sensory motor perform a given exercise within the second predefined time interval, also referred to as “a valid performance time period”, then after a delay, which could be of about 2 seconds, the next iteration for the subject to perform is automatically displayed. Importantly, the subject is not provided with any performance feedback when failing to sensory motor perform. In one embodiment, the second predefined time interval or maximal valid performance time period for lack of response is from 10-20 seconds, preferably 15-20 seconds, and more preferably 17 seconds. In another embodiment, the second predefined time interval is at least 30 seconds.

In another aspect of the exercises of Example 6, any selected affix containing the selected ROPB that the subject is required to sensorially perceptually discriminate from within the provided alphabetic array(s) may be highlighted for a first predefined time interval. Highlighting of the selected affix is effectuated to promote the sensorial perceptual discrimination of the same in the provided alphabetic array(s) by the subject. The duration of the first predefined time interval is not particularly limited. In one embodiment, the first predefined time interval is any interval between 0.5 and 3 seconds.

In another aspect of the exercises of Example 6, the predefined alphabetic arrays comprise stand-alone words. The stand-alone words may further comprise a carrier word and a sub-word embedded in the carrier word. Any stand-alone word may also be complemented with one or two separable affixes. In another aspect of the exercises of Example 6, the predefined alphabetic arrays comprise sentences. For the case when the provided alphabetic arrays comprise sentences, at least one of the sentences may be a figurative speech sentence which represents a metaphor, irony, idiom, proverb or adage.

In general, the length of each alphabetic array provided to the subject during any given exercise of Example 6 is not particularly limited. In one embodiment, each of the provided alphabetic arrays has a maximum length of seven letters.

In a further aspect of the exercises of Example 6, the location of a correctly sensory motor selected affix containing the selected ROPB in the alphabetic array(s) impacts the change(s) in spatial and/or time perceptual related attribute(s). For example, a correctly sensory motor selected affix located in the right visual field of the subject will have a different spatial and/or time perceptual related attribute change than a correctly sensory motor selected affix located in the left visual field of the subject. In another example, a correctly sensory motor selected affix containing the selected ROPB that is located at the beginning of a stand-alone word (e.g., prefix) from the displayed alphabetic array may have a different spatial and/or time perceptual related attribute than a correctly sensory motor selected affix containing the selected ROPB located at the end of a stand-alone word (e.g., suffix) from the displayed alphabetic array. Further, the difference in spatial and/or time perceptual related attribute changes between a correctly sensory motor selected affix at the beginning of a stand-alone word and a correctly sensory motor selected affix at the end of a stand-alone word will occur irrespective of and in addition to the location of the selected affix in either the left or right visual field of a subject.

As discussed above, upon sensory motor selection of a correct answer by the subject, the correctly selected affix containing the selected ROPB is immediately displayed with a spatial and/or time perceptual related attribute that is different from the displayed alphabetic arrays. The changed spatial or time perceptual related attributes of the two symbols forming the selected ROPB embedded in the selected affix may include, without being limited to, the following: symbol color, symbol sound, symbol size, symbol font style, symbol spacing, symbol case, boldness of symbol, angle of symbol rotation, symbol mirroring, or combinations thereof. Furthermore, the symbols of the embedded ROPB in the correctly selected affix may be displayed with a time perceptual related attribute “flickering” behavior in order to further highlight the differences in perceptual related attributes thereby facilitating the subject's sensorial perceptual discrimination of the differences.

As previously indicated above with respect to the general methods for implementing the present subject matter, the exercises in Example 6 are useful in promoting fluid intelligence abilities in the subject through the sensorial motor and sensorial perceptual domains that jointly engage when the subject performs the given exercise. That is, the serial sensory motor manipulating and sensorial perceptual discrimination of embedded relational open proto-bigrams in selected affixes by the subject engages body movements to execute sensory motor selecting the correct selected affix containing the selected ROPB, and combinations thereof. The sensory motor activity engaged within the subject may be any sensory motor activity jointly involved in the sensorial perception of the complete and incomplete alphabetic arrays. While any body movements can be considered motor activity implemented by the subject's body, the present subject matter is mainly concerned with implemented body movements selected from body movements of the subject's eyes, head, neck, arms, hands, fingers and combinations thereof.

In a preferred embodiment, the sensory motor activity the subject is required to perform is selected from the group including: mouse-clicking on the embedded ROPB, voicing the embedded ROPB, and touching the embedded ROPB with a finger or stick in a selected affix.

By requesting that the subject engage in specific degrees of body motor activity, the exercises of Example 6 require the subject to bodily-ground cognitive fluid intelligence abilities. The exercises of Example 6 cause the subject to revisit an early developmental realm wherein the subject implicitly acted and/or experienced a fast and efficient enactment of fluid cognitive abilities when specifically dealing with the serial pattern sensorial perceptual discrimination of non-concrete symbol terms and/or symbol terms meshing with their salient spatial-time perceptual related attributes. The established relationships between the non-concrete symbol terms and/or symbol terms and their salient spatial and/or time perceptual related attributes heavily promote symbolic knowhow in a subject. It is important that the exercises of Example 6 downplay or mitigate, as much as possible, the subject's need to recall/retrieve and use semantic or episodic knowledge from memory storage in order to support or assist inductive reasoning strategies to problem solve the exercises. The exercises of Example 6 mainly concern promoting fluid intelligence, in general, and do not rise to the cognitive operational level of promoting crystalized intelligence via explicit associative learning and/word recognition decoding strategies facilitated by retrieval of declarative semantic knowledge from long term memory. Accordingly, each set of displayed alphabetic arrays are intentionally selected and arranged to downplay or mitigate the subject's need for developing problem solving strategies and/or drawing inductive-deductive inferences necessitating prior verbal knowledge and/or recall-retrieval of lexical information from declarative-semantic and/or episodic kinds of memories.

In the main aspect of the exercises present in Example 6, the predefined library, which supplies the alphabetic array(s) for each exercise, comprises words containing separable affixes, which may or may not contain embedded relational open proto-bigrams.

In an aspect of the present subject matter, the exercises of Example 6 include providing a graphical representation of the selected affix containing the selected ROPB to the subject when providing the subject with the predefined number of alphabetic arrays of the exercise. The visual presence of the embedded ROPB in the selected affix helps the subject to perform the exercise, by facilitating a fast, visual spatial, sensorial perceptual discrimination of the presented selected affix and embedded ROPB. In other words, the visual presence of the selected affix assists the subject to sensorially perceptually discriminate the selected affix and sensory motor select the embedded ROPB from within the displayed alphabetic arrays.

The methods implemented by the exercises of Example 6 also contemplate situations in which the subject fails to sensory motor perform the given task. The following failure to perform criteria is applicable to any exercise of the present task in which the subject fails to perform. Specifically, there are two kinds of “failure to perform” criteria. The first kind of “failure to perform” criteria occurs in the event that the subject fails to perform by not click-selecting, In this case, the subject remains inactive (or passive) and fails to perform a requisite sensory motor activity representative of an answer selection. Thereafter, following a valid performance time period and a subsequent delay of, for example, about 2 seconds, the subject is automatically directed to the next trial exercise to be performed without receiving any feedback about his/her actual performance. In some embodiments, this valid performance time period is 17 seconds.

The second “failure to perform” criteria occurs in the event where the subject fails to correctly sensory motor select the selected affix containing the selected ROPB for three consecutive attempts. As an operational rule applicable for any failed trial exercise in Example 4, failure to perform results in the automatic display of the next trial exercise to be performed from the predefined number of iterations. Importantly, the subject does not receive any performance feedback during any failed trial exercise and prior to the implementation of the automatic display of the next trial exercise to be performed.

In the event the subject fails to correctly sensorially perceptually discriminate and sensory motor select the correct affixes in excess of 2 non-consecutive trial exercises (a single block exercise), then one of the following two options will occur: 1) if the failure to perform occurs for more than 2 non-consecutive trial exercises, then the subject's current block-exercise performance is immediately halted. After a time interval of about 2 seconds, the next trial exercise to be performed from the predetermined number of iterations will immediately be displayed and the subject will not be provided with any feedback concerning his/her performance of the previous trial exercise; or 2) when there are no other further trial exercises left to be performed, the subject will be immediately exited from the exercise and returned back to the main menu of the computer program without receiving any performance feedback.

The total duration of the time to complete the exercises of Example 6, as well as the time it took to implement each of the individual trial exercises, are registered in order to help generate an individual and age-gender group performance score. Records of all of the subject's incorrect sensory motor selections from each trial exercise are generated and may be displayed. In general, the subject will perform this task about 6 times during the based brain mental fitness training program.

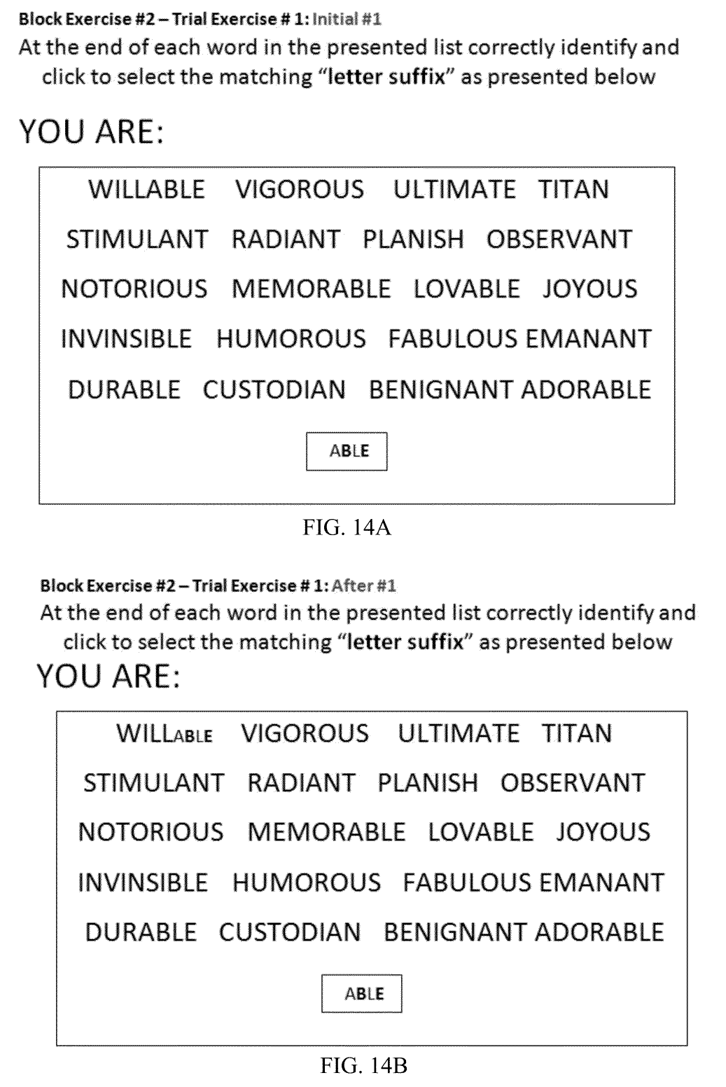

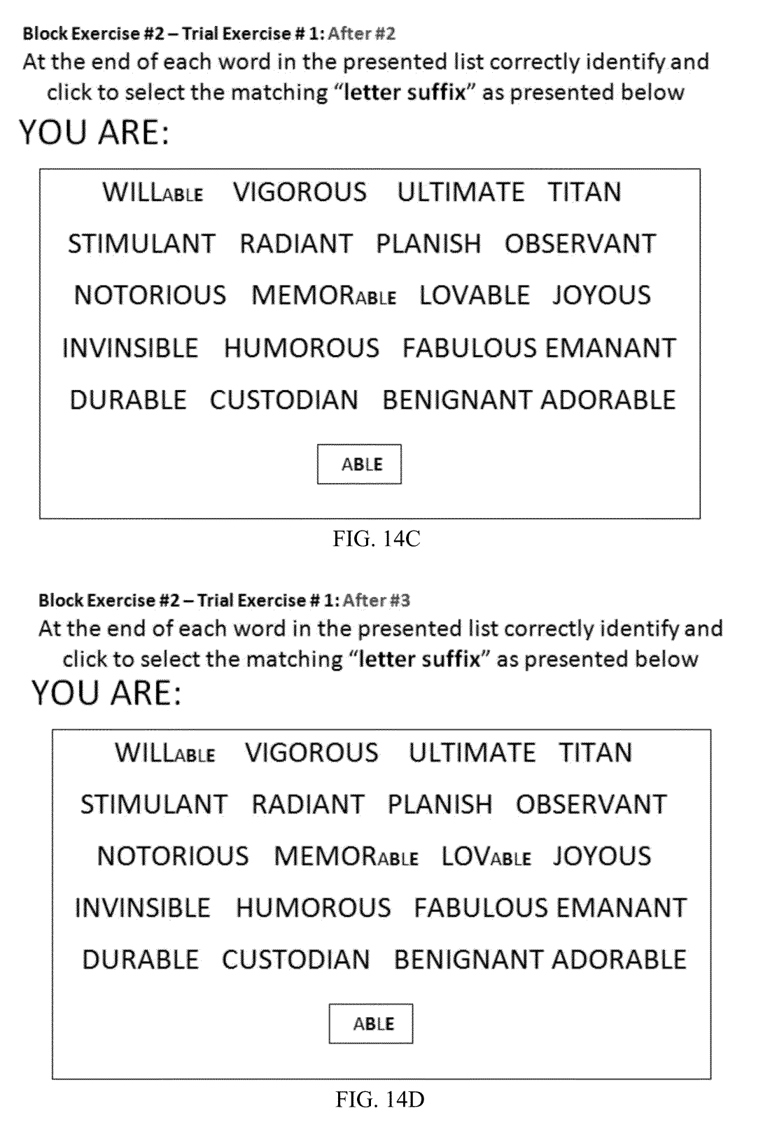

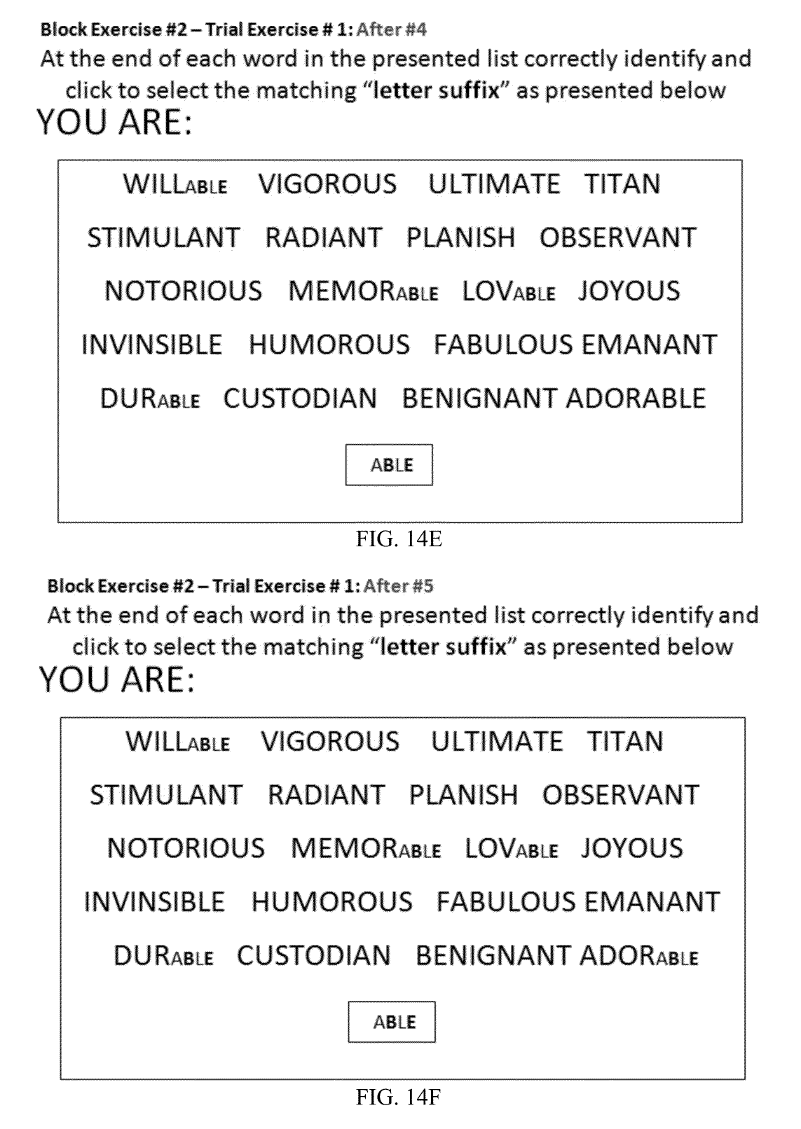

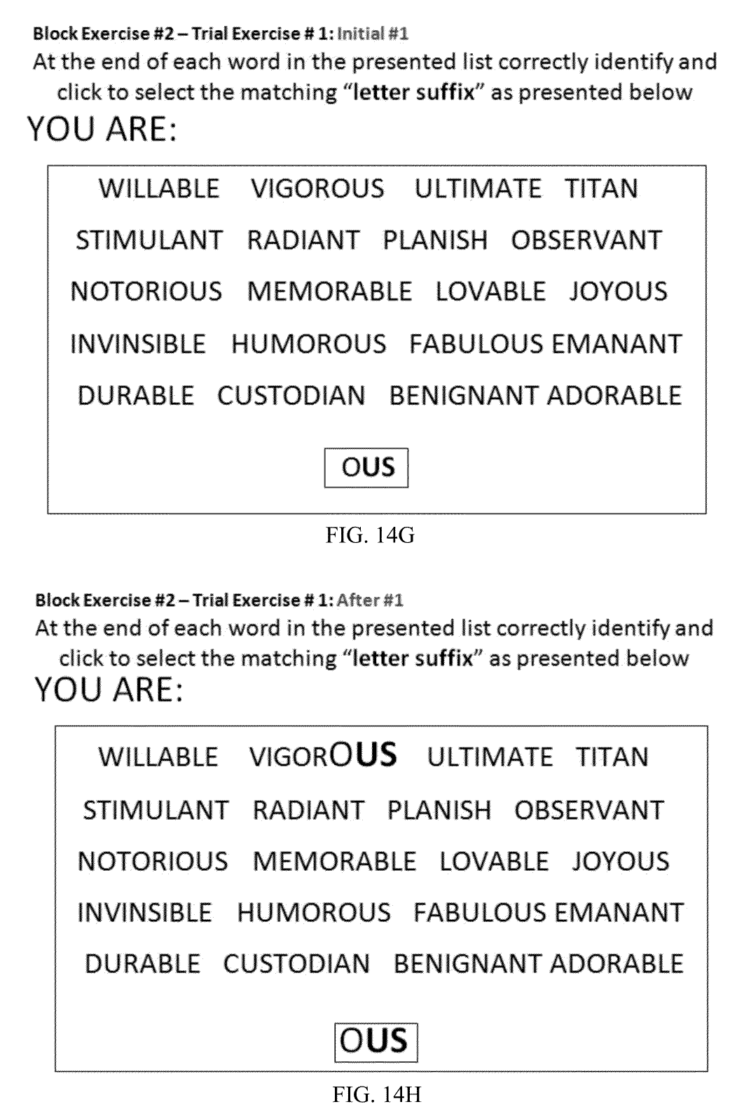

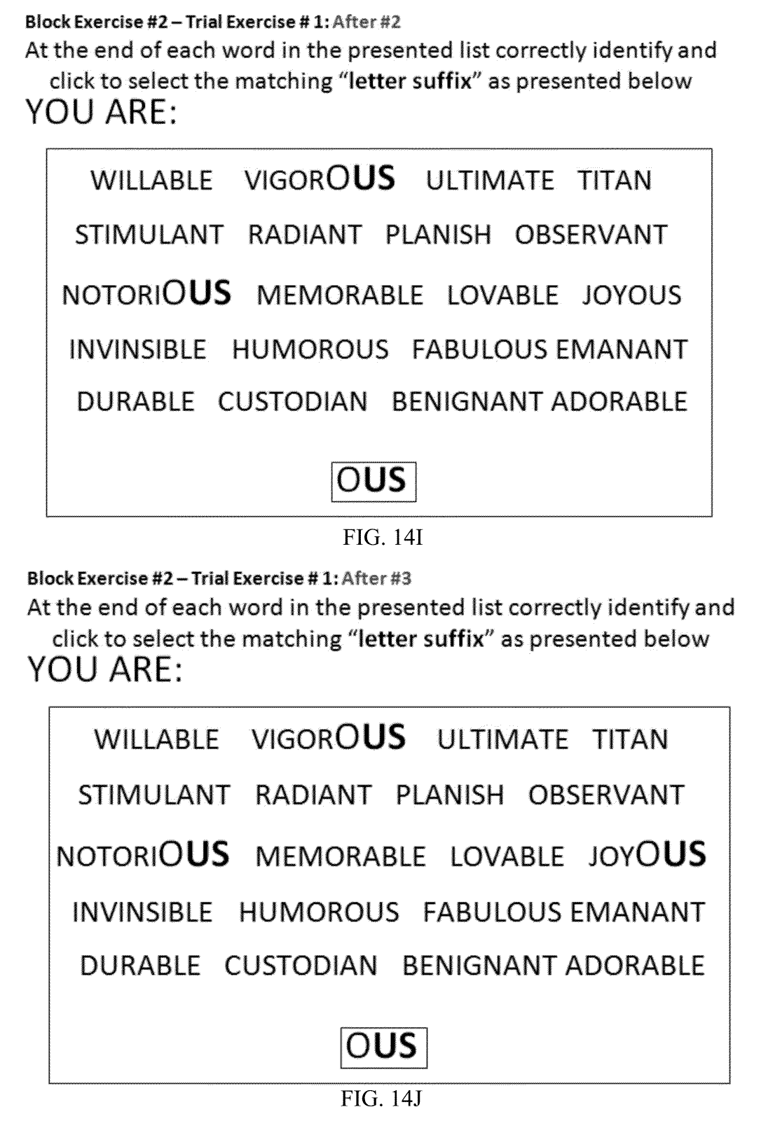

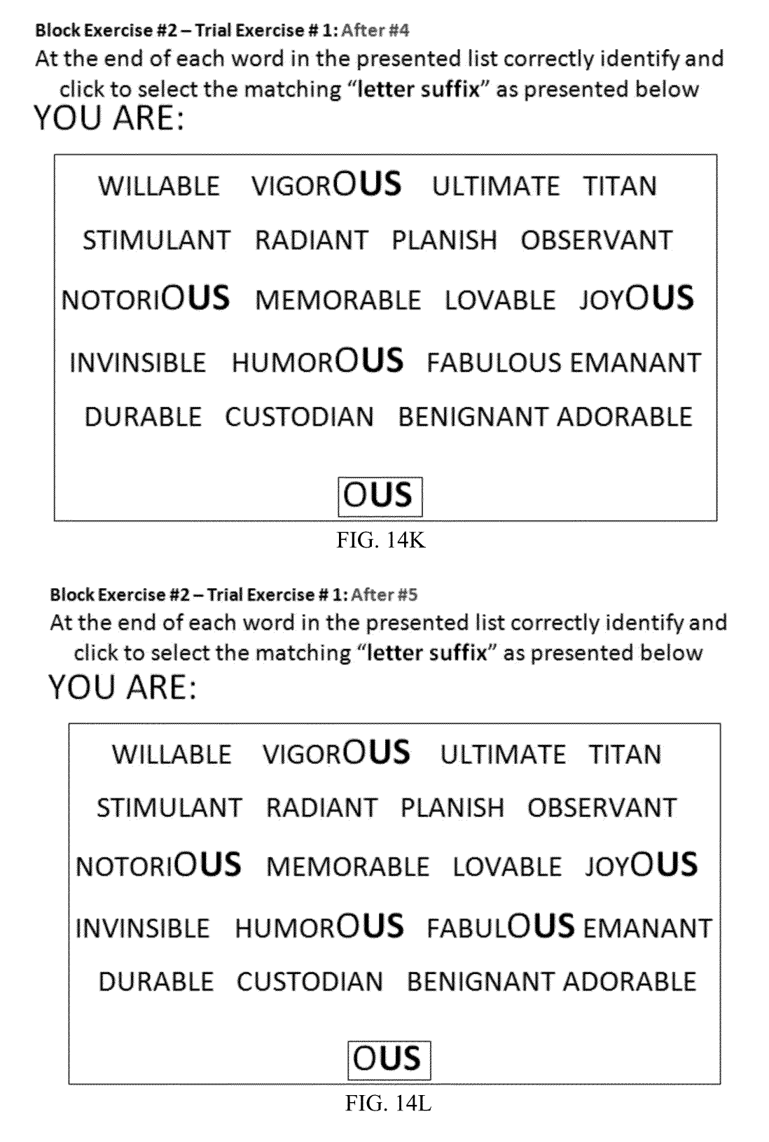

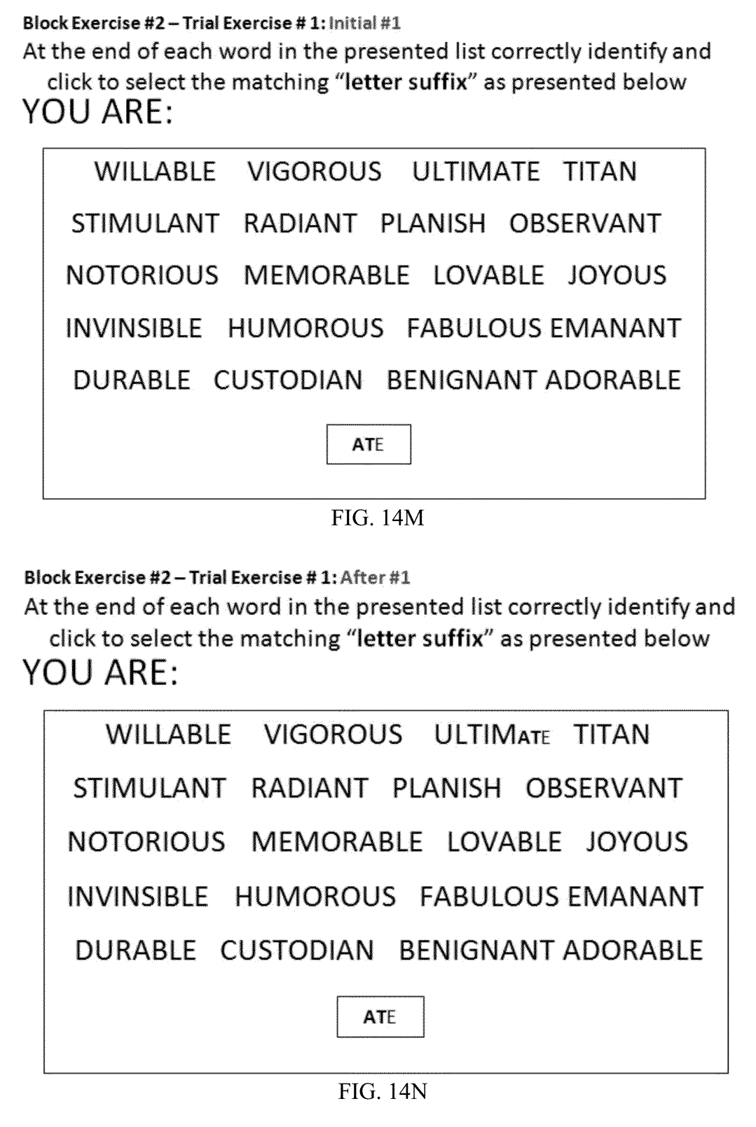

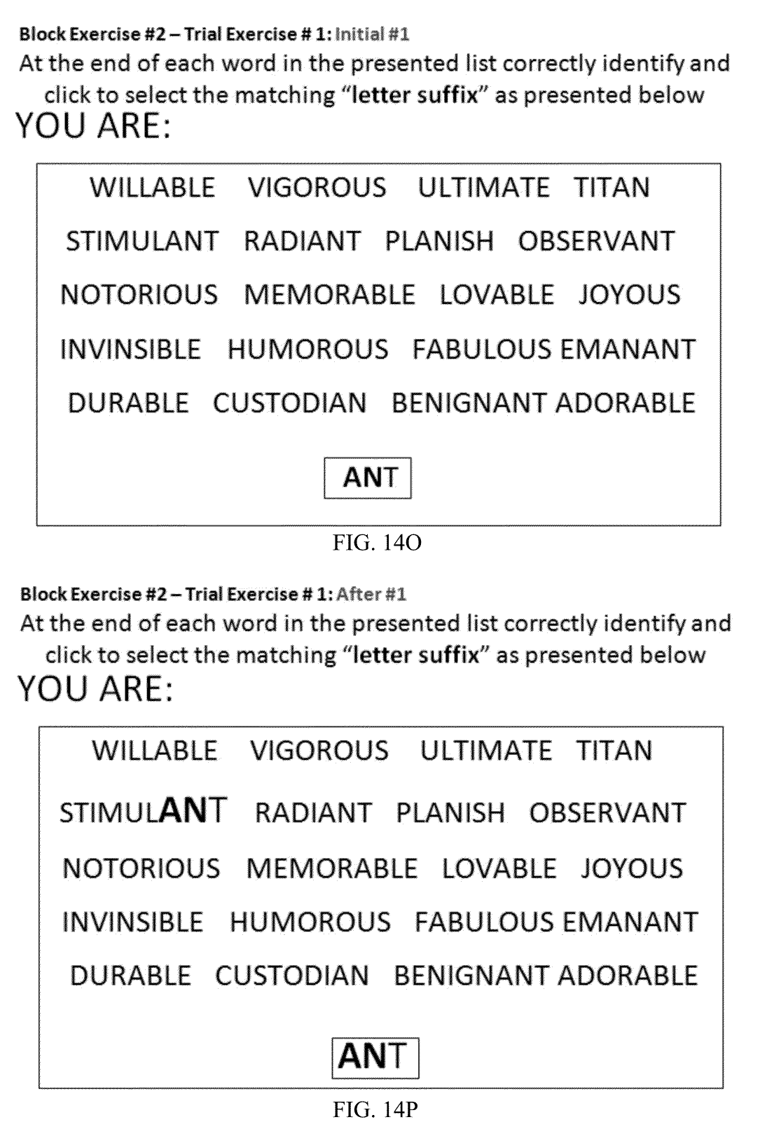

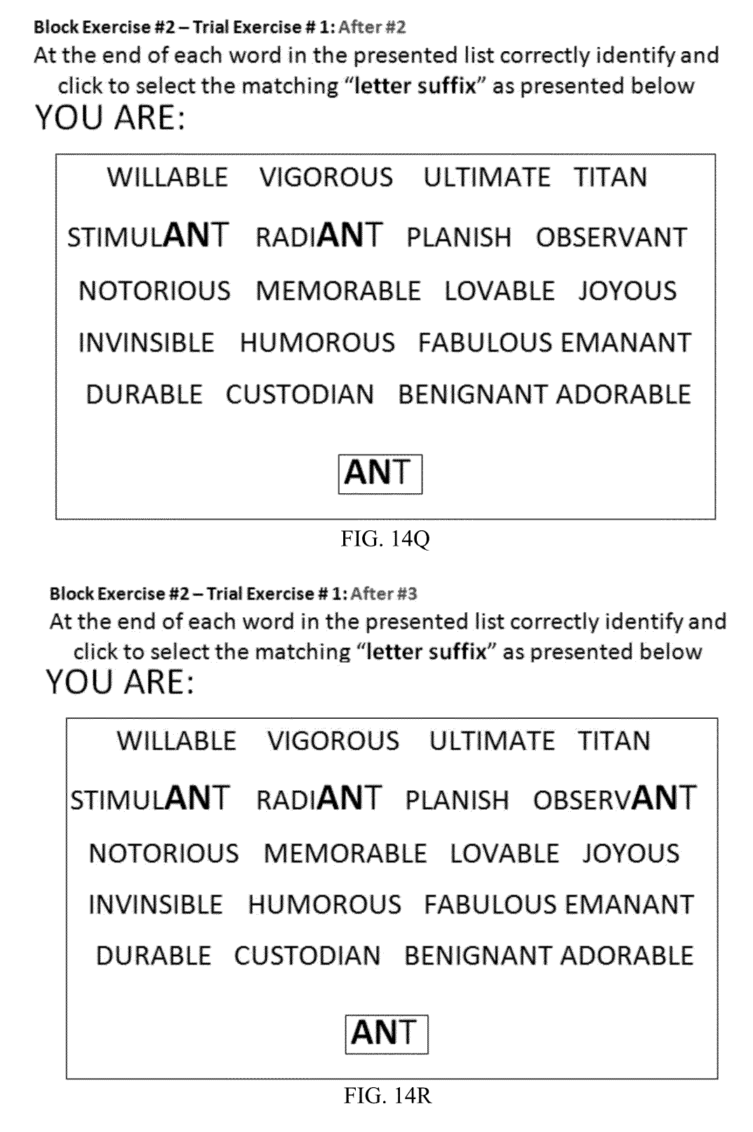

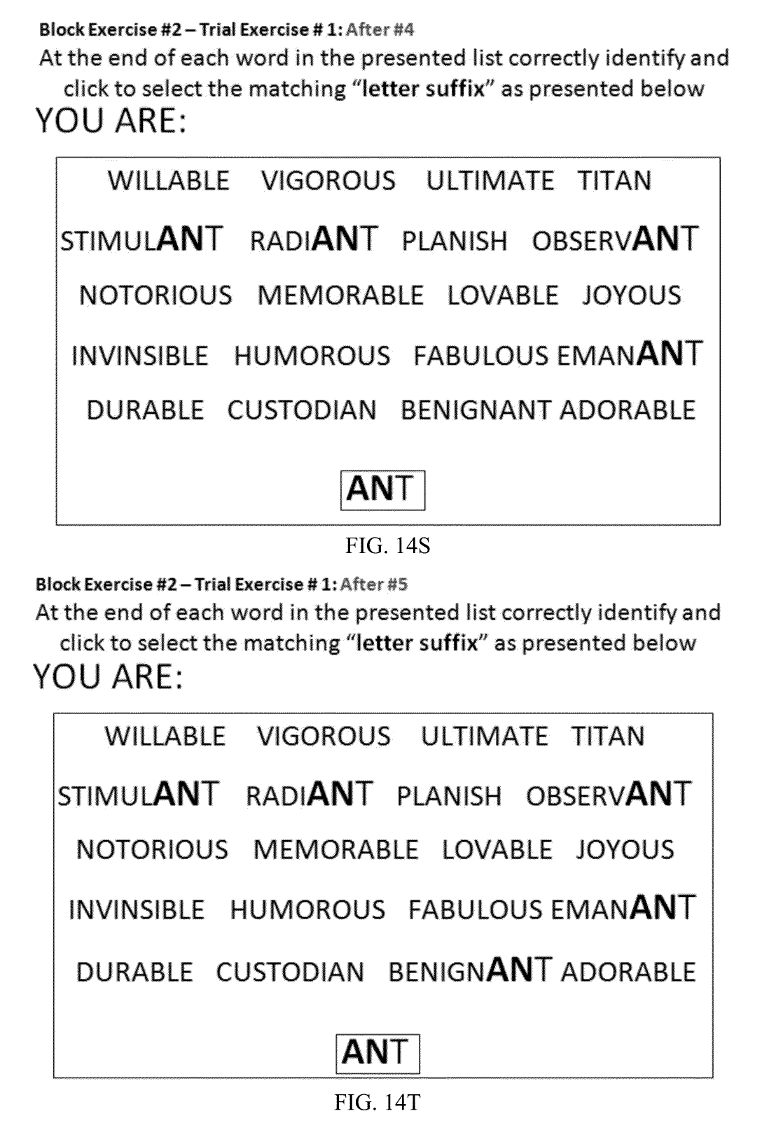

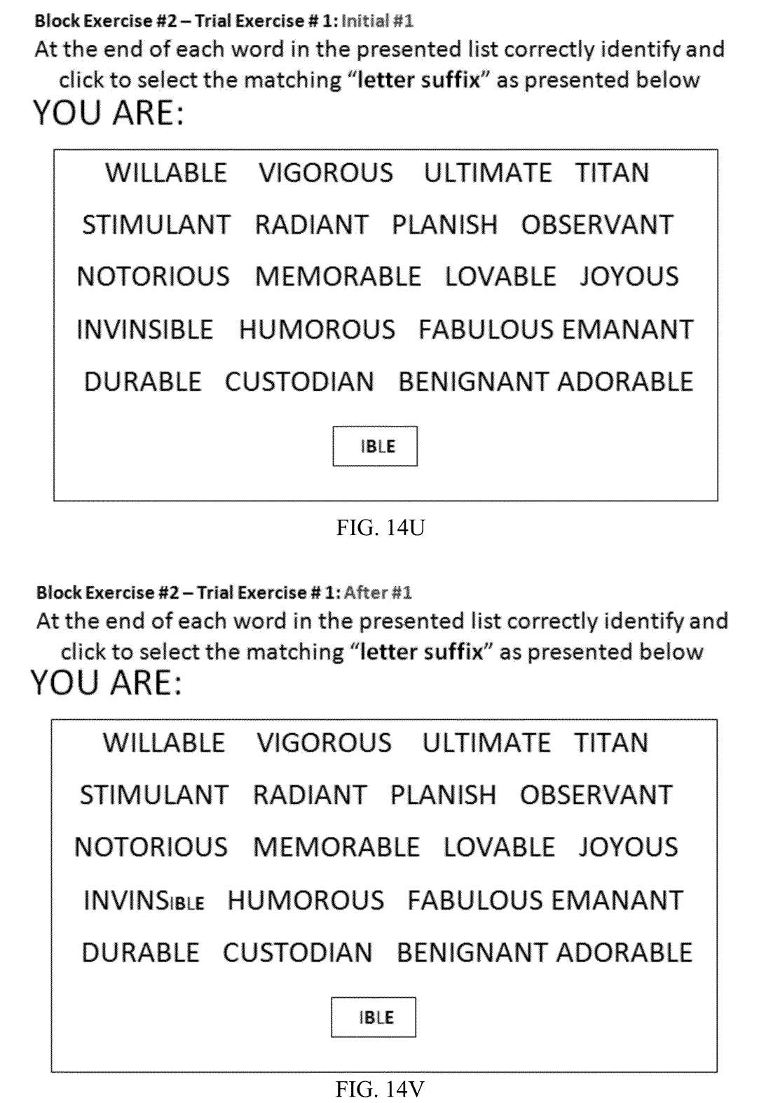

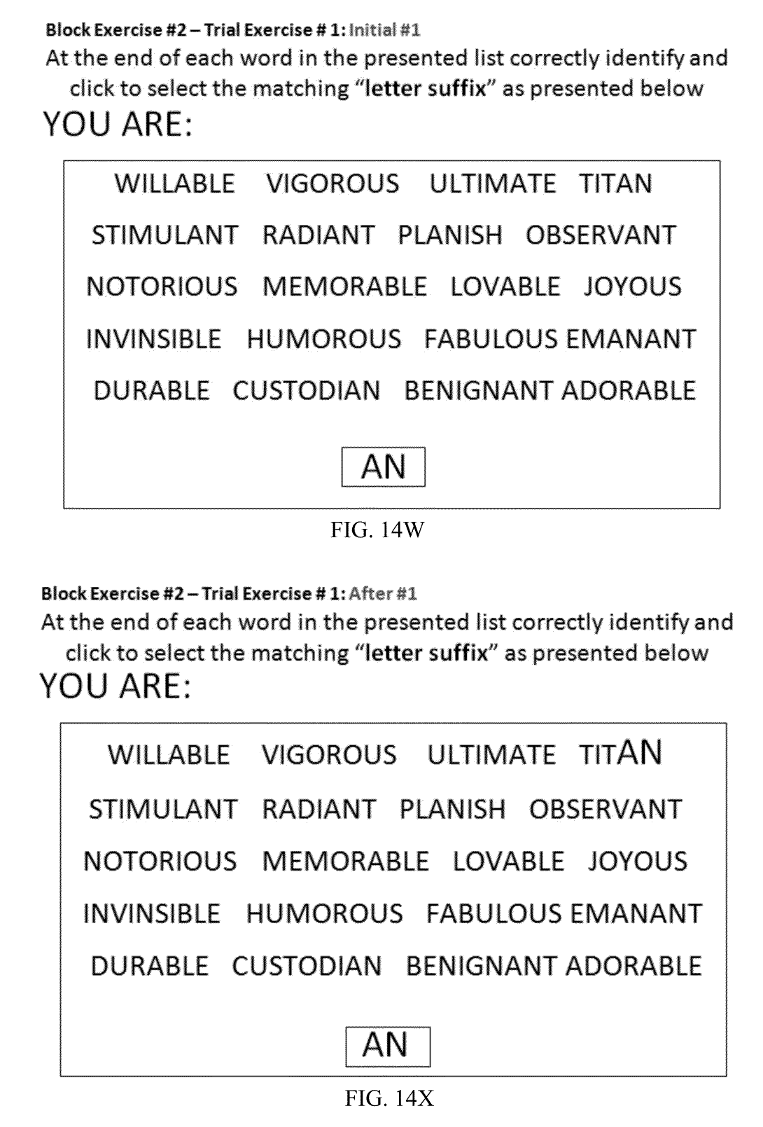

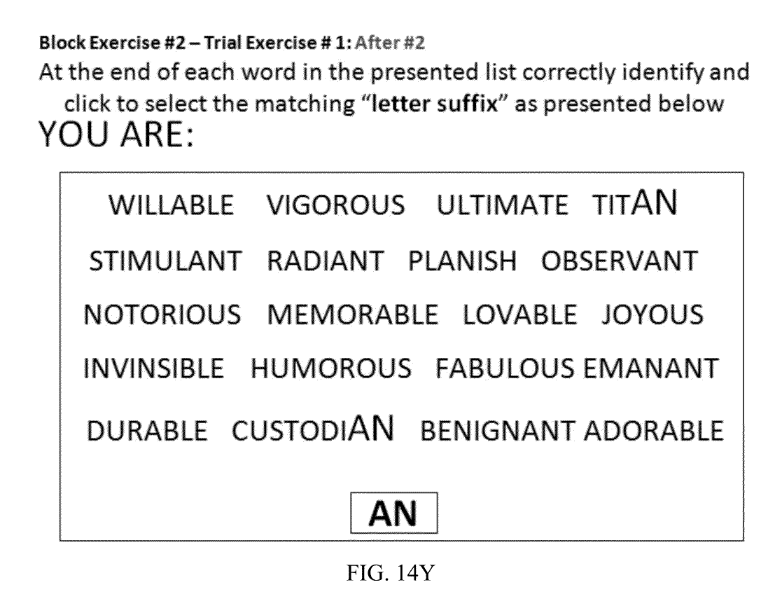

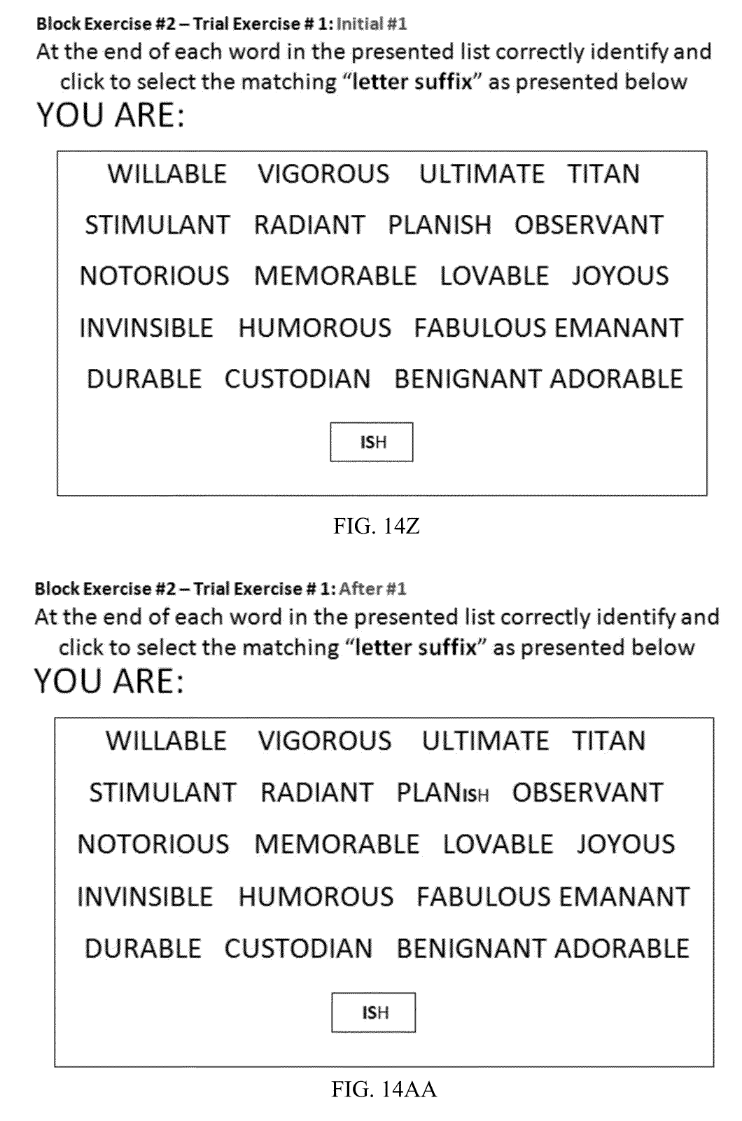

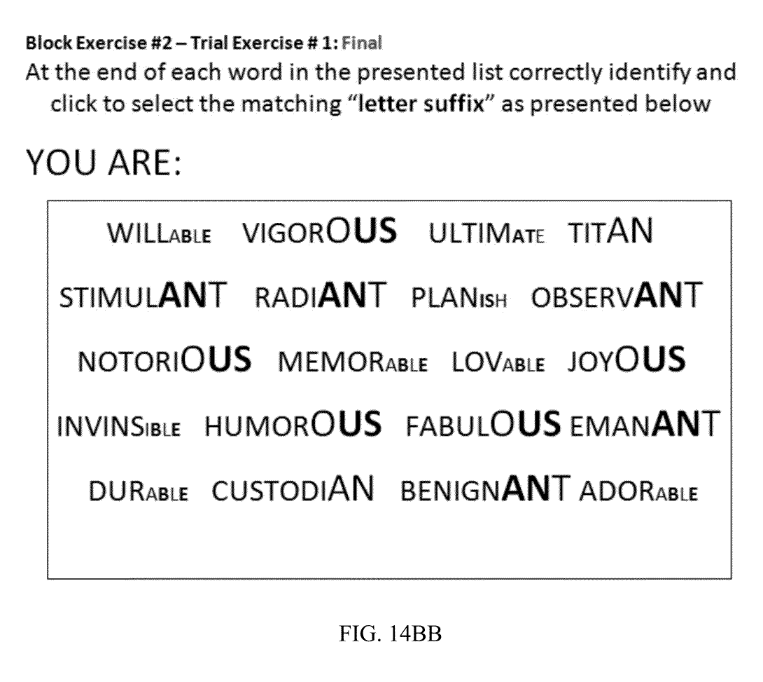

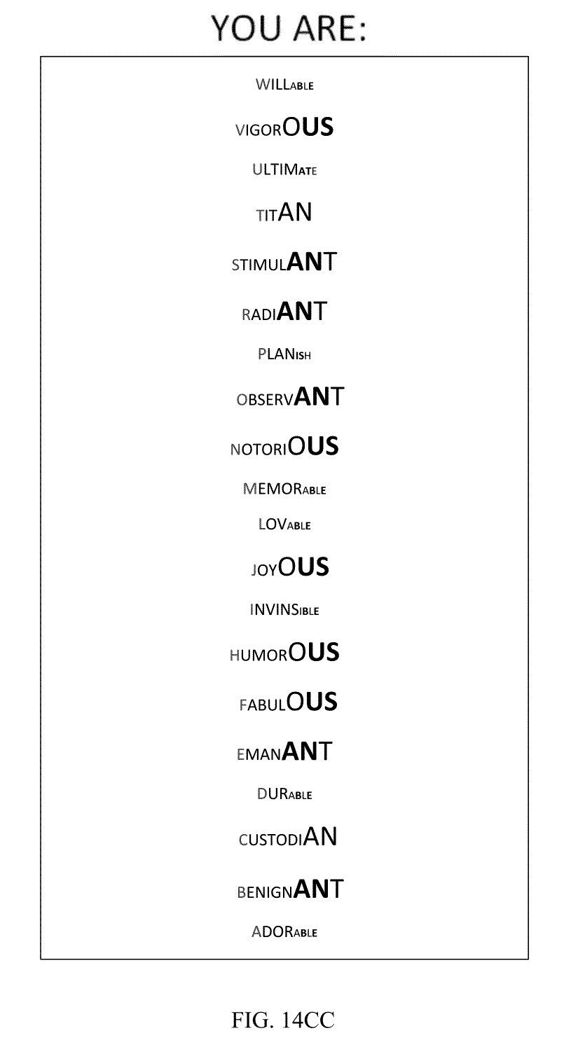

FIGS. 14A-14CC depict a number of non-limiting examples of the exercises for sensorially perceptually discriminating selected relational open proto-bigrams (ROPB) embedded in selected separable affixes within predefined alphabetic arrays. FIG. 14A shows a selected alphabetic array comprising a number of words comprising one or more separable affixes. All of the words of the selected alphabetic array initially have the same spatial and time perceptual related attributes and may be arranged in a direct or inverse alphabetical serial letter based on the first letter of each word. The subject is further provided with the selected affix ‘ABLE’ which contains the selected ROPB ‘BE’ embedded therein. The subject is required to sensorially perceptually discriminate which words from the selected alphabetic array contain the selected affix ‘ABLE’. FIG. 14B shows the correctly sensory motor selected word ‘willable’. More importantly, the selected affix ‘ABLE’ is highlighted by a change in the spatial perceptual related attribute of font size. The embedded ROPB ‘BE’ is further highlighted from within the selected affix ‘ABLE’ by an additional time and/or spatial perceptual related attribute change of the two letters forming the embedded ROPB, which is shown in at least FIG. 14B as a change in the spatial perceptual related attribute of font boldness.

FIGS. 14C-14F each show additional correctly sensory motor selected words containing the selected affix ‘ABLE’. Once a word containing the selected affix is correctly sensory motor selected, the changed spatial and/or time perceptual related attribute(s) are displayed until all of the words from the alphabetic array containing the selected affix have been correctly sensory motor selected. As shown in FIG. 14F, all of the words containing the selected affix ‘ABLE’ have been correctly sensory motor selected.

In FIG. 14G, the changed spatial and/or time perceptual related attribute(s) of the correctly sensory motor selected affix ‘ABLE’ and the embedded ROPB ‘BE’ containing words from FIG. 14F are reversed such that all of the symbol terms in the provided alphabetic array have the same spatial and time perceptual related attributes as initially presented. The subject is further provided with the newly selected affix ‘OUS’ which contains the selected ROPB ‘US’ embedded therein. The subject is required to sensorially perceptually discriminate which words from the selected alphabetic array contain the selected affix ‘OUS’. FIG. 14H shows the correctly sensory motor selected word ‘vigorous’. More importantly, the selected affix ‘OUS’ is highlighted by a change in the spatial perceptual related attribute of font size. The embedded ROPB ‘US’ is further highlighted from within the selected affix ‘OUS’ by an additional time and/or spatial perceptual related attribute change of the two letters forming the embedded ROPB. FIGS. 14I-14L each show additional correctly sensory motor selected words containing the selected affix ‘OUS’. Thus, in FIG. 14L, all of the words containing the selected affix ‘OUS’ have been sensorially perceptually discriminated and sensory motor selected.

In FIG. 14M, the changed spatial and/or time perceptual related attribute(s) of the correctly sensory motor selected affix ‘OUS’ and the embedded ROPB ‘US’ containing words from FIG. 14L are reversed such that all of the symbol terms in the provided alphabetic array have the same spatial and time perceptual related attributes as initially presented. The subject is further provided with the newly selected affix ‘ATE’ which contains the selected ROPB ‘AT’ embedded therein. The subject is required to sensorially perceptually discriminate which words from the selected alphabetic array contain the selected affix ‘ATE’. FIG. 14N shows the correctly sensory motor selected word ‘ultimate’. More importantly, the selected affix ‘ATE’ is highlighted by a change in the spatial perceptual related attribute of font size. The embedded ROPB ‘AT’ is further highlighted from within the selected affix ‘ATE’ by an additional time and/or spatial perceptual related attribute change of the two letters forming the embedded ROPB.

In FIG. 14O, the changed spatial and/or time perceptual related attribute(s) of the correctly sensory motor selected affix ‘ATE’ and the embedded ROPB ‘AT’ containing words from FIG. 17N are reversed such that all of the symbol terms in the provided alphabetic array have the same spatial and time perceptual related attributes as initially presented. The subject is further provided with the newly selected affix ‘ANT’ which contains the selected ROPB ‘AN’ embedded therein. The subject is required to sensorially perceptually discriminate which words from the selected alphabetic array contain the selected affix ‘ANT’. FIG. 14P shows the correctly sensory motor selected word ‘stimulant’. More importantly, the selected affix ‘ANT’ is highlighted by a change in the spatial perceptual related attribute of font size. The embedded ROPB ‘AN’ is further highlighted from within the selected affix ‘ANT’ by an additional time and/or spatial perceptual related attribute change of the two letters forming the embedded ROPB. FIGS. 14Q-14T each show additional correctly selected sensory motor selected words containing the selected affix ‘ANT’. All of the words containing the selected affix ‘ANT’ have been sensorially perceptually discriminated and correctly sensory motor selected as shown in FIG. 14T.

In FIG. 14U, the changed spatial and/or time perceptual related attribute(s) of the correctly sensory motor selected affix ‘ANT’ and the embedded ROPB ‘AN’ containing words from FIG. 14T are reversed such that all of the symbol terms in the provided alphabetic array have the same spatial and time perceptual related attributes as initially presented. The subject is further provided with the newly selected affix ‘IBLE’ which contains the selected ROPB ‘BE’ embedded therein. The subject is required to sensorially perceptually discriminate which words from the selected alphabetic array contain the selected affix ‘IBLE’. FIG. 14V shows the correctly sensory motor selected word ‘invisible’. More importantly, the selected affix ‘IBLE’ is highlighted by a change in the spatial perceptual related attribute of font size. The embedded ROPB ‘BE’ is further highlighted from within the selected affix ‘ANT’ by an additional time and/or spatial perceptual related attribute change of the two letters forming the embedded ROPB.

In FIG. 14W, the changed spatial and/or time perceptual related attribute(s) of the correctly sensory motor selected affix ‘IBLE’ and the embedded ROPB ‘BE’ containing words from FIG. 14V are reversed such that all of the symbol terms in the provided alphabetic array have the same spatial and time perceptual related attributes as initially presented. The subject is further provided with the newly selected affix (and ROPB) ‘AN’. The subject is required to sensorially perceptually discriminate which words from the selected alphabetic array contain the selected affix ‘AN’. FIG. 14X shows the correctly sensory motor selected word ‘titan’. More importantly, the selected affix ‘AN’ is highlighted by a change in the spatial perceptual related attribute of font size. FIG. 14Y shows all of the words containing the selected affix ‘AN’ that have been sensorially perceptually discriminated and correctly sensory motor selected.

In FIG. 14Z, the changed spatial and/or time perceptual related attribute(s) of the correctly sensory motor selected affix (and ROPB) ‘AN’ containing words from FIG. 14Y are reversed such that all of the symbol terms in the provided alphabetic array have the same spatial and time perceptual related attributes as initially presented. The subject is further provided with the newly selected affix ‘ISH’ which contains the selected ROPB ‘IS’ embedded therein. The subject is required to sensorially perceptually discriminate which words from the selected alphabetic array contain the selected affix ‘ISH’. FIG. 14AA shows the correctly sensory motor selected word ‘planish’. More importantly, the selected affix ‘ISH’ is highlighted by a change in the spatial perceptual related attribute of font size. The embedded ROPB ‘IS’ is further highlighted from within the selected affix ‘ISH’ by an additional time and/or spatial perceptual related attribute change of the two letters forming the embedded ROPB.

Once all of the selected affixes and the selected ROPBs embedded therein for a selected alphabetic array have been sensorially perceptually discriminated and correctly sensory motor selected, all of the selected affixes and the respective selected ROPBs embedded therein are immediately displayed together in a direct or inverse alphabetical order in the same spatial horizontal frame, as shown in FIG. 14BB. Importantly, each of the selected affixes and respective embedded ROPBs are displayed with the same respective spatial and/or time perceptual related attribute(s) changes that were previously made as discussed above. Shortly thereafter, all of the selected affixes and respective embedded ROPBs are immediately displayed together in a direct or inverse alphabetical list in the same spatial vertical frame, as shown in FIG. 14CC. More importantly, each of the selected affixes and respective embedded ROPBs are displayed with the same respective spatial and/or time perceptual related attribute(s) changes as shown in FIG. 14BB.

What is claimed:

1. A method of promoting fluid intelligence abilities in a subject comprising:
a) selecting a predefined number of alphabetic arrays, containing a selected relational open proto-bigram (ROPB), from a predefined library of stand-alone words, separable affixes, and selected alphabetic arrays, wherein the predefined number of alphabetic arrays may form a sentence; and displaying the selected predefined number of alphabetic arrays to the subject during a first predefined time period with the selected ROPB either orthographically present or absent;
b) providing the selected ROPB to the subject during the first predefined time period, thereby prompting the subject to discriminate the selected ROPB from the displayed alphabetic arrays of which the ROPB is an integral part;
c) at the end of the first predefined time period, prompting the subject to immediately select, within a second predefined time period, the discriminated ROPB of step b), wherein the subject is required to perform a sensory motor activity for each ROPB selection;
d) if the selection made by the subject is an incorrect selection, then returning to step a);
e) if the selection made by the subject is a correct selection, then immediately displaying the correctly selected ROPB with at least one different spatial and/or time perceptual related attribute than the displayed alphabetic arrays;
f) repeating the above steps for a predetermined number of iterations; and
g) upon completion of the predetermined number of iterations, providing the subject with the results of each iteration.

2. The method of claim 1, wherein a partial or complete predefined ROPB list of one or more ROPB types is displayed with the predefined number of alphabetic arrays in step a).

3. The method of claim 1, wherein the selected ROPB is highlighted for a first predefined time interval during step b) to promote sensorial perceptual discrimination of the selected ROPB by the subject.

4. The method of claim 3, wherein the first predefined time interval is any interval between 0.5 and 3 seconds.

5. The method of claim 1, wherein at least one of the selected stand-alone words from step a) comprises a carrier word and a sub-word embedded in the carrier word or is complemented with one or two separable affixes.

6. The method of claim 1, wherein the displayed alphabetic arrays have a maximum of seven letters.

7. The method of claim 1, wherein the sensory motor activity is selected from the group including: mouse-clicking on the ROPB, voicing the ROPB, and touching the ROPB with a finger or stick.

8. The method of claim 1, wherein the sensory motor activity is performed at one or more pre-selected locations of the displayed alphabetic arrays.

9. The method of claim 1, wherein the at least one different spatial and/or time perceptual related attribute for a correctly selected ROPB of step e) located in a right visual field of the subject is a different spatial and/or time perceptual related attribute change than a correctly selected ROPB of step e) located in a left visual field of the subject.

10. The method of claim 1, wherein the at least one different spatial and/or time perceptual related attribute for a correctly selected ROPB located at a beginning of a stand-alone word from the displayed alphabetic array is a different spatial and/or time perceptual related attribute change than a correctly selected ROPB located at an end of a stand-alone word from the displayed alphabetic array, and wherein the difference occurs irrespective of location of the correctly selected ROPB in either a left visual field or right visual field of the subject.

11. The method of claim 10, wherein the changed at least one spatial and/or time perceptual related attribute is an orthographical topological expansion, for a correctly selected ROPB of any type that is located at the beginning of a first word in a sentence, and/or for a correctly selected ROPB, having no letters contained in between the letter pair forming the ROPB, that is located at the end of the last word in a sentence.

12. The method of claim 11, wherein the orthographical topological expansion of a symbol representing a letter or a number is realized by graphically changing an orthographical morphology of the symbol at one or more vertices and/or terminal points of the symbol's graphical representation.

13. The method of claim 12, wherein the graphical changes are selected from the group including: predefined changes of color, brightness, and/or thickness of one or more vertices, adding a preselected straight line length having a predefined spatial orientation, and combinations thereof.

14. The method of claim 12, wherein when the orthographical topological expansion is performed on letters of an alphabetic set array, the alphabetic set array is segmented into a predefined number of letter sectors having at least first and last letter sectors, each letter sector having a selected number of letters, the last letter sector having a last ordinal position occupied by the letter ‘Z’ in a direct alphabetic set array, the first letter sector having a first ordinal position occupied by the letter A’ in the direct alphabetic set array,
wherein the letters of the last letter sector have a greater number of graphical changes than the letters of any preceding letter sector, and
wherein the letters of the first letter sector have a lesser number of graphical changes than the letters of any following letter sector.

15. The method of claim 14, wherein the orthographical morphology changes are performed only on letters of a correctly selected ROPB.

16. The method of claim 12, wherein when the orthographical topological expansion is performed on symbols of a sentence, the sentence is segmented into a predefined number of sectors including at least first and last sectors,
wherein the symbols of the last sector of the sentence have a greater number of graphical changes than the symbols of any preceding sector of the sentence, and
wherein the symbols of the first sector of the sentence have a lesser number of graphical changes than the symbols of any following sector of the sentence.

17. The method of claim 16, wherein the orthographical morphology changes are performed only on letters of a correctly selected ROPB.

18. The method of claim 1, wherein when the subject incorrectly selects a letter pair in the displayed alphabetic array that is not the selected ROPB, the subject is provided with up to two additional consecutive attempts to make a correct ROPB selection.

19. The method of claim 1, wherein when the subject fails to perform the sensory motor activity in step c) within a second predefined time interval, the subject is automatically directed to step f) wherein the subject is prompted to perform the next available iteration in the predefined number of iterations.

20. The method of claim 19, wherein the second predefined time interval is at least 30 seconds.

21. The method of claim 19, wherein the subject does not receive any performance feedback either when failing to sensory motor perform or when failing to make a correct ROPB selection after either three consecutive attempts or more than two non-consecutive attempts.

22. The method of claim 1, wherein the predetermined number of iterations is between 3 and 10.

23. The method of claim 1, wherein for any given iteration having orthographically absent ROPB, the correct selections are either all the same ROPB or all different ROPB such that no one ROPB is repeated in the given iteration.

24. The method of claim 1, wherein the sentence of step a) is a figurative sentence, which represents a metaphor, irony, proverb, or adage.

25. A computer program product for promoting fluid intelligence abilities in a subject, stored on a non-transitory computer-readable medium, which when executed causes a computer system to perform a method comprising the steps of:
a) selecting a predefined number of alphabetic arrays containing a selected relational open proto-bigram (ROPB), wherein the ROPB is selected from a predefined library of stand-alone words, words inside sentences, separable affixes, and selected alphabetic arrays; and displaying the selected predefined number of alphabetic arrays to the subject during a first predefined time period with the selected ROPB either orthographically present or absent;
b) providing the selected ROPB to the subject during the first predefined time period thereby prompting the subject to discriminate the selected ROPB from the displayed alphabetic arrays of which the ROPB is an integral part;
c) at the end of the first predefined time period, prompting the subject to immediately select, within a second predefined time period, the discriminated ROPB of step b), wherein the subject is required to perform a sensory motor activity for each ROPB selection;
d) if the selection made by the subject is an incorrect selection, then returning to step a);
e) if the selection made by the subject is a correct selection, then immediately displaying the correctly selected ROPB with at least one different spatial and/or time perceptual related attribute than the displayed alphabetic arrays;
f) repeating the above steps for a predetermined number of iterations; and
g) upon completion of the predetermined number of iterations, providing the subject with the results of each iteration.

26. A system for promoting fluid intelligence abilities in a subject, the system comprising:
a computer system comprising:
a processor, memory, and a graphical user interface (GUI),
wherein the processor contains instructions for:
a) selecting a predefined number of alphabetic arrays containing a selected relational open proto-bigram (ROPB), wherein the ROPB is selected from a predefined library of stand-alone words, words inside sentences, separable affixes, and selected alphabetic arrays; displaying the selected predefined number of alphabetic arrays to the subject on the GUI during a first predefined time period with the selected ROPB either orthographically present or absent;
b) providing the selected ROPB to the subject on the GUI during the first predefined time period thereby prompting the subject to discriminate the selected ROPB from the displayed alphabetic arrays of which the ROPB is an integral part;
c) at the end of the first predefined time period, prompting the subject to immediately select on the GUI, within a second predefined time period, the discriminated ROPB of step b), wherein the subject is required to perform a sensory motor activity for each ROPB selection;
d) determining whether the selection made by the subject is either correct or incorrect;
e) if the selection made by the subject is an incorrect selection, then returning to step a);
f) if the selection made by the subject is a correct selection, then immediately displaying the correctly selected ROPB on the GUI with at least one different spatial and/or time perceptual related attribute than the displayed alphabetic arrays;
g) repeating the above steps for a predetermined number of iterations; and
h) upon completion of the predetermined number of iterations, providing the subject with the results of each iteration on the GUI.
